(19) United States
(12) Patent Application Publication
(10) Pub. No.: US 2012/0140883 A1
(43) Pub. Date: Jun. 7, 2012

(54) RADIOGRAPHIC APPARATUS AND RADIOGRAPHIC SYSTEM

(75) Inventors: Naoto IWAKIRI, Kanagawa (JP); Dai MURAKOSHI, Kanagawa (JP)

(73) Assignee: FUJIFILM Corporation, Tokyo (JP)

(21) Appl. No.: 13/302,207

(22) Filed: Nov. 22, 2011

(30) Foreign Application Priority Data
Dec. 7, 2010 (JP) 2010-273067

(51) Int. Cl. G01N 23/04

(52) U.S. Cl. 378/62

(57) ABSTRACT

A radiographic apparatus includes: a first grating; a grating pattern having a period that substantially coincides with a pattern period of a radiological image formed by radiation having passed through the first grating; a radiological image detector that detects the radiological image masked by the grating pattern, and a third grating that is arranged at a more forward location than the first grating in a traveling direction of the radiation incident onto the first grating and selectively shields an area to which the radiation is irradiated, thereby forming disperse radiation sources. A heat insulation member is arranged at a more forward location than the third grating in the traveling direction of the radiation.

### CROSS-REFERENCE TO RELATED APPLICATIONS

This application is based on and claims priority under 35 USC 119 from Japanese Patent Application No. 2010-273067 filed on Dec. 7, 2010, the entire content of which is incorporated herein by reference.

### BACKGROUND

1. Technical Field

The invention relates to a radiographic apparatus performing a phase imaging by radiation such as X-ray for a photographic subject and a radiographic system.

2. Related Art

Since X-ray attenuates depending on an atomic number of an element configuring a material and a density and a thickness of the material, it is used as a probe for seeing through an inside of a photographic subject. An imaging using the X-ray is widely spread in fields of medical diagnosis, nondestructive inspection and the like.

In a general X-ray imaging system, a photographic subject is arranged between an X-ray source that irradiates the X-ray and an X-ray image detector that detects the X-ray, and a transmission image of the photographic subject is captured. In this case, the X-ray irradiated from the X-ray source toward the X-ray image detector is subject to the quantity attenuation (absorption) depending on differences of the material properties (for example, atomic numbers, densities and thickness) existing on a path to the X-ray image detector and is then incident onto each pixel of the X-ray image detector. As a result, an X-ray absorption image of the photographic subject is detected and captured by the X-ray image detector. As the X-ray image detector, a flat panel detector (FPD) that uses a semiconductor circuit is widely used in addition to a combination of an X-ray intensifying screen and a film and a photostimulable phosphor.

However, the smaller the atomic number of the element configuring material, the X-ray absorption ability is reduced. Accordingly, for the soft biological tissue or soft material, it is not possible to acquire the contrast of an image that is enough for the X-ray absorption image. For example, the cartilaginous part and joint fluid configuring an articulation of the body are mostly comprised of water. Thus, since a difference of the X-ray absorption amounts thereof is small, it is difficult to obtain the shading difference. Up to date, the soft tissue can be imaged by using the MRI (Magnetic Resonance Imaging). However, it takes several tens of minutes to perform the imaging and the resolution of the image is low such as about 1 mm. Hence, it is difficult to use the MRI in a regular physical examination such as medical checkup due to the cost-effectiveness.

Regarding the above problems, instead of the intensity change of the X-ray by the photographic subject, a research on an X-ray phase imaging of obtaining an image (hereinafter, referred to as a phase contrast image) based on a phase change (refraction angle change) of the X-ray by the photographic subject has been actively carried out in recent years. In general, it has been known that when the X-ray is incident onto an object, the phase of the X-ray, rather than the intensity of the X-ray, shows the higher interaction. Accordingly, in the X-ray phase imaging of using the phase difference, it is possible to obtain a high contrast image even for a weak absorption material having a low X-ray absorption ability. Up to date, regarding the X-ray phase imaging, it has been possible to perform the imaging by generating the X-ray having a wavelength and a phase with a large-scaled synchrotron radiation facility (for example, SPring-8) using an accelerator, and the like. However, since the facility is too huge, it cannot be used in a usual hospital. As the X-ray phase imaging to solve the above problem, an X-ray imaging system has been recently suggested which uses an X-ray Talbot interferometer having two transmission diffraction gratings (phase type grating and absorption type grating) and an X-ray image detector (for example, refer to Patent Document 1 (JP-A-2008-200359)).

The X-ray Talbot interferometer includes a first diffraction grating (phase type grating or absorption type grating) that is arranged at a rear side of a photographic subject, a second diffraction grating (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating forms a self-image by the Talbot interference effect. The self-image is modulated by the interaction (phase change) of the photographic subject, which is arranged between the X-ray source and the first diffraction grating, and the X-ray.

In the X-ray Talbot interferometer, a moiré fringe that is generated by superimposition (intensity modulation) of the self-image of the first diffraction grating and the second diffraction grating is detected and a change of the moiré fringe by the photographic subject is analyzed, so that phase information of the photographic subject is acquired. As the analysis method of the moiré fringe, a fringe scanning method has been known, for example. According to the fringe scanning method, a plurality of imaging is performed while the second diffraction grating is translation-moved with respect to the first diffraction grating in a direction, which is substantially parallel with a plane of the first diffraction grating and is substantially perpendicular to a grating direction (strip direction) of the first diffraction grating, with a scanning pitch that is obtained by equally partitioning the grating pitch, and an angle distribution (differential image of a phase shift) of the X-ray refracted at the photographic subject is acquired from changes of respective pixel values obtained in the X-ray image detector. Based on the angle distribution, it is possible to acquire a phase contrast image of the photographic subject. By doing so, according to the acquired phase contrast image, it is possible to capture an image of the tissue (the cartilage or soft tissue) that cannot be seen by the X-ray absorption-based image method because the absorption difference is small and there is no contrast difference that can be said perfect. In particular, although it is not possible to substantially acquire the absorption difference between the cartilage and the joint fluid in the X-ray absorption, it is possible to capture the cartilage and the joint fluid in the X-ray phase (refraction) imaging because there are clear contrasts. Thereby, it is possible to rapidly and easily diagnose the knee osteoarthritis that most of the aged (about 30 million persons) are regarded to have, the arthritic disease such as meniscus injury due to sports disorders, the rheumatism, the Achilles tendon injury, the disc hernia and the soft tissue such as breast tumor mass by the X-ray. Hence, it is expected that it is possible to contribute to the early diagnosis and the early treatment of the potential patient and the reduction of the medical care cost.

In the phase imaging as described above, a focus diameter of the X-ray is preferable smaller so as to prevent the quality deterioration of the phase contrast image. However, when a pin hole and the like are used to reduce the focus diameter, the intensity of the X-ray is correspondingly lowered.

Regarding the above problem, a technology has been suggested in which a third grating referred to as a multi-slit is arranged near an X-ray source and thus a plurality of point light sources (disperse radiation sources) is formed (for example, refer to Patent Document 2).

Here, when the respective relative positions of the multi-slit, the first grating and the second grating are deviated due to the temperature change and the like, the quality of the phase contrast image is highly influenced. In Patent Document 2, a control device determines whether a distortion or temporal distortion due to the temperature is caused to the first and second gratings, and when it is determined that the temperature exceeds a preset temperature or the distortion is caused, a warning is displayed. However, Patent Document 2 (WO-A-2008/102598 corresponding to US-A-2010/0080436) does not consider the thermal distortion of the multi-slit.

A pitch of the multi-slit and distances from the multi-slit to the first and second gratings are determined so that radiological images, which are formed for each of disperse focal points as the X-ray emitted from the respective focal points (effective focal points) of the disperse radiation sources by the multi-slit passes through the first grating, are superimposed and thus coincide with each other. That is, the grating pitch of the multi-slit, the distance between the multi-slit and the first grating, the distance between the first and second gratings and the grating pitch of the second grating are geometrically determined and the quality of the phase contrast image is deteriorated when the determined corresponding relations become inappropriate.

Even when the relative position deviations of the multi-slit, the first grating and the second grating are only several μm, since the pitches of the first and second gratings are about several μm and the pitch of the multi-slit is about several tens μm, the above relative position deviations are sufficiently large for the grating pitches of μm unit. Thereby, the quality of the phase contrast image is remarkably deteriorated.

Here, the multi-slit that is arranged near the X-ray source is considerably apt to be thermally expanded, compared to the other gratings. The generation efficiency of the X-ray is low such as 0.5% or lower and a large amount of power (for example, 5 kW) that is applied to an X-ray tube is mostly consumed to generate heat. Thus, it is necessary to suppress the thermal expansion of the multi-slit, which is arranged near the X-ray source that is a large heat generation source as such, to several μm or smaller.

### SUMMARY

An object of the invention is to provide a radiographic apparatus and a radiographic system capable of sufficiently suppressing the thermal expansion of a multi-slit and enabling a favorable capturing of a phase contrast image.

According to an aspect of the invention, a radiographic apparatus includes: a first grating; a grating pattern having a period that substantially coincides with a pattern period of a radiological image formed by radiation having passed through the first grating; a radiological image detector that detects the radiological image masked by the grating pattern, and a third grating that is arranged at a more forward location than the first grating in a traveling direction of the radiation incident onto the first grating and selectively shields an area to which the radiation is irradiated, thereby forming disperse radiation sources. A heat insulation member is arranged at a more forward location than the third grating in the traveling direction of the radiation.

According to another aspect of the invention, a radiographic system includes: the radiographic apparatus discussed above, a calculation processing unit that calculates, from an image detected by the radiological image detector of the radiographic apparatus, a refraction angle distribution of the radiation incident onto the radiological image detector and generates a phase contrast image of a photographic subject based on the refraction angle distribution.

According to the radiographic apparatus and the radiographic system, it is possible to sufficiently suppress the thermal expansion of the multi-slit and to enable a favorable capturing of a phase contrast image.

### BRIEF DESCRIPTION OF THE DRAWINGS

FIG. 1 is a partial side sectional view pictorially showing an example of a configuration of a radiographic system for illustrating an illustrative embodiment of the invention.

FIG. 2 is a control block diagram of the radiographic system of FIG. 1.

FIG. 3 is a pictorial view showing a configuration of a radiological image detector by using blocks.

FIG. 4 is a perspective view of a multi-slit, first and second gratings and a radiological image detector.

FIG. 5 is a side view of the multi-slit, the first and second gratings and the radiological image detector.

FIGS. 6A to 6C are pictorial views each showing a mechanism for changing a period of an interference fringe (moiré) resulting from interaction of first and second gratings.

FIG. 7 is a pictorial view for illustrating refraction of radiation by a photographic subject.

FIG. 8 is a pictorial view for illustrating a fringe scanning method.

FIG. 9 is a graph showing pixel signals of the radiological image detector in accordance with the fringe scanning.

FIG. 10 is a partial side sectional view showing a configuration in which an infrared cutoff filter is provided instead of a heat insulation member of FIG. 1.

FIG. 11 is a pictorial view showing another example of a configuration of a radiographic system for illustrating an illustrative embodiment of the invention.

FIG. 12 is a pictorial view showing another example of a configuration of a radiographic system for illustrating an illustrative embodiment of the invention.

FIG. 13 is a pictorial view showing another example of a configuration of a radiographic system for illustrating an illustrative embodiment of the invention.

FIG. 14 is a partial sectional view pictorially showing an air cooling unit for cooling a multi-slit (when an imaging is performed while a photographic subject stands).

FIG. 15 is a partial sectional view pictorially showing the air cooling unit for cooling the multi-slit (when an imaging is performed while a photographic subject lies down).

FIG. 16 is a pictorial view showing another example of a configuration of a radiographic system for illustrating an illustrative embodiment of the invention.

FIG. 17 is a perspective view of the radiographic system of FIG. 16.

FIG. 18 is a pictorial side view showing another example of a configuration of a radiographic system for illustrating an illustrative embodiment of the invention.

FIG. 19 is a pictorial side view showing another example of a configuration of a radiographic system for illustrating an illustrative embodiment of the invention.

FIG. 20 is a pictorial view showing a rotation mechanism in accordance with a radiographic system for illustrating an illustrative embodiment of the invention.

FIG. 21 is a side view showing first and second gratings having concave curve surfaces in accordance with a radiographic system for illustrating an illustrative embodiment of the invention.

FIG. 22 shows a schematic configuration of a radiographic system for illustrating an illustrative embodiment of the invention.

FIGS. 23A to 23C show a schematic configuration of an optical reading type radiological image detector.

FIG. 24 shows an arrangement relation of the first grating, the second grating and pixels of the radiological image detector.

FIG. 25 shows a method of setting an inclination angle of the first grating relative to the second grating.

FIG. 26 shows a method of adjusting an inclination angle of the first grating relative to the second grating.

FIGS. 27A and 27B illustrate a recording operation of an optical reading type radiological image detector.

FIG. 28 illustrates a scanning operation of the optical reading type radiological image detector.

FIG. 29 shows an operation of acquiring a plurality of fringe images, based on image signals read out from the optical reading type radiological image detector.

FIG. 30 shows an operation of acquiring a plurality of fringe images, based on image signals read out from the optical reading type radiological image detector.

FIG. 31 shows an arrangement relation between a radiological image detector using TFT switches and the first and second gratings.

FIG. 32 shows a schematic configuration of a radiological image detector using CMOSs.

FIG. 33 shows a configuration of one pixel circuit of the radiological image detector using CMOSs.

FIG. 34 shows an arrangement relation between the radiological image detector using CMOSs and the first and second gratings.

FIG. 35 is a schematic view showing another example of a configuration of a radiographic system for illustrating an illustrative embodiment of the invention.

FIGS. 36A to 36C show a schematic configuration of an illustrative embodiment of the radiological image detector.

FIGS. 37A and 37B illustrate a recording operation of the radiological image detector according to an illustrative embodiment.

FIG. 38 illustrates a reading operation of the radiological image detector according to an illustrative embodiment.

FIG. 39 shows another illustrative embodiment of the radiological image detector.

FIGS. 40A and 40B illustrate a recording operation of the radiological image detector according to another illustrative embodiment.

FIG. 41 illustrates a reading operation of the radiological image detector according to another illustrative embodiment.

FIG. 42 shows an example of a grating having a grating surface that is a curved concave surface.

FIG. 43 is a pictorial view showing a configuration of an X-ray image detector in accordance with another example of a radiographic system for illustrating an illustrative embodiment of the invention.

FIG. 44 is a block diagram showing a configuration of a calculation unit that generates a radiological image, in accordance with another example of a radiographic system for illustrating an illustrative embodiment of the invention.

FIG. 45 is a graph showing pixel signals of a radiological image detector for illustrating a process in the calculation unit of the radiographic system shown in FIG. 44.

### DETAILED DESCRIPTION

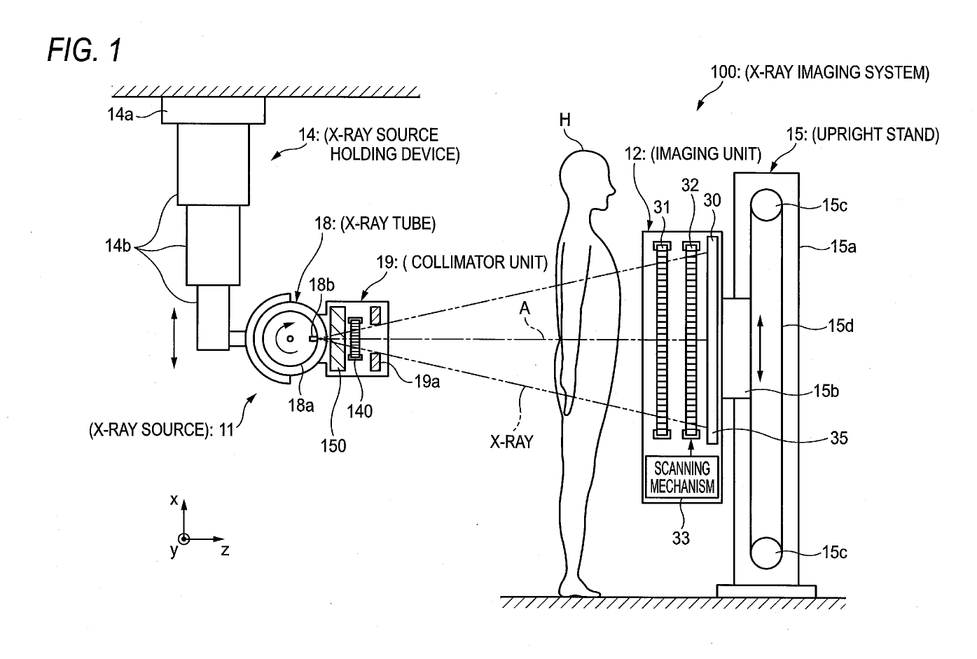

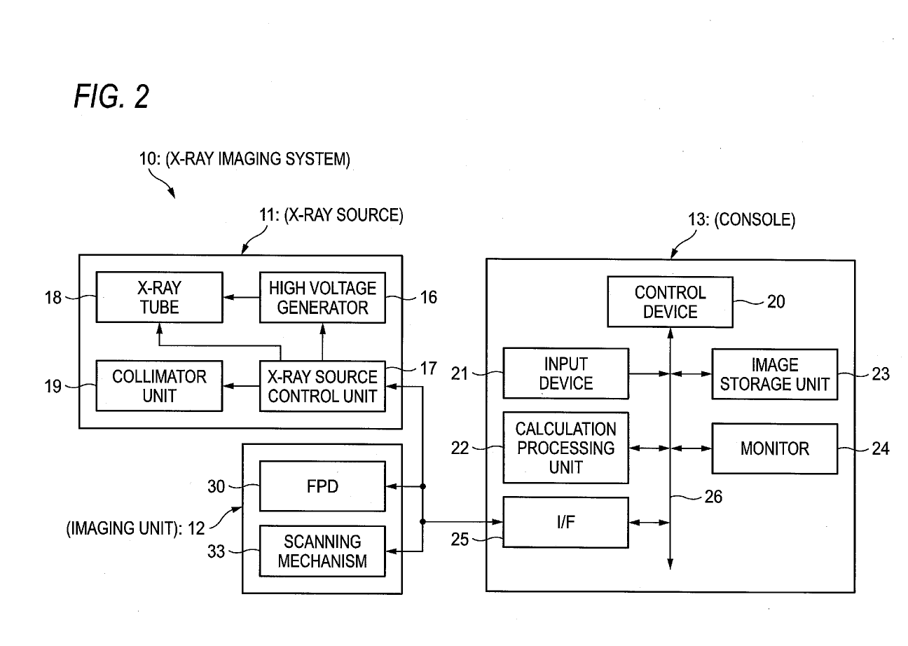

FIG. 1 shows an example of a configuration of a radiographic system for illustrating an illustrative embodiment of the invention and FIG. 2 is a control block diagram of the radiographic system of FIG. 1.

An X-ray imaging system 10 is an X-ray diagnosis apparatus that performs an imaging while a photographic subject (patient) H stands, and includes an X-ray source 11 that X-radiates the photographic subject H, an imaging unit 12 that is opposed to the X-ray source 11 with the photographic subject H being interposed between the X-ray source 11 and the imaging unit, detects the X-ray having penetrated the photographic subject H from the X-ray source 11 and thus generates image data and a console 13 (refer to FIG. 2) that controls an exposing operation of the X-ray source 11 and an imaging operation of the imaging unit 12 based on an operation of an operator, calculates the image data acquired by the imaging unit 12 and thus generates a phase contrast image.

The X-ray source 11 is held so that it can be moved in an upper-lower direction (x direction) by an X-ray source holding device 14 hanging from the ceiling.

The imaging unit 12 is held that it can be moved in the upper-lower direction by an upright stand 15 mounted on the bottom.

The X-ray source 11 includes an X-ray tube 18 that generates the X-ray in response to a high voltage applied from a high voltage generator 16, based on control of an X-ray source control unit 17.

The X-ray tube 18 is a rotary anode type and includes a filament (not shown) serving as an electron emission source (cathode), a rotary anode 18a with which electrons emitted from the filament collide and a rotation driving unit (not shown) (for example, motor) that rotates the rotary anode 18a at high speed and thus changes an electron collision area of the rotary anode 18a. The X-ray tube 18 enables the electrons to collide with the rotary anode 18a, thereby generating the X-ray. A collision area of the electron beam of the rotary anode 18a is an X-ray focal point (X-ray actual focal point) 18b.

Here, the generation efficiency η of the X-ray can be calculated by a following equation.

η=CZV

where C is a constant and about 1.1×10⁻⁹, Z is an atomic number of a target material and Z=74 when the material is tungsten that is generally used for the X-ray source, and V is a tube voltage of the X-ray tube 18. When the imaging is performed with 50 kV with which it is possible to easily obtain contrast of an image shading even for the soft tissue, η=0.407% that is very slight generation efficiency and 99% or more of the power is consumed to generate heat. When the tube voltage is 50 kV and the tube current is 100 mA, the power that is fed to the X-ray is 5 kW and about 99.6% of the power is consumed to generate the heat. Thus, it can be seen that the X-ray tube 18 is a very high heat generation source.

The X-ray tube 18 is provided with a collimator unit 19 having a moveable collimator 19a that limits an irradiation field so as to shield a part of the X-ray generated from the X-ray tube 18, which part does not contribute to an inspection area of the photographic subject H. The collimator unit 19 is integrally held to a housing of the X-ray tube 18.

The collimator unit 19 has therein a multi-slit 140 functioning as a third grating and a heat insulation member 150 made of a foamed material at an X-ray source 11-side of the collimator 19a. The multi-slit 140 that is embedded in the collimator unit 19 is integrally mounted to the X-ray source 11. The multi-slit 140 is arranged at a more forward side than a first grating 31 in a traveling direction of the X-ray incident onto the first grating 31.

When a distance from the X-ray source 11 to an FPD 30 is set to be same as a distance (1 to 2 m) that is set in an imaging room of a typical hospital, the blurring of a projection image (which is also referred to as G1 image), which is formed as the X-ray passes through the first absorption grating 31, may be influenced depending on a focus size (in general, about 0.1 mm to 1 mm) of the X-ray focal point 18b, so that the quality of a phase contrast image may be deteriorated. Accordingly, it may be considered that a pin hole is provided just after the X-ray focal point 18b to effectively reduce the focus size. However, when an opening area of the pin hole is decreased so as to reduce the effective focus size, the X-ray intensity is lowered. In order to solve this problem, the multi-slit 104 is arranged just after the X-ray focal point 18b.

Also, the heat insulation member 150 and the multi-slit 140 are held in the housing together with the collimator 19a. Thus, compared to a configuration in which the heat insulation member and the multi-slit are held in a housing separate from the collimator 19a, it is possible to shorten a distance between the X-ray source 11 and the multi-slit 140 and a distance between the multi-slit 140 and the collimator 19a. The X-ray is conically spread (conical beam) from the X-ray source. Accordingly, the respective distances from the X-ray source 11 to the multi-slit 140 and the collimator 19a are shortened, so that it is possible to reduce a size of the multi-slit 140 and a size and a moving distance of the collimator 19a and thus to easily realize the compact configuration and the cost reduction. By the above configuration, it is possible to appropriately perform the formation of disperse radiation sources by the multi-slit 140 and the limit of the X-ray irradiation field by the collimator 19a.

The heat insulation member 150 is made of a foamed material (phenol foam, urethane foam, polystyrene foam, polyethylene foam and the like) having interconnected or closed pores therein, and is provided at a position intersecting with an optical axis (radiation axis) A of the X-ray between the X-ray source 11 and the multi-slit 140. Since the heat insulation member 150 having the pores has a high X-ray transmittance, it is very appropriately used as a heat insulation member that is provided between the X-ray source 11 and the multi-slit 140. The heat insulation member 150 is provided at the position intersecting with the optical axis A at which a density of the X-ray beam is high and thus the heat is easily concentrated, so that it is possible to sufficiently insulate the multi-slit 140 and the X-ray source 11 without lowering the X-ray intensity. Also, since the heat insulation member 150 has a high X-ray transmittance and a low X-ray absorption ability, the deterioration due to the irradiation of the X-ray is not caused well, so that the maintenance thereof is easy.

In addition, the heat insulation member 150 also serves as a vibration-proof member that prevents vibrations from being transferred to the multi-slit 140 from the outside. The external vibrations that are transferred to the multi-slit 140 include vibration that is transferred from the ceiling through the X-ray source holding device 14, vibration that is caused in association with operations of a carriage unit 14a and strut units 14b, and the like. The vibration of the X-ray source 11 that is arranged near the multi-slit 140 may be mainly exemplified.

Here, the vibration that is caused in association with the high-speed rotation of the rotary anode 18a of the X-ray tube 18 is a large cause of the vibrations that are transferred to the multi-slit 140. Also, the X-ray tube 18 is generally provided with a fan for cooling the X-ray tube 18 and the vibration that is generated in association with the rotation of the cooling fan is also a large cause of the vibrations that are transferred to the multi-slit 140. Like this, the vibrations of the X-ray tube 18 and the cooling fan are apt to be transferred to the multi-slit 140 that is arranged nearby. However, since the heat insulation member 150 arranged between the X-ray source 11 and the multi-slit 140 also serves as a vibration-proof member, it is possible to block the vibration transfer from the X-ray source 11 to the multi-slit 140 and thus to sufficiently suppress the vibration of the multi-slit 140.

Like this, since the heat insulation member 150 also functions as a vibration-proof member, the distance between the X-ray focal point 18b (X-ray actual focal point) and the multi-slit 140 is not long, compared to a configuration in which a heat insulation member and a vibration-proof member are separately provided. Thereby, it is possible to increase the X-ray intensity at each of the point light sources (disperse radiation sources) formed by the multi-slit 140.

In addition, since the vibrations of the X-ray tube 18 and the cooling fan are particularly apt to be transferred to the multi-slit 140 in the configuration in which the multi-slit 140 is integrated to the X-ray source 11 through the collimator unit 19, the vibration-proof effect by the heat insulation member 150 can be further improved.

The X-ray source holding device 14 includes a carriage unit 14a that is adapted to move in a horizontal direction (z direction) by a ceiling rail (not shown) mounted on the ceil and a plurality of strut units 14b that is connected in the upper-lower direction. The carriage unit 14a is provided with a motor (not shown) that expands and contracts the strut units 14b to change a position of the X-ray source 11 in the upper-lower direction.

The upright stand 15 includes a main body 15a that is mounted on the bottom and a holding unit 15b that holds the imaging unit 12 and is attached to the main body 15a so as to move in the upper-lower direction. The holding unit 15b is connected to an endless belt 15d that extends between two pulleys 16c spaced in the upper-lower direction, and is driven by a motor (not shown) that rotates the pulleys 15c. The driving of the motor is controlled by a control device 20 of the console 13 (which will be described later), based on a setting operation of the operator.

Also, the upright stand 15 is provided with a position sensor (not shown) such as potentiometer, which measures a moving amount of the pulleys 15c or endless belt 15d and thus detects a position of the imaging unit 12 in the upper-lower direction. The detected value of the position sensor is supplied to the X-ray source holding device 14 through a cable and the like. The X-ray source holding device 14 expands and contracts the strut units 14b, based on the detected value, and thus moves the X-ray source 11 to follow the vertical moving of the imaging unit 12.

The console 13 is provided with the control device 20 that includes a CPU, a ROM, a RAM and the like. The control device 20 is connected with an input device 21 with which the operator inputs an imaging instruction and an instruction content thereof, a calculation processing unit 22 that calculates the image data acquired by the imaging unit 12 and thus generates an X-ray image, an image storage unit 23 that stores the X-ray image, a monitor 24 that displays the X-ray image and the like and an interface (I/F) 25 that is connected to the respective units of the X-ray imaging system 10, via a bus 26.

As the input device 21, a switch, a touch panel, a mouse, a keyboard and the like may be used, for example. By operating the input device 21, radiography conditions such as X-ray tube voltage, X-ray irradiation time and the like, an imaging timing and the like are input. The monitor 24 consists of a liquid crystal display and the like and displays letters such as radiography conditions and the X-ray image under control of the control device 20.

The imaging unit 12 has a flat panel detector (FPD) 30 serving as a radiological image detector that has a semiconductor circuit, and a first absorption type grating 31 and a second absorption type grating 32 that detect a phase change (angle change) of the X-ray by the photographic subject H and perform a phase imaging.

The imaging unit 12 is provided with a scanning mechanism 33 that translation-moves the second absorption type grating 32 in the upper-lower direction (x direction) and thus relatively moves the first absorption type grating 31 and the second absorption type grating 32.

The FPD 30 has a detection surface that is arranged to be orthogonal to the optical axis A of the X-ray irradiated from the X-ray source 11. As specifically described in the below, the first and second absorption type gratings 31, 32 are arranged between the FPD 30 and the X-ray source 11.

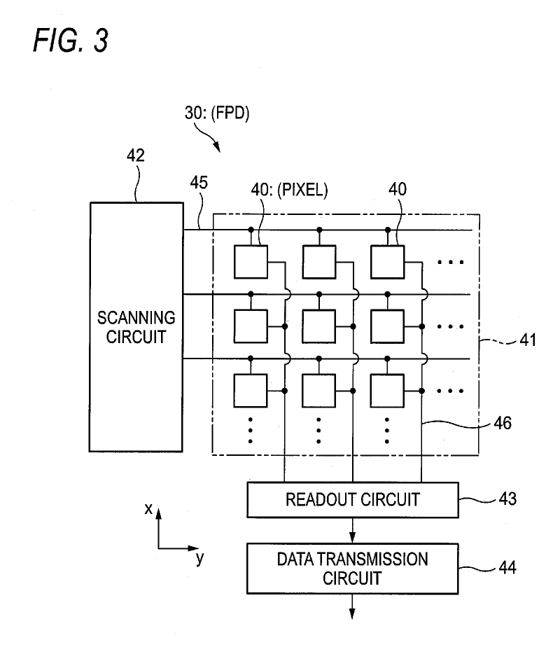

FIG. 3 shows a configuration of the radiological image detector that is included in the radiographic system of FIG. 1.

The FPD 30 serving as the radiological image detector includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the I/F 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40 can be configured as a direct conversion type element that directly converts the X-ray into charges with a conversion layer (not shown) made of amorphous selenium and the like and accumulates the converted charges in a capacitor (not shown) connected to a lower electrode of the conversion layer. Each pixel 40 is connected with a TFT switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

Meanwhile, each pixel 40 may be also configured as an indirect conversion type X-ray detection element that converts the X-ray into visible light with a scintillator (not shown) made of terbium-doped gadolinium oxysulfide (Gd₂O₂S:Tb), thallium-doped cesium iodide (CsI:Tl) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory, which are not shown. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs an offset correction, a gain correction and a linearity correction for the image data and stores the image data after the corrections in the image memory. Meanwhile, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

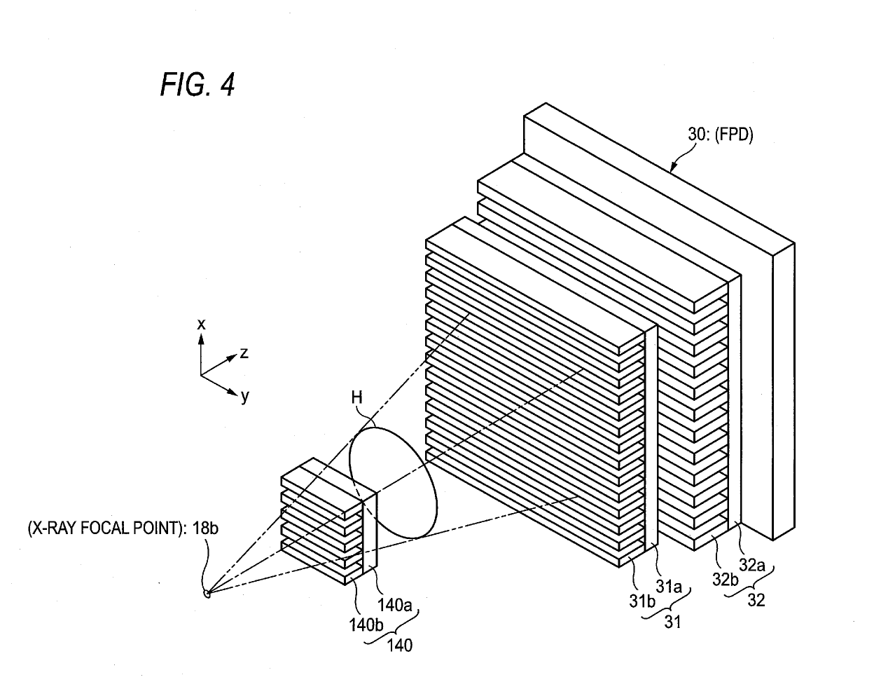

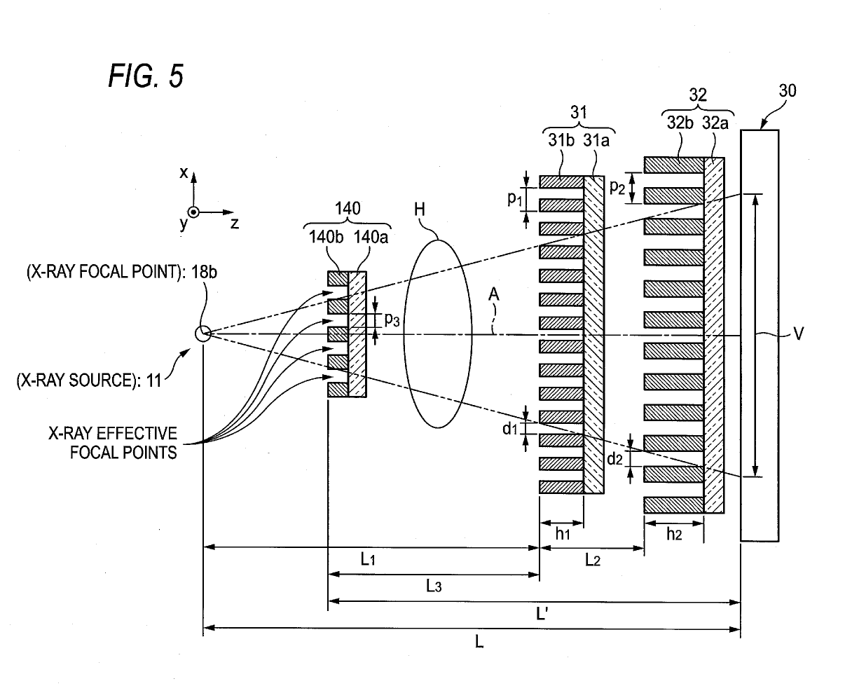

FIGS. 4 and 5 pictorially show the multi-slit 140, the first and second gratings 31, 32 and the FPD 30.

First, the configurations of the first and second gratings 31, 32 and an operation of forming a moiré fringe by the first and second gratings 31, 32 are described.

The first absorption type grating 31 has a substrate 31a and a plurality of X-ray shield units 31b arranged on the substrate 31a. Likewise, the second absorption type grating 32 has a substrate 32a and a plurality of X-ray shield units 32b arranged on the substrate 32a. The substrates 31a, 32a are configured by radiolucent members through which the X-ray penetrates, such as glass.

The X-ray shield units 31b, 32b are configured by linear members extending in in-plane one direction (in the shown example, a y direction orthogonal to the x and z directions) orthogonal to the optical axis A of the X-ray irradiated from the X-ray source 11. As the materials of the respective X-ray shield units 31b, 32b, materials having excellent X-ray absorption ability are preferable. For example, the heavy metal such as gold, platinum and the like is preferable. The X-ray shield units 31b, 32b can be formed by the metal plating or deposition method.

The X-ray shield units 31b are arranged on the in-plane orthogonal to the optical axis A of the X-ray with a constant pitch p₁ and at a predetermined interval d₁ in the direction (x direction) orthogonal to the one direction. Likewise, the X-ray shield units 32b are arranged on the in-plane orthogonal to the optical axis A of the X-ray with a constant pitch p₂ and at a predetermined interval d₂ in the direction (x direction) orthogonal to the one direction.

Since the first and second absorption type gratings 31, 32 provide the incident X-ray with an intensity difference, rather than the phase difference, they are also referred to as amplitude type gratings. In the meantime, the slit (area of the interval d₁ or d₂) may not be a void. For example, the void may be filled with X-ray low absorption material such as high molecule or light metal.

The first and second absorption type gratings 31, 32 are adapted to geometrically project the X-ray having passed through the slits, regardless of the Talbot interference effect.

Specifically, the intervals d₁, d₂ are set to be sufficiently larger than a peak wavelength of the X-ray irradiated from the X-ray source 11, so that most of the X-ray included in the irradiated X-ray is enabled to pass through the slits while keeping the linearity thereof, without being diffracted in the slits. For example, when the rotary anode 18a is made of tungsten and the tube voltage is 50 kV, the peak wavelength of the X-ray is about 0.4 Å. In this case, when the intervals d₁, d₂ are set to be about 1 to 10 nm, most of the X-ray is geometrically projected in the slits without being diffracted.

Since the X-ray irradiated from the X-ray source 11 is a conical beam having the X-ray focal point 18b as an emitting point, rather than a parallel beam, a projection image (hereinafter, referred to as G1 image), which has passed through the first absorption type grating 31 and is projected, is enlarged in proportion to a distance from the X-ray focal point 18b. The grating pitch p₂ and the interval d₂ of the second absorption type grating 32 are determined so that the slits substantially coincide with a periodic pattern of bright parts of the G1 image at the position of the second absorption type grating 32. That is, when a distance from the X-ray focal point 18b to the first absorption type grating 31 is L₁ and a distance from the first absorption type grating 31 to the second absorption type grating 32 is L₂, the grating pitch p₂ and the interval d₂ are determined to satisfy following equations (1) and (2).

Also, the equations and descriptions thereof relate to a configuration in which the multi-slit is not arranged and the equations in a configuration in which the multi-slit is arranged will be described later.

$$\begin{matrix}[ equation 1 ] & \\ {p}_{2} = \frac{{L}_{1} + {L}_{2}}{{L}_{1}} {p}_{1} & ( 1 ) \\ [ equation 2 ] & \\ {d}_{2} = \frac{{L}_{1} + {L}_{2}}{{L}_{1}} {d}_{1} & ( 2 )\end{matrix}$$

In the Talbot interferometer, the distance L₂ from the first absorption type grating 31 to the second absorption type grating 32 is restrained with a Talbot interference distance that is determined by a grating pitch of a first diffraction grating and an X-ray wavelength. However, in the imaging unit 12 of the X-ray imaging system 10 of this illustrative embodiment, since the first absorption type grating 31 projects the incident X-ray without diffracting the same and the G1 image of the first absorption type grating 31 is similarly obtained at all positions of the rear of the first absorption type grating 31, it is possible to set the distance L₂ irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p₁ of the first absorption type grating 31, the grating pitch p₂ of the second absorption type grating 32, the X-ray wavelength (peak wavelength) λ and a positive integer m.

$$\begin{matrix}[ equation 3 ] & \\ Z = m \frac{{p}_{1} {p}_{2}}{λ} & ( 3 )\end{matrix}$$

The equation (3) indicates a Talbot interference distance when the X-ray irradiated from the X-ray source 11 is a conical beam and is known by Atsushi Momose, et al. (Japanese Journal of Applied Physics, Vol. 47, No. 10, 2008, August, page 8077).

In the X-ray imaging system 10, the distance L₂ is set to be shorter than the minimum Talbot interference distance Z when m=1 so as to make the imaging unit 12 smaller. That is, the distance L₂ is set by a value within a range satisfying a following equation (4).

$$\begin{matrix}[ equation 4 ] & \\ {L}_{2} < \frac{{p}_{1} {p}_{2}}{λ} & ( 4 )\end{matrix}$$

In addition, when the X-ray irradiated from the X-ray source 11 can be considered as a substantially parallel beam, the Talbot interference distance Z is expressed by a following equation (5) and the distance L₂ is set by a value within a range satisfying a following equation (6).

$$\begin{matrix}[ equation 5 ] & \\ Z = m \frac{{p}_{1}^{2}}{λ} & ( 5 ) \\ [ equation 6 ] & \\ {L}_{2} < \frac{{p}_{1}^{2}}{λ} & ( 6 )\end{matrix}$$

In order to generate a period pattern image having high contrast, it is preferable that the X-ray shield units 31b, 32b perfectly shield (absorb) the X-ray. However, even when the materials (gold, platinum and the like) having excellent X-ray absorption ability are used, many X-rays penetrate the X-ray shield units without being absorbed. Accordingly, in order to improve the shield ability of X-ray, it is preferable to make thickness h₁, h₂ of the X-ray shield units 31b, 32b thicker as much as possible, respectively. For example, when the tube voltage of the X-ray tube 18 is 50 kV, it is preferable to shield 90% or more of the irradiated X-ray. In this case, the thickness h₁, h₂ are preferably 30 nm or larger, based on gold (Au).

In the meantime, when the thickness h₁, h₂ of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction (strip band direction) of the X-ray shield units 31b, 32b is narrowed. Therefore, from a standpoint of securing the field of view, the upper limits of the thickness h₁, h₂ are defined. In order to secure a length V of the effective field of view in the x direction on the detection surface of the FPD 30, when a distance from the X-ray focal point 18b to the detection surface of the FPD 30 is L, the thickness h₁, h₂ are necessarily set to satisfy following equations (7) and (8), from a geometrical relation shown in FIG. 5.

$$\begin{matrix}[ equation 7 ] & \\ {h}_{1} \leq \frac{L}{V / 2} {d}_{1} & ( 7 ) \\ [ equation 8 ] & \\ {h}_{2} \leq \frac{L}{V / 2} {d}_{2} & ( 8 )\end{matrix}$$

For example, when d₁=2.5 μm, d₂=3.0 μm and L=2 m, assuming a typical diagnose in a typical hospital, the thickness h₁ should be 100 μm or smaller and the thickness h₂ should be 120 μm or smaller so as to secure a length of 10 cm as the length V of the effective field of view in the x direction.

In the imaging unit 12 configured as described above, when the photographic subject H is not arranged, the image contrast is generated in the X-ray by the superimposition of the G1 image of the first absorption type grating 31 and the second absorption type grating 32. The image contrast is captured by the FPD 30. A pattern period p₁′ of the G1 image at the position of the second absorption type grating 32 and a substantial grating pitch p₂′ (substantial pitch after the manufacturing) of the second absorption type grating 32 are slightly different depending on the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p₁′ of the G1 image and the grating pitch p₂′, the image contrast becomes a moiré fringe. A period T of the moiré fringe is expressed by a following equation (9).

$$\begin{matrix}[ equation 9 ] & \\ T = \frac{p {1}^{′} \times p {2}^{′}}{\vert p {1}^{′} - p {2}^{′} \vert} & ( 9 )\end{matrix}$$

When it is intended to detect the moiré fringe with the FPD 30, an arrangement pitch P of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P is not an integer multiple of the moiré period T. Even for a case of n≧2, it is possible to detect the moiré fringe in principle. The equation (11) means that the arrangement pitch P is set to be smaller than the moiré period T.

Since the arrangement pitch P of the pixels 40 of the FPD 30 are design-determined (in general, about 100 nm) and it is difficult to change the same, when it is intended to adjust a magnitude relation of the arrangement pitch P and the moiré period T, it is preferable to adjust the positions of the first and second absorption type gratings 31, 32 and to change at least one of the pattern period p₁′ of the G1 image and the grating pitch p₂′, thereby changing the moiré period T.

In the below, the configuration of the multi-slit 140 is described. The multi-slit 140 is an absorption type grating (i.e., third absorption grating) having the same configuration as the first and second absorption type gratings 31, 32. The multi-slit 140 has a substrate 140a that is a radiolucent member and a plurality of X-ray shield units 140b that is made of a material having a high X-ray absorption ability and is formed on the substrate 140a. The X-ray shield units 140b extend in the same direction (y direction) as the X-ray shield units 31b, 32b and are periodically arranged with a constant pitch p₃ in the same direction (x direction) as the X-ray shield units 31b, 32b. The multi-slit 140 is to partially shield the radiation emitted from the X-ray source 11 by the X-ray shield units 140b, thereby reducing the effective focus size in the x direction and forming a plurality of point light sources (disperse radiation sources) in the x direction.

It is necessary to set a grating pitch p₃ of the multi-slit 140 so that it satisfies a following equation (12), when a distance from the multi-slit 140 to the first absorption type grating 31 is L₃.

$$\begin{matrix}[ equation 12 ] & \\ {p}_{3} = \frac{{L}_{3}}{{L}_{2}} {p}_{2} & ( 12 )\end{matrix}$$

Also, in this illustrative embodiment, since the position of the multi-slit 140 is substantially the X-ray focal point, the grating pitch p₂ and the interval d₂ of the second absorption type grating 32 are determined to satisfy following equations (13) and (14).

$$\begin{matrix}[ equation 13 ] & \\ {p}_{2} = \frac{{L}_{3} + {L}_{2}}{{L}_{3}} {p}_{1} & ( 13 ) \\ [ equation 14 ] & \\ {d}_{2} = \frac{{L}_{3} + {L}_{2}}{{L}_{3}} {d}_{1} & ( 14 )\end{matrix}$$

Also, in this illustrative embodiment, in order to secure a length V of the effective field of view in the x direction on the detection surface of the FPD 30, when a distance from the multi-slit 140 to the detection surface of the FPD 30 is U, the thickness h₁, h₂ of the X-ray shield units 31b, 32b of the first and second gratings 31, 32 are determined to satisfy following equations (15) and (16).

$$\begin{matrix}[ equation 15 ] & \\ {h}_{1} \leq \frac{{L}^{′}}{V / 2} {d}_{1} & ( 15 ) \\ [ equation 16 ] & \\ {h}_{2} \leq \frac{{L}^{′}}{V / 2} {d}_{2} & ( 16 )\end{matrix}$$

The equation (12) is a geometrical condition so that the projection images (G1 images) of the X-rays by the first absorption type grating 31, which are emitted from the respective point light sources dispersedly formed by the multi-slit 140, coincide (overlap) at the position of the second absorption type grating 32. Like this, in this illustrative embodiment, the G1 images based on the point light sources formed by the multi-slit 140 are superimposed, so that it is possible to improve the quality of the phase contrast image without lowering the X-ray intensity.

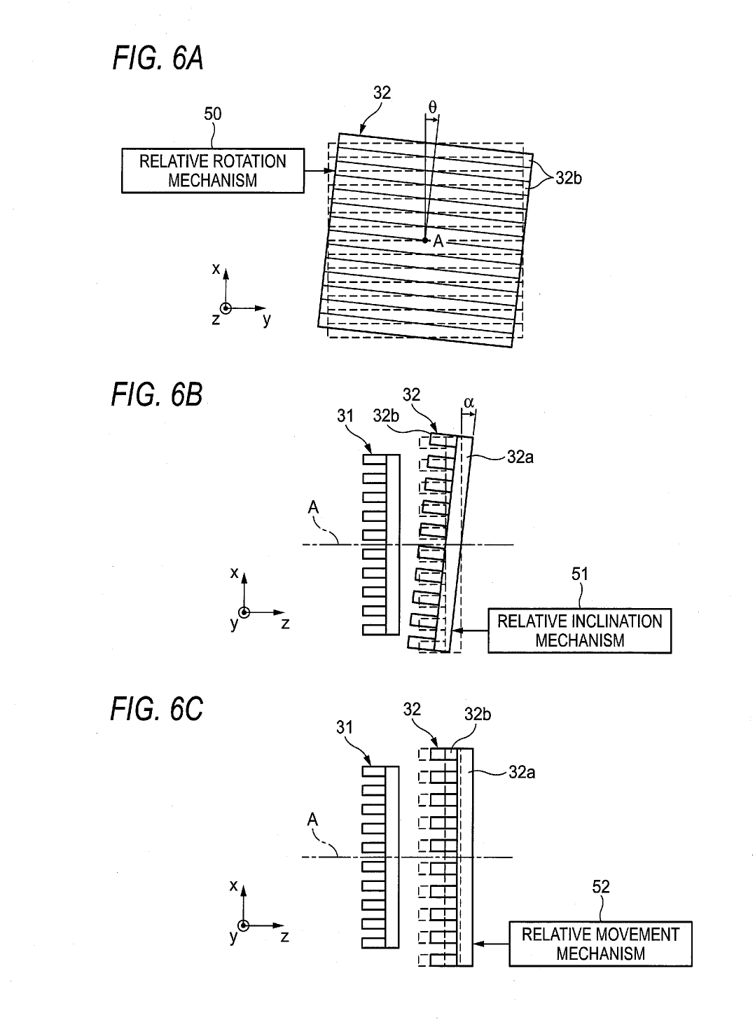

FIGS. 6A to 6C show methods of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle θ by the relative rotation mechanism 50, the substantial grating pitch in the x direction is changed from “p₂′” to “p₂′/cos θ”, so that the moiré period T is changed (refer to FIG. 6A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from “p₂′” to “p₂′×cos α”, so that the moiré period T is changed (refer to FIG. 6B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L₂ between the first absorption type grating 31 and the second absorption type grating 32. When the second absorption type grating 32 is moved along the optical axis A by a moving amount δ by the relative movement mechanism 52, the pattern period of the G1 image of the first absorption type grating 31 projected at the position of the second absorption type grating 32 is changed from “p₁′” to “p₁′×(L₁+L₂+δ)/(L₁+L₂)”, so that the moiré period T is changed (refer to FIG. 6C).

In the X-ray imaging system 10, since the imaging unit 12 is not the Talbot interferometer and can freely set the distance L₂, it can appropriately adopt the mechanism for changing the distance L₂ to thus change the moiré period T, such as the relative movement mechanism 52. The changing mechanisms (the relative rotation mechanism 50, the relative inclination mechanism 51 and the relative movement mechanism 52) of the first and second absorption type gratings 31, 32 for changing the moiré period T can be configured by actuators such as piezoelectric devices.

When the photographic subject H is arranged between the X-ray source 11 and the first absorption type grating 31, the moiré fringe that is detected by the FPD 30 is modulated by the photographic subject H. An amount of the modulation is proportional to the angle of the X-ray that is deviated by the refraction effect of the photographic subject H. Accordingly, it is possible to generate the phase contrast image of the photographic subject H by analyzing the moiré fringe detected by the FPD 30.

In the below, an analysis method of the moiré fringe is described.

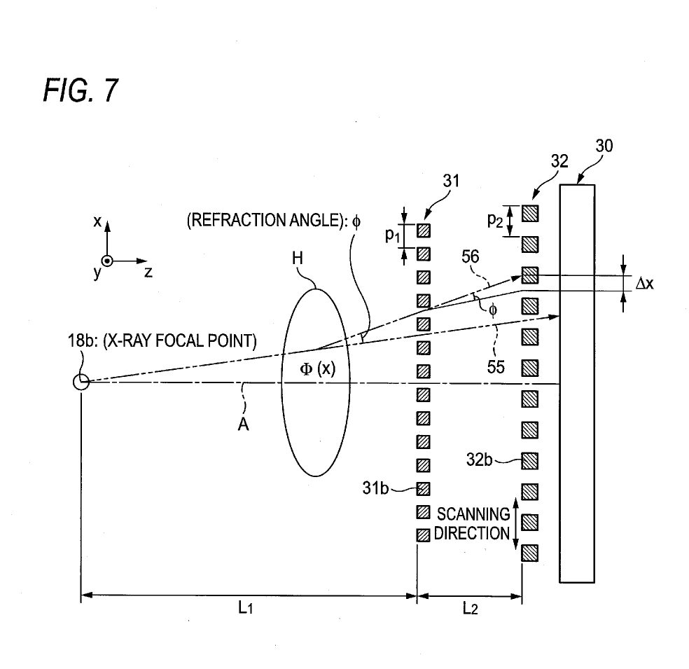

FIG. 7 shows one X-ray that is refracted in correspondence to a phase shift distribution Φ(x) in the x direction of the photographic subject H. In the meantime, the multi-slit 140 is not shown.

A reference numeral 55 indicates a path of the X-ray that goes straight when there is no photographic subject H. The X-ray traveling along the path 55 passes through the first and second absorption type gratings 31, 32 and is then incident onto the FPD 30. A reference numeral 56 indicates a path of the X-ray that is refracted and deviated by the photographic subject H. The X-ray traveling along the path 56 passes through the first absorption type grating 31 and is then shielded by the second absorption type grating 32.

The phase shift distribution Φ(x) of the photographic subject H is expressed by a following equation (17), when a refractive index distribution of the photographic subject H is indicated by n(x, z) and the traveling direction of the X-ray is indicated by z.

$$\begin{matrix}[ equation 17 ] & \\ Φ ( x ) = \frac{2 π}{λ} \int [ 1 - n ( x , z ) ] d z & ( 17 )\end{matrix}$$

The G1 image that is projected from the first absorption type grating 31 to the position of the second absorption type grating 32 is displaced in the x direction as an amount corresponding to a refraction angle φ, due to the refraction of the X-ray at the photographic subject H. An amount of displacement Δx is approximately expressed by a following equation (18), based on the fact that the refraction angle φ of the X-ray is slight.

[equation 18]

Δx≈L₂φ (18)

Here, the refraction angle φ is expressed by an equation (19) using a wavelength λ of the X-ray and the phase shift distribution Φ(x) of the photographic subject H.

$$\begin{matrix}[ equation 19 ] & \\ ϕ = \frac{λ}{2 π} \frac{\partial Φ ( x )}{\partial x} & ( 19 )\end{matrix}$$

Like this, the amount of displacement Δx of the G1 image due to the refraction of the X-ray at the photographic subject H is related to the phase shift distribution Φ(x) of the photographic subject H. Also, the amount of displacement Δx is related to a phase deviation amount ψ of a signal output from each pixel 40 of the FPD 30 (a deviation amount of a phase of a signal of each pixel 40 when there is the photographic subject H and when there is no photographic subject H), as expressed by a following equation (20).

$$\begin{matrix}[ equation 20 ] & \\ ψ = \frac{2 π}{{p}_{2}} Δ x = \frac{2 π}{{p}_{2}} {L}_{2} ϕ & ( 20 )\end{matrix}$$

Therefore, when the phase deviation amount ψ of a signal of each pixel 40 is calculated, the refraction angle φ is obtained from the equation (20) and a differential of the phase shift distribution Φ(x) is obtained by using the equation (19). Hence, by integrating the differential with respect to x, it is possible to generate the phase shift distribution ψ(x) of the photographic subject H, i.e., the phase contrast image of the photographic subject H. In the X-ray imaging system 10 of this illustrative embodiment, the phase deviation amount ω is calculated by using a fringe scanning method that is described below.

In the fringe scanning method, an imaging is performed while one of the first and second absorption type gratings 31, 32 is stepwise translation-moved relatively to the other in the x direction (that is, an imaging is performed while changing the phases of the grating periods of both gratings). In the X-ray imaging system 10 of this illustrative embodiment, the second absorption type grating 32 is moved by the scanning mechanism 33. However, the first absorption type grating 31 may be moved. As the second absorption type grating 32 is moved, the moiré fringe is moved. When the translation distance (moving amount in the x direction) reaches one period (grating pitch p₂) of the grating period of the second absorption type grating 32 (i.e., when the phase change reaches 2π), the moiré fringe returns to its original position. Regarding the change of the moiré fringe, while moving the second absorption type grating 32 by 1/n (n: integer) with respect to the grating pitch p₂, the fringe images are captured by the FPD 30 and the signals of the respective pixels 40 are obtained from the captured fringe images and calculated in the calculation processing unit 22, so that the phase deviation amount ψ of the signal of each pixel 40 is obtained.

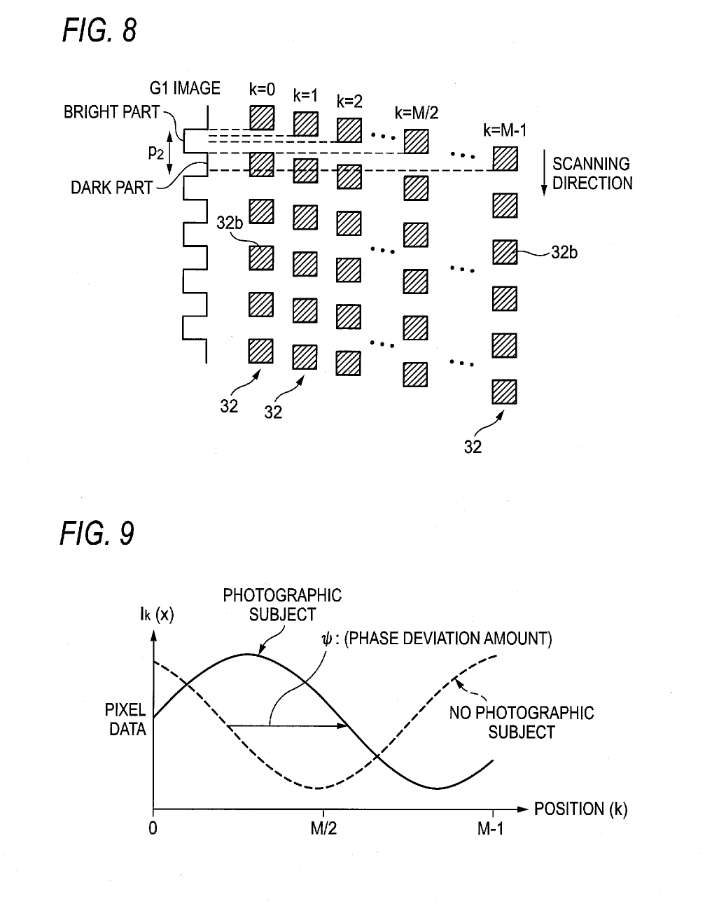

FIG. 8 pictorially shows that the second absorption type grating 32 is moved with a scanning pitch (p₂/M) (M: integer of 2 or larger) that is obtained by dividing the grating pitch p₂ into M.

The scanning mechanism 33 sequentially translation-moves the second absorption type grating 32 to each of M scanning positions of k=0, 1, 2, . . . , M−1. In FIG. 8, an initial position of the second absorption type grating 32 is a position (k=0) at which a dark part of the G1 image at the position of the second absorption type grating 32 when there is no photographic subject H substantially coincides with the X-ray shield unit 32b. However, the initial position may be any position of k=0, 1, 2, . . . , M−1.

First, at the position of k=0, mainly, the X-ray that is not refracted by the photographic subject H passes through the second absorption type grating 32. Then, when the second absorption type grating 32 is moved in order of k=1, 2, . . . , regarding the X-ray passing through the second absorption type grating 32, the component of the X-ray that is not refracted by the photographic subject H is decreased and the component of the X-ray that is refracted by the photographic subject H is increased. In particular, at the position of k=M/2, mainly, only the X-ray that is refracted by the photographic subject H passes through the second absorption type grating 32. At the position exceeding k=M/2, contrary to the above, regarding the X-ray passing through the second absorption type grating 32, the component of the X-ray that is refracted by the photographic subject H is decreased and the component of the X-ray that is not refracted by the photographic subject H is increased.

At each position of k=0, 1, 2, . . . , M−1, when the imaging is performed by the FPD 30, M signal values are obtained for the respective pixels 40. In the below, a method of calculating the phase deviation amount ω of the signal of each pixel 40 from the M signal values is described. When a signal value of each pixel 40 at the position k of the second absorption type grating 32 is indicated with Iₖ(x), Iₖ(x) is expressed by a following equation (21).

$$\begin{matrix}[ equation 21 ] & \\ {I}_{k} ( x ) = {A}_{0} + {\sum }_{n > 0} {A}_{n} exp [ 2 π i \frac{n}{{p}_{2}} \{ {L}_{2} ϕ ( x ) + \frac{{kp}_{2}}{M} \} ] & ( 21 )\end{matrix}$$

Here, x is a coordinate of the pixel 40 in the x direction, A₀ is the intensity of the incident X-ray and Aₙ is a value corresponding to the contrast of the signal value of the pixel 40 (n is a positive integer). Also, φ(x) indicates the refraction angle φ as a function of the coordinate x of the pixel 40.

Then, when a following equation (22) is used, the refraction angle φ(x) is expressed by a following equation (23).

$$\begin{matrix}[ equation 22 ] & \\ {\sum }_{k = 0}^{M - 1} exp ( - 2 π i \frac{k}{M} ) = 0 & ( 22 ) \\ [ equation 23 ] & \\ ϕ ( x ) = \frac{{p}_{2}}{2 π {L}_{2}} arg [ {\sum }_{K = 0}^{M - 1} {I}_{k} ( x ) exp ( - 2 π i \frac{k}{M} ) ] & ( 23 )\end{matrix}$$

Here, arg[ ] means the extraction of an angle of deviation and corresponds to the phase deviation amount ψ of the signal of each pixel 40. Therefore, from the M signal values obtained from the respective pixels 40, the phase deviation amount ψ of the signal of each pixel 40 is calculated based on the equation (18), so that the refraction angle φ(x) is acquired.

FIG. 9 shows a signal of one pixel of the radiological image detector, which is changed depending on the fringe scanning.

The M signal values obtained from the respective pixels 40 are periodically changed with the period of the grating pitch p₂ with respect to the position k of the second absorption type grating 32. The broken line of FIG. 9 indicates the change of the signal value when there is no photographic subject H and the solid line of FIG. 9 indicates the change of the signal value when there is the photographic subject H. A phase difference of both waveforms corresponds to the phase deviation amount ψ of the signal of each pixel 40.

Since the refraction angle φ(x) is a value corresponding to the differential phase value, as shown with the equation (14), the phase shift distribution Φ(x) is obtained by integrating the refraction angle φ(x) along the x axis.

The above calculations are performed by the calculation processing unit 22 and the calculation processing unit 22 stores the phase contrast image in the image storage unit 23.

After the operator inputs the imaging instruction through the input device 21, the respective units operate in cooperation with each other under control of the control device 20, so that the fringe scanning and the generation process of the phase contrast image are automatically performed and the phase contrast image of the photographic subject H is finally displayed on the monitor 24.

Also, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical fields, as the X-ray source 11. In the meantime, since it is possible to arbitrarily set the distance L₂ from the first absorption type grating 31 to the second absorption type grating 32 and to set the distance L₂ to be smaller than the minimum Talbot interference distance of the Talbot interferometer, it is possible to miniaturize the imaging unit 12. Further, in the X-ray imaging system of this illustrative embodiment, since the substantially entire wavelength components of the irradiated X-ray contribute to the projection image (G1 image) from the first absorption type grating 31 and the contrast of the moiré fringe is thus improved, it is possible to improve the detection sensitivity of the phase contrast image.

In the X-ray phase imaging by the fringe scanning method of using the first and second gratings 31, 32, when measuring the very slight change amounts related to the refraction angle φ of the X-ray, the phase deviation amount ψ of the G1 image, the intensity modulation signal and the like, it is not possible to ignore the influences of the thermal expansions of the multi-slit 140 and the first and second gratings 31, 32. The refraction angle φ of the X-ray when penetrating the photographic subject H is very slight such as several μrad, so that the phase deviation amount ψ of the radiological image resulting from the refraction angle φ, i.e., the signal change amounts for the respective pixels are also very small. The signal change amounts for the respective pixels are obtained by performing a plurality of imaging while displacing the relative positions of the first and second gratings 31, 32 by one period of the slit interval of the grating. When performing the plurality of imaging, the relative moving amounts of the first and second gratings 31, 32 are slight. Accordingly, when the respective relative positions of the multi-slit 140 and the first and second gratings 31, 32 are deviated even slightly due to the thermal expansions, it may seriously influence the quality of the phase contrast image. That is, the respective relative positions of the multi-slit 140 and the first and second gratings 31, 32 are very important.

Here, the multi-slit 140 that is arranged near the X-ray source 11 is particularly apt to be thermally expanded and may cause the high heat distortion as the heat generated from the X-ray source is spread thereto. Therefore, the thermal expansion of the multi-slit 140 highly influences the quality of the phase contrast image. When the multi-slit 140 is thermally expanded, the pitch p₃ of the multi-slit 140 and the distance L₃ between the multi-slit 140 and the first grating 31, which are geometrically determined by the equations (12) to (14), are changed, so that the G1 images for each of the disperse focal points of the disperse radiation sources formed by the multi-slit 140 are not superimposed at the position of the second grating 32 and the G1 images superimposed at the position of the second grating 32 are blurred in the x direction. As a result, the contrast of the G1 image is considerably deteriorated. Like this, when the disperse focal points of the disperse radiation sources and the respective relative positions of the first and second gratings 31, 32 are deviated due to the thermal expansion of the multi-slit 140, the same result as the deviation of the respective relative positions of the X-ray focal point 18b (X-ray actual focal point) and the first and second gratings 31, 32 is caused. When the contrast of the G1 image is deteriorated, the contrast of the intensity change that is detected by the radiological image detector is lowered and a calculation error is caused in the X-ray phase imaging that is organized based on the intensity change. Thereby, the quality deterioration such as the contrast or resolution deterioration in the phase contrast image is caused.

Also, the relative relations of the grating periods (pitches) p₁, p₂ and the slit intervals d₁, d₂ of the first and second gratings 31, 32 are geometrically determined with respect to the respective distances L₁, L₂ between the X-ray focal points (effective disperse focal points relative to the X-ray focal point 18b (X-ray actual focal point)) and the first and second gratings 31, 32. Thereby, when the distances L₁, L₂ are relatively deviated due to the thermal expansion of the multi-slit 140 and the like, a magnification power is changed, so that a ratio of the pitch p₂ of the second grating 32 to the pitch p₁ of the G1 image is deviated and a moiré of the spatial frequency is generated in correspondence to the deviation. Regarding the moiré, a correction process can be performed such an extent that a problem is not caused for an image, by using separately acquired reference images just before and after the imaging or performing a very suitable filtering process. However, it is very difficult to correct the moiré in which the spatial frequency is changed depending on the relative deviation amounts of the X-ray focal points and the respective gratings (the moiré that is difficult to remove can be referred to as the artifact). Also in this regard, the quality of the phase contrast image is deteriorated.

Accordingly, the heat insulation member 150 is arranged at the X-ray source 11-side of the multi-slit 140, so that the heat spread from the X-ray source 11 to the multi-slit 140 is blocked. The X-ray source 11 of the X-ray imaging system is the heat generation source of the highest temperature. By providing the heat insulation member 150, it is possible to remove most of the causes of the thermal expansion of the multi-slit 140, so that it is possible to sufficiently suppress the thermal expansion of the multi-slit 140. Thereby, it is possible to suppress the contrast deterioration of the intensity change detected in the FPD 30 and the quality deterioration of the phase contrast image.

The relative position relations of the multi-slit 140 and the first and second gratings 31, 32 are important in the scanning direction (x direction) for acquiring the phase contrast image, particularly. By the heat insulation member 150, it is possible to sufficiently reduce the relative position deviations of the multi-slit 140 and the first and second gratings 31, 32 in the x direction with respect to the scanning pitch (for example, about 1 μm) by the scanning mechanism 33. Thereby, even when the temperature is changed while the plurality of imaging is performed by the FPD 30, it is possible to obtain the phase contrast image based on the images captured at the appropriate relative positions of the multi-slit 140 and the first and second gratings 31, 32.

Also, when the temperature is changed at the time of reference scanning (pre-scanning) in which the grating pattern image of the radiation is acquired as a reference image at a state in which there is no photographic subject and at the time of main scanning in which the grating pattern image of the radiation is acquired at a state in which the photographic subject is interposed, the relative initial positions of the first and second gratings at each scanning are changed, so that an unexpected phase deviation amount offset is generated in measurements. However, since it is possible to prevent the phase deviation amount offset, it is possible to secure a precise measurement result. Like this, since the quality deterioration of the phase contrast image, which is caused when the multi-slit 140 is thermally expanded, is suppressed, it is possible to capture the very appropriate phase contrast image.

Likewise the thermal expansion of the multi-slit 140, the vibration that is transferred to the multi-slit 140 also causes the relative position deviations of the multi-slit 140 and the first and second gratings 31, 32. As described above, since the heat insulation member 150 also serves as a vibration-proof member, it is possible to block the vibration transfer from the X-ray tube 18 or cooling fan to the multi-slit 140. Therefore, it is possible to suppress the quality deterioration of the phase contrast image more securely.

In the X-ray phase imaging by the fringe scanning method of using the first and second absorption type gratings 31, 32, the thermal expansion or vibration measure for precisely keeping the relative positions of the multi-slit 140 and the first and second gratings 31, 32 is particularly important from a standpoint of the phase detection accuracy. Regarding this, it is very meaningful that at least one of the causes of the relative position deviations of the gratings is removed by the heat insulation member 150.

Also, in the X-ray imaging system 10, the refraction angle φ is calculated by performing the fringe scanning for the projection image of the first grating. Thus, it has been described that both the first and second gratings are the absorption type gratings. However, the invention is not limited thereto. As described above, the invention is also useful even when the refraction angle φ is calculated by performing the fringe scanning for the Talbot interference image. Accordingly, the first grating is not limited to the absorption type grating and may be a phase type grating. Also, the analysis method of the moiré fringe that is formed by the superimposition of the X-ray image of the first grating and the second grating is not limited to the above fringe scanning method. For example, a variety of methods using the moiré fringe, such as method of using Fourier transform/inverse Fourier transform known in “J. Opt. Soc. Am. Vol. 72, No. 1 (1982) p. 156”, may be also applied.

Also, it has been described that the X-ray imaging system 10 stores or displays, as the phase contrast image, the image based on the phase shift distribution Φ. However, as described above, the phase shift distribution Φ is obtained by integrating the differential of the phase shift distribution Φ obtained from the refraction angle φ, and the refraction angle φ and the differential of the phase shift distribution Φ are also related to the phase change of the X-ray by the photographic subject. Accordingly, the image based on the refraction angle φ and the image based on the differential of the phase shift distribution Φ are also included in the phase contrast image.

In addition, it may be possible to prepare a phase differential image (differential amount of the phase shift distribution Φ) from an image group that is acquired by performing the imaging (pre-imaging) at a state in which there is no photographic subject. The phase differential image reflects the phase non-uniformity of a detection system (that is, the phase differential image includes a phase deviation by the moiré, a grid non-uniformity, a refraction of a radiation dose detector, and the like). Also, by preparing a phase differential image from an image group that is acquired by performing the imaging (main imaging) at a state in which there is a photographic subject and subtracting the phase differential image acquired in the pre-imaging from the phase differential image acquired in the main imaging, it is possible to acquire a phase differential image in which the phase non-uniformity of a measuring system is corrected.

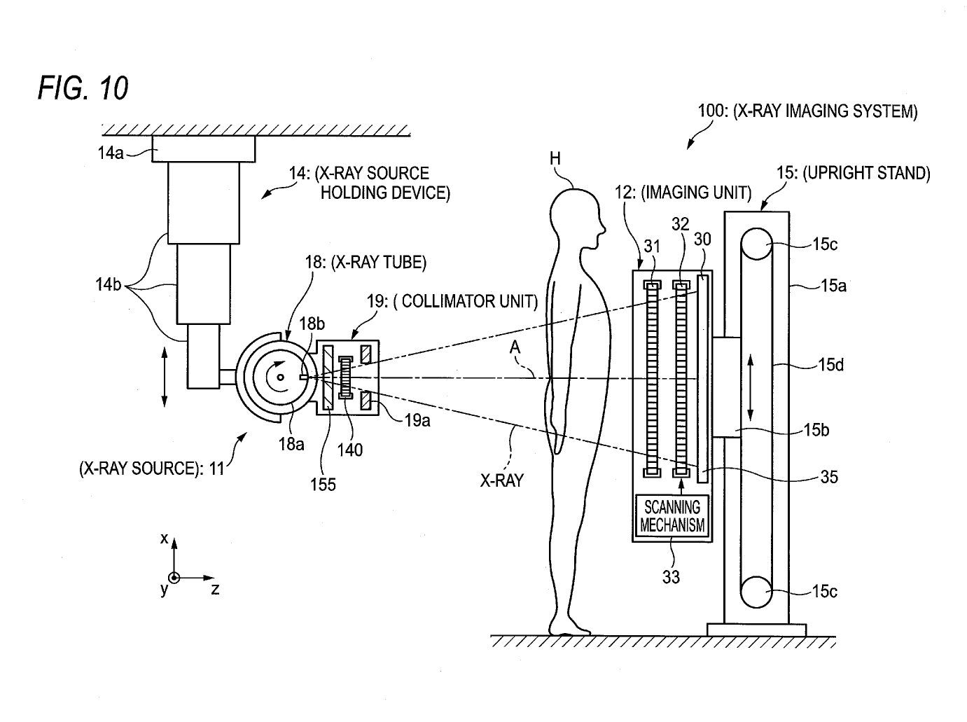

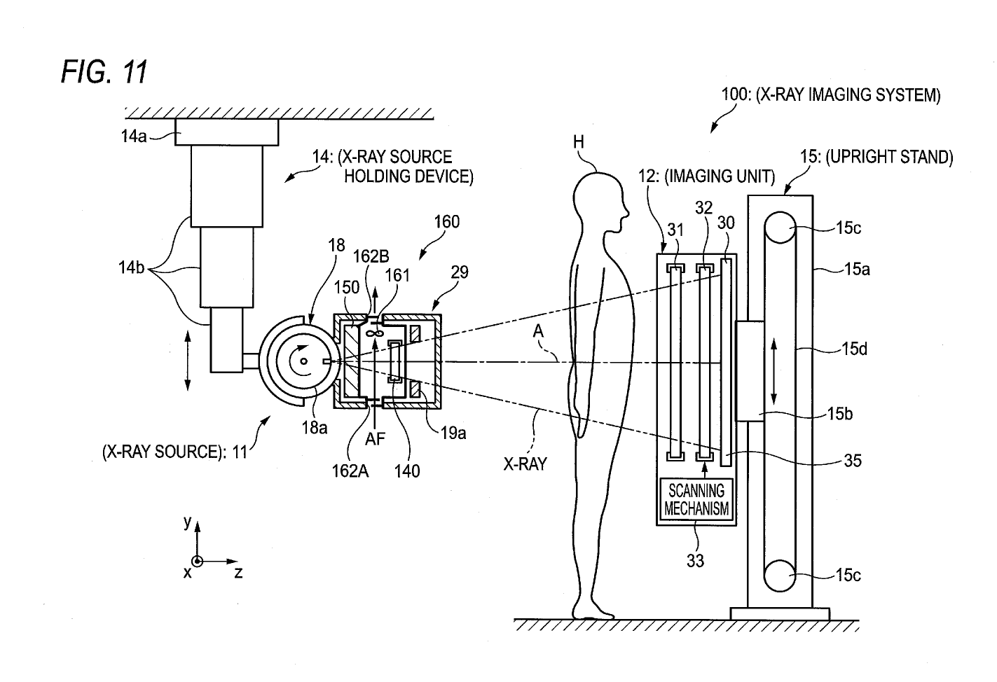

FIG. 10 shows a configuration in which an infrared cutoff filter 155 is provided as a heat insulation member, instead of the above-described heat insulation member 150.

Also, the same configurations as those already described are indicated with the same reference numerals and the descriptions thereof are omitted. The differences from the configurations already described will be described.

Since the infrared cutoff filter 155 shields an infrared component due to the heat generated from the X-ray source 11, it is possible to prevent the temperature of the multi-slit 140 from being increased. Thereby, it is possible to suppress the thermal expansion of the multi-slit 140. Also, a structure in which a dielectric thin film is formed on a resin substrate or resin film is more preferable as the infrared cutoff filter because the X-ray is less absorbed.

Here, the heat insulation member that is arranged between the X-ray source 11 and the multi-slit 140 may be configured by both the heat insulation member 150 made of the foamed material and the infrared cutoff filter 155. Thereby, it is possible to increase the heat insulation effect. In this case, the heat insulation member 150 is arranged at the X-ray source 11-side of the infrared cutoff filter 155, so that it is possible to prevent the deterioration of the infrared cutoff filter 155 due to the X-ray absorption.

In the respective embodiments, the multi-slit 140 and the heat insulation member are provided in the collimator unit 19. However, the multi-slit 140 and the heat insulation member may be provided at the outside of the collimator unit 19.

Also, although the collimator unit 19 is held at the housing of the X-ray source 11, the collimator unit 19 may be held by a holding structure separate from the X-ray source holding device 14.

That is, the multi-slit 140 may be separately provided from the X-ray source 11.

FIG. 11 shows another example of the X-ray imaging system for illustrating an illustrative embodiment of the invention. A collimator unit 29 has an air cooling unit 160 for cooling the multi-slit 140.

Also, in FIGS. 11 and 13 to 16, the arrangement direction of the first and second gratings 31, 32 and the multi-slit 140 is different from those of FIG. 1 and the like by 90 degrees. Thus, as shown with the axes of coordinates in FIGS. 11 and 13 to 16, the first and second gratings 31, 32 and the multi-slit 140 are arranged so that the extending direction (y direction) of the X-ray shield units thereof follows the vertical direction.

The air cooling unit 160 includes a fan (air blower) 161 and a duct 162. Also, an X-ray penetration area of the air cooling unit 160 is preferably made of a member having a high X-ray transmittance so as not to attenuate the X-ray. For example, beryllium (Be), an organic compound such as carbon plate and resin or a metal foil having small atomic number such as aluminum (Al) and magnesium (Mg) is preferably used.

The duct 162 has an air introduction port 162A and an air exhaust port 162B. In the duct 162, the multi-slit 140 and the fan 161 are disposed. Also, the air introduction port 162A and the air exhaust port 162B have a labyrinth structure having walls on which X-ray shield members are arranged to alternate each other so that the X-ray is not leaked from the introduction port and the exhaust port. Thereby, the air travels in zigzags but it is possible to shield the X-ray having high linearity.

The air introduction port 162A is provided at a bottom surface part of the collimator unit 29, which is positioned at an opposite side to an upper surface part of the collimator unit 29 at which the convection of heat generated from the X-ray source 11 is apt to occur. Therefore, it is difficult for the air, which is warmed by the heat generated from the X-ray source 11, to enter the air introduction port 162A and the external air having relative low temperature can be introduced into the duct 162, so that it is possible to increase the cooling efficiency.

In the meantime, the air exhaust port 162B is provided at the upper surface part of the housing of the collimator unit 29. As the fan 161 disposed near the air exhaust port 162B performs air suction and exhaust operations, air current AF is formed between the heat insulation member 150 and the multi-slit 140.

Since a direction of the air current AF is parallel with the y direction that is the extending direction of the X-ray shield units 140b of the multi-slit 140 and is not a direction (x direction) crossing the X-ray shield units 140b, it is possible to suppress the vibration of the multi-slit 140 due to the air current AF. Also, since the air current AF flows along a grating surface (xy plane) of the multi-slit 140 and the heat is radiated from the entire grating surface of the multi-slit 140 by the air current AF, it is possible to increase the heat radiation efficiency of the multi-slit 140.

In addition, the respective positions of the air introduction port and the air exhaust port are not limited to the respective positions of the air introduction port 162A and the air exhaust port 162B, which are shown in FIG. 11. For example, the air introduction port and the air exhaust port may be respectively provided on side surfaces of both ends of the collimator unit 29 in the y direction.

Also, it is not necessarily required that the air introduction port and the air exhaust port are arranged on the opposite surfaces of the housing of the collimator unit. For example, a configuration may be possible in which the air current introduced from the air introduction port 162A on the bottom surface of the collimator unit 29 is directed in the y or z direction of FIG. 11 by a rectification plate and the like after it passes through the grating surface of the multi-slit 140 and is then exhausted from the air exhaust port provided on the side surface of the collimator unit 290 in the y or z direction.

The position of the air introduction port is not limited to the lower position of the collimator unit 29 in the x direction, which is shown in FIG. 11. However, a position is preferable at which the temperature of the air is not increased (or a temperature increase degree is small) by the influence of the heat convection from the X-ray source 11. Also, in FIG. 11, the air current AF mainly flows along the surface of the X-ray source 11-side of the multi-slit 140. However, a configuration may be also possible in which the air current flows along both surfaces of the multi-slit and the multi-slit is thus cooled from both surfaces thereof.

For cooling the multi-slit, a water cooling unit, a heat pipe and the like may be appropriately adopted in addition to the air cooling unit.

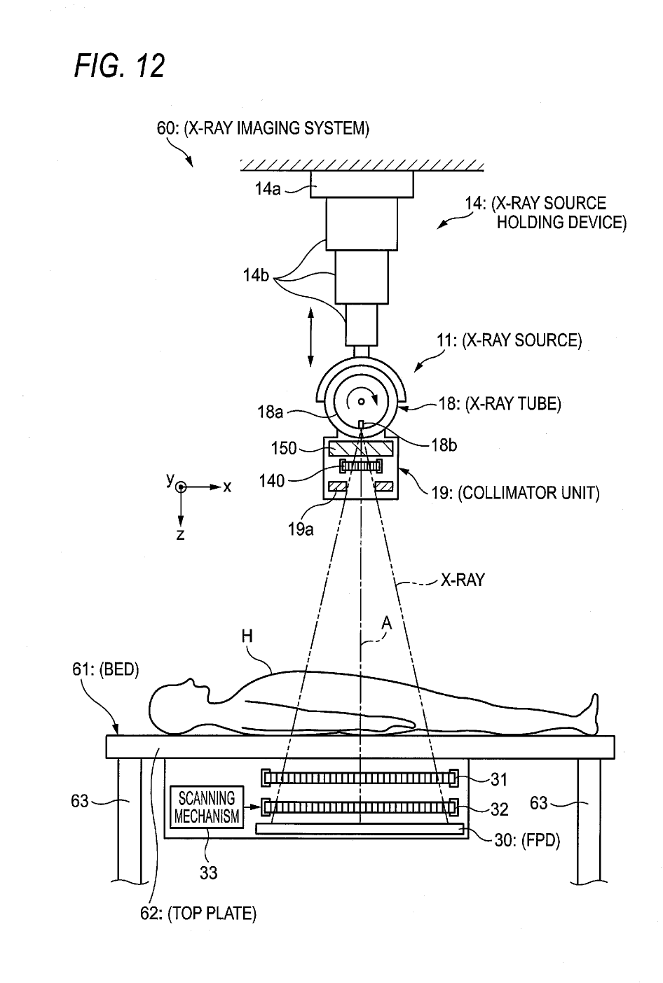

FIG. 12 shows another example of the radiographic system for illustrating an illustrative embodiment of the invention.

An X-ray imaging system 60 is an X-ray diagnosis apparatus that performs an imaging while the photographic subject H (patient) lies down, and includes the X-ray source 11, the imaging unit 12 and a bed 61 on which the photographic subject H lies down.

In this illustrative embodiment, the imaging unit 12 is mounted on a lower surface of a top plate 62 so as to face the X-ray source 11 through the photographic subject H. The X-ray source 11 is held by the X-ray source holding device 14 and the X-ray irradiation direction faces downwards by an angle changing device (not shown) of the X-ray source 11. At this state, the X-ray source 11 irradiates the X-ray toward the photographic subject H that lies down on the top plate 62 of the bed 61. Since the X-ray source holding device 14 can vertically move the X-ray source 11 by the expansion and contraction of the strut units 14b, it is possible to adjust a distance from the X-ray focal point 18b to the detection surface of the FPD 30 by the vertical movement.

As described above, since it is possible to shorten the distance L₂ between the first absorption type grating 31 and the second absorption type grating 32 and to thus miniaturize the imaging unit 12, it is possible to shorten legs 63 supporting the top plate 62 of the bed 61 and to thus lower the position of the top plate 62. For example, it is preferable to miniaturize the imaging unit 12 and to lower the position of the top plate 62 to a height (for instance, about 40 cm from the bottom) at which the photographic subject H (patient) can easily sit. Also, the lowering of the position of the top plate 62 is preferable when securing the sufficient distance from the X-ray source 11 to the imaging unit 12.

In addition, contrary to the position relation between the X-ray source 11 and the imaging unit 12, it may be possible to perform the imaging while the photographic subject H lies down, by attaching the X-ray source 11 to the bed 61 and mounting the imaging unit 12 on the ceiling.

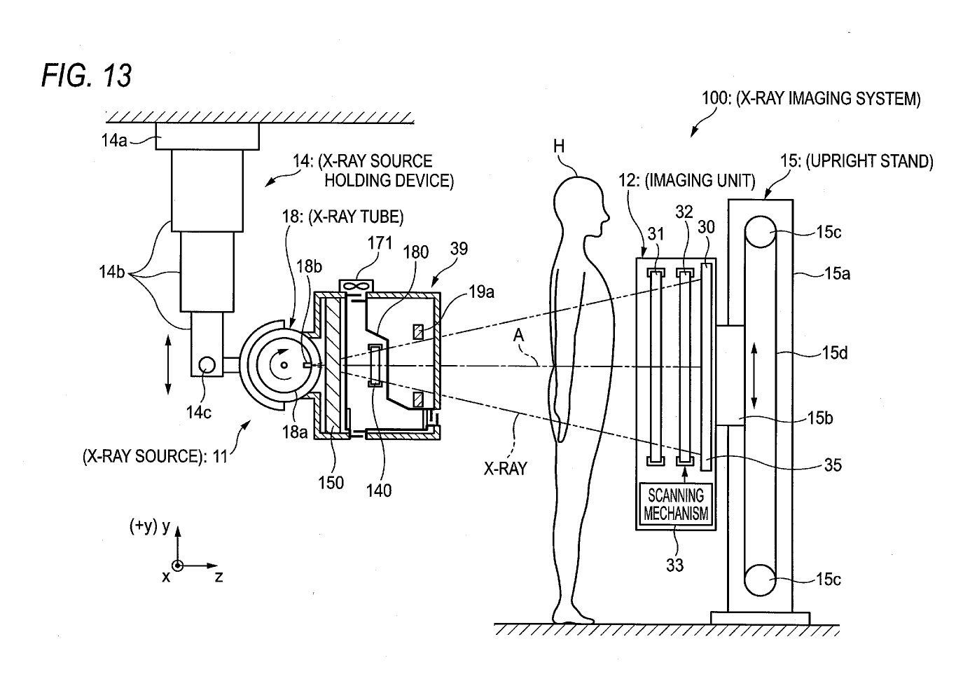

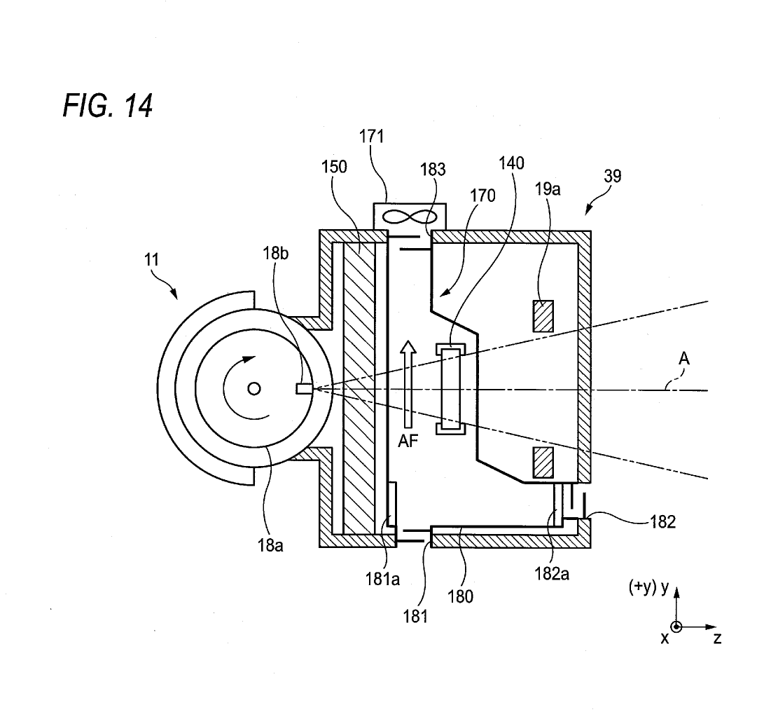

FIGS. 13 and 14 show another example of a configuration of the X-ray imaging system for illustrating an illustrative embodiment of the invention. The X-ray source 11 is rotatably provided relatively to the strut units 14b of the X-ray source holding device 14. The strut units 14b are provided with a rotational shaft 14c along the horizontal direction, so that the X-ray source 11 is rotated about the rotational shaft 14c by a motor (not shown). Therefore, the direction of the optical axis A of the X-ray emitted from the X-ray source 11 can be switched between the horizontal direction as shown in FIG. 13 and the vertical direction as shown in FIG. 12. Also, the optical axis A can be directed in any direction between the horizontal direction and the vertical direction.

When the optical axis A of the X-ray faces in the vertical direction, the X-ray source 11 is combined with the bed 61 as shown in FIG. 12. That is, the X-ray imaging system having the X-ray source 11, the bed 61, the imaging unit 12 mounted below the bed 61 and the console 13 is configured.

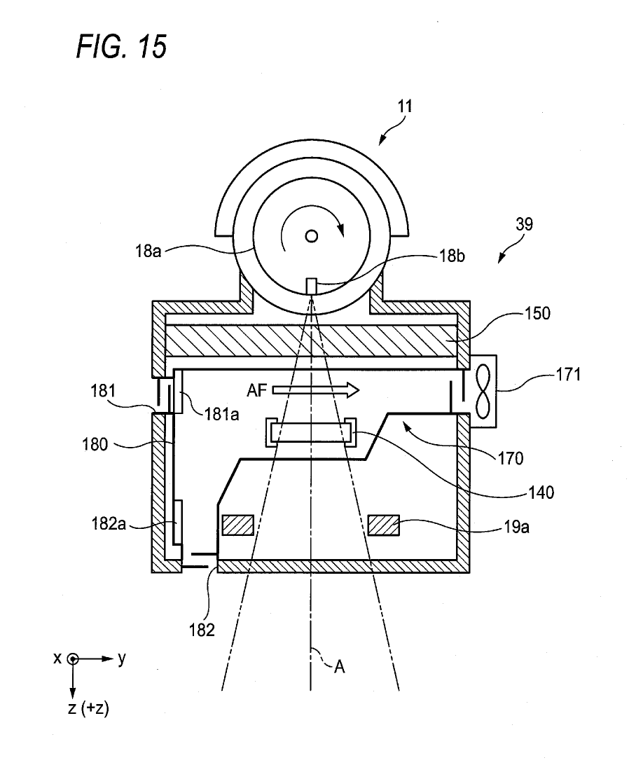

FIGS. 14 and 15 are partial sectional pictorial views of the collimator unit 39. The collimator unit 39 has an air cooling unit 170 that cools the multi-slit 140. The air cooling unit 170 has a fan 171, a duct 180 and a rectification plate (not shown). Also, an X-ray penetration area of the air cooling unit 170 is preferably made of a member having a high X-ray transmittance so as not to attenuate the X-ray. For example, beryllium (Be), an organic compound such as carbon plate and resin or a metal foil having small atomic number such as aluminum (Al) and magnesium (Mg) is preferably used. The duct 180 has two air introduction ports 181, 182 and one air exhaust port 183. The air introduction ports 181, 182 and the air exhaust port 183 have a labyrinth structure having walls on which X-ray shield members are arranged to alternate each other so that the X-ray is not leaked from the introduction ports and the exhaust port. Thereby, although the air travels in zigzags, it is possible to shield the X-ray having high linearity.

The air introduction ports 181, 182 have opening and closing units 181A and 182A, respectively. The fan 171 and the opening and closing units 181A and 182A are respectively connected to the control device 20 through the I/F 25 of the console 13 (refer to FIG. 2). Although not shown, the control device 20 of this illustrative embodiment has an introduction port opening and closing control unit for controlling the opening and closing of the air introduction ports 181, 182 along the direction of the optical axis A. The introduction port opening and closing control unit configures a part of the processing of the control device 20.

The shown configuration indicates an example in which the plurality of air introduction ports 181, 182 are opened and closed in the irradiation direction of the X-ray.

As shown in FIG. 14, when the optical axis A of the X-ray faces in the horizontal direction (for example, when an imaging is performed while the photographic subject stands), the temperature near the upper end of the housing of the collimator unit 39 in the +y direction is increased due to the convection of the heat generated from the X-ray source 11 and the temperature near the air exhaust port 183 that is positioned at the upper end of the duct 180 in the +y direction is increased due to the retention of the heat including the heat radiated from the multi-slit 140. Like this, when the optical axis A faces in the horizontal direction, under control of the introduction port opening and closing control unit, the one air introduction port 181, which is located at a position spaced from the part having temperature increased due to the influence of the convection of the heat generated from the X-ray source 11, i.e., a lower temperature side in the heat convection and located close to the multi-slit 140, is opened and the other air introduction port 182, which is located at a more distant position from the multi-slit 140 than the air introduction port 181, is closed. When the plurality of air introduction ports is provided at the lower temperature side in the convection of the heat generated from the X-ray source 11, as shown in FIG. 14, the air introduction port closer to the multi-slit 140 is opened and the air introduction port distant from the multi-slit 140 is closed. When the optical axis of the X-ray faces in the horizontal direction, the fan 171 performs air suction and exhaust operations, so that the external air is introduced into the duct 180 from the air introduction port 181 and the air current AF is thus formed.

As shown in FIG. 15, when the optical axis A of the X-ray faces in the vertical direction (for example, when an imaging is performed while the photographic subject lies down on the bed), the temperature near the upper end of the housing of the collimator unit 39 in the −z direction is increased due to the convection of the heat generated from the X-ray source 11 and the temperature near the upper end of the duct 180 in the −z direction (the temperature of the upper part of the multi-slit 140) is increased due to the retention of the heat including the heat radiated from the multi-slit 140. Like this, when the optical axis A faces in the vertical direction, under control of the introduction port opening and closing control unit, the air introduction port 182, which is located at a position spaced from the part having temperature increased due to the influence of the convection of the heat generated from the X-ray source 11, i.e., a lower temperature side in the heat convection, is opened and the other air introduction port 181, which is located at a closer position to the temperature increased part than the air introduction port 182, i.e., a higher temperature side in the convection of the heat, is closed.

When the optical axis of the X-ray faces in the vertical direction, the fan 171 performs the air suction and exhaust operations, so that the external air is introduced into the duct 180 from the air introduction port 182 and the air current AF is thus formed.

Like this, the air introduction ports 181, 182 are separately used depending on the direction of the optical axis A. Thereby, even when the rotating position of the X-ray source 11 is changed, it is possible to introduce the external air having the relatively lower temperature in the convection of the heat generated from the X-ray source 11 into the duct 180 and thus to effectively cool the multi-slit 140.

Also, in the configuration of FIGS. 14 and 15, the fan 171 performs the air suction and exhaust operations. However, another fan for air suction may be provided. The position at which the fan is provided is not particularly limited. The air exhaust port 183 is commonly used when the optical axis faces in the horizontal direction and in the vertical direction. However, an air exhaust port that is used when the optical axis faces in the horizontal direction and an air exhaust port that is used when the optical axis faces in the vertical direction may be separately provided.

The collimator unit 39 shown in FIG. 14 can be applied to any of the X-ray imaging systems described in the specification.

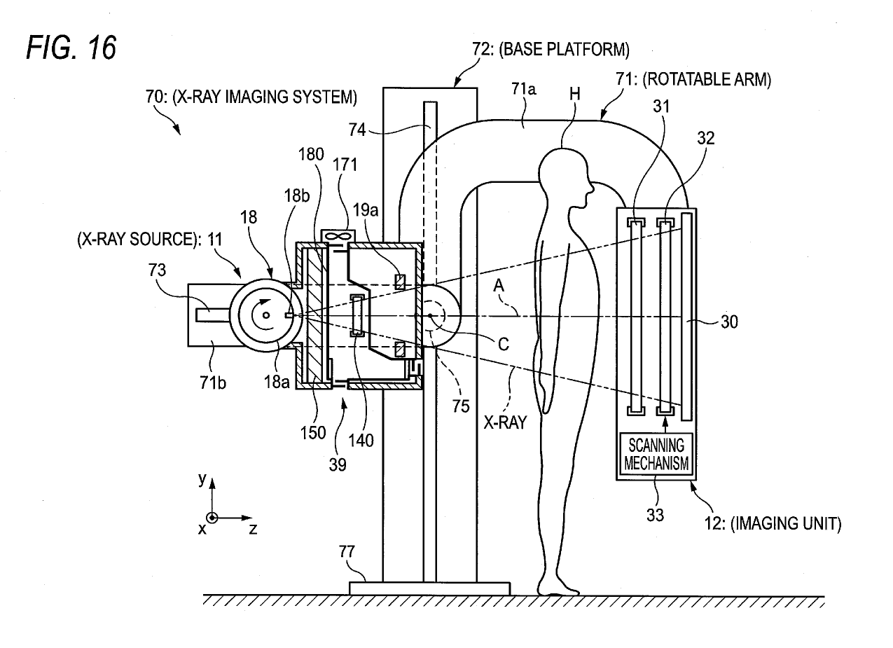

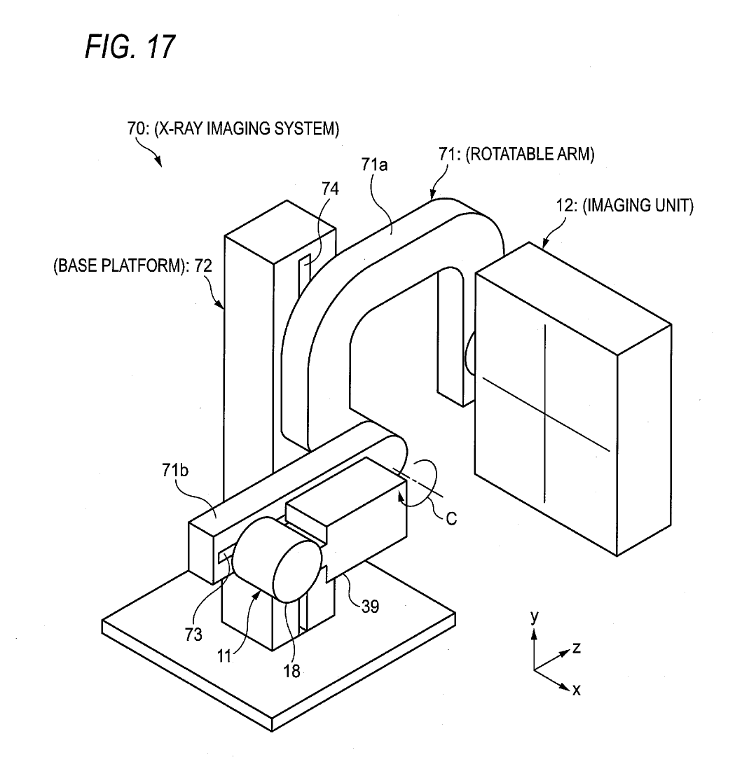

FIGS. 16 and 17 show another example of the X-ray imaging system for illustrating an illustrative embodiment of the invention. An X-ray imaging system 60 is an X-ray diagnosis apparatus that performs an imaging while the photographic subject (patient) H stands and lies down. The X-ray source 11 and the imaging unit 12 are held by a rotational arm 71. The rotational arm 71 is rotatably connected to a base platform 72.

The rotational arm 71 has a U-shaped part 71a having a substantially U shape and a linear part 71b that is connected to one end of the U-shaped part 71a. The other end of the U-shaped part 71a is mounted with the imaging unit 12. The linear part 71b is formed with a first recess 73 along the extending direction thereof. The X-ray source 11 is slidably mounted in the first recess 73. The X-ray source 11 and the imaging unit 12 are opposed to each other. By moving the X-ray source 11 along the first recess 73, it is possible to adjust the distance from the X-ray focal point 18b to the detection surface of the FPD 30.

Also, the base platform 72 is formed with a second recess 74 extending in the upper-lower direction. The rotational arm 71 is adapted to vertically move along the second recess 74 by a connection mechanism 75 that is provided to a connection part of the U-shaped part 71a and the linear part 71b. Also, the rotational arm 71 is adapted to rotate about a rotational axis C following the y direction by the connection mechanism 75. When the rotational arm 71 is 90°-rotated clockwise about the rotational axis C from the standing posture imaging state shown in FIG. 16 and the imaging unit 12 is arranged below a bed (not shown) on which the photographic subject H lies down, it is possible to perform the lying down posture imaging. In the meantime, the rotational arm 71 is not limited to the 90° rotation and can be rotated by an arbitrary angle, so that it is possible to perform the imaging in any direction, in addition to the standing posture imaging (horizontal direction) and the lying down posture imaging (vertical direction). When the rotational arm 71 is 90°-rotated and the imaging unit 12 is arranged below the bed, the imaging is performed with X-ray source 11 being rotated relatively to the linear part 71b and the optical axis A facing in the vertical direction. Since the X-ray imaging system of this illustrative embodiment is provided with the collimator unit 39, the air introduction ports are selectively opened as described above, depending on the direction of the optical axis A. Thereby, it is possible to cool the multi-slit 140 more securely.

In this illustrative embodiment, the X-ray source 11 and the imaging unit 12 are held by the rotational arm 71. Therefore, compared to the above embodiments, it is possible to set the distance from the X-ray source 11 to the imaging unit 12 easily and accurately.

Also, in this illustrative embodiment, the imaging unit 12 is provided to the U-shaped part 71a and the X-ray source 11 is provided to the linear part 71b. However, like an X-ray diagnosis apparatus using a so-called C arm, the imaging unit 12 may be provided to one end of the C arm and the X-ray source 11 may be provided to the other end of the C arm.

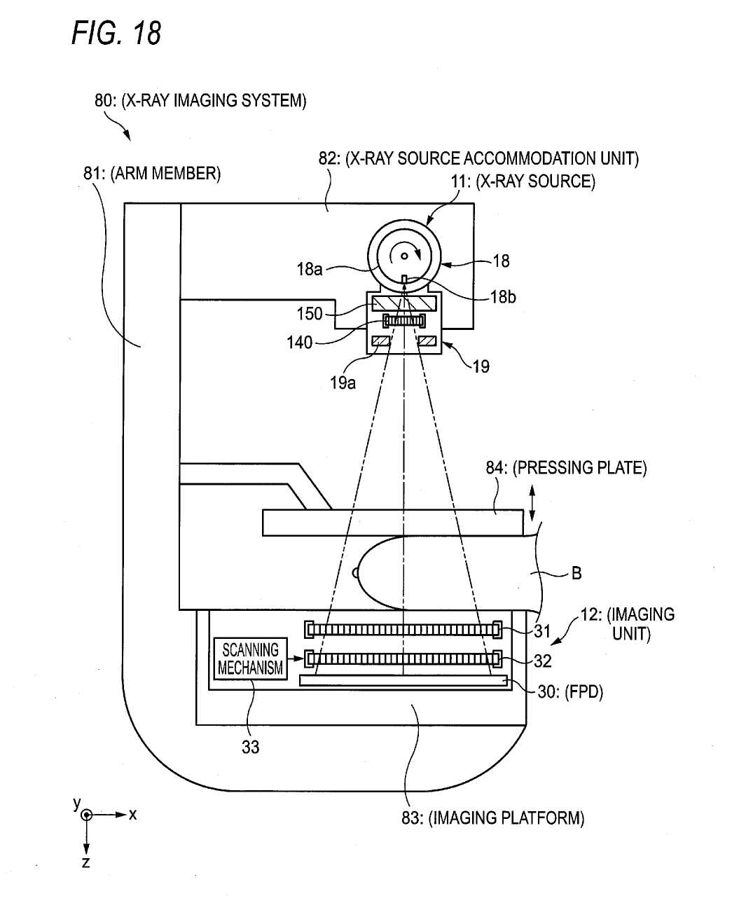

In the below, an embodiment is described in which the invention is applied to a mammography (X-ray breast imaging). A mammography apparatus 80 shown in FIG. 18 is an apparatus of capturing an X-ray image (phase contrast image) of a breast B that is the photographic subject. The mammography apparatus 80 includes an X-ray source accommodation unit 82 that is mounted to one end of an arm member 81 rotatably connected to a base platform (not shown), an imaging platform 83 that is mounted to the other end of the arm member 81 and a pressing plate 84 that is configured to vertically move relatively to the imaging platform 83.

The X-ray source 11 is accommodated in the X-ray source accommodation unit 82 and the imaging unit 12 is accommodated in the imaging platform 83. The X-ray source 11 and the imaging unit 12 are arranged to face each other. The pressing plate 84 is moved by a moving mechanism (not shown) and presses the breast B between the pressing plate and the imaging platform 83. At this pressing state, the X-ray imaging is performed.

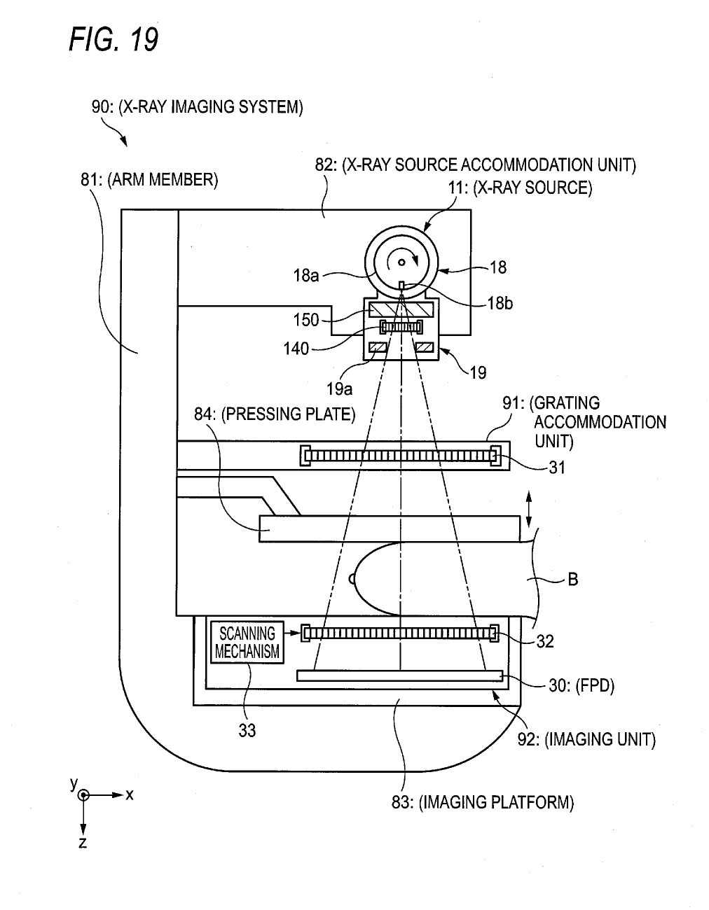

In the below, a modified embodiment of the mammography apparatus 80 is described. A mammography apparatus 90 shown in FIG. 19 is different from the mammography apparatus 80 in that the first absorption type grating 31 is provided between the X-ray source 11 and the pressing plate 84. The first absorption type grating 31 is accommodated in a grating accommodation unit 91 that is connected to the arm member 81. An imaging unit 92 does not have the first absorption type grating 31 and is configured by the FPD 30, the second absorption type grating 32 and the scanning mechanism 33.

Like this, even when the photographic subject (breast) B is positioned between the first absorption type grating 31 and the second absorption type grating 32, the projection image (G1 image) of the first absorption type grating 31, which is formed at the position of the second absorption type grating 32, is deformed by the photographic subject B. Accordingly, also in this case, it is possible to detect the moiré fringe, which is modulated due to the photographic subject B, by the FPD 30. That is, also in this embodiment, it is possible to obtain the phase contrast image of the photographic subject B by the above-described principle.

In this illustrative embodiment, since the X-ray whose radiation dose has been substantially halved by the shielding of the first absorption type grating 31 is irradiated to the photographic subject B, it is possible to decrease the radiation exposure amount of the photographic subject B about by half, compared to the above illustrative embodiment. In the meantime, the configuration in which the photographic subject is arranged between the first absorption type grating 31 and the second absorption type grating 32 is not limited to the mammography apparatus and can be applied to the other X-ray imaging systems.

Also, in the above illustrative embodiment, as described above, the phase contrast image is based on the refracted component of the X-ray in the periodic arrangement direction (x direction) of the X-ray shield units 31b, 32b of the first and second absorption type gratings 31, 32 and the refracted component in the extending direction (y direction) of the X-ray shield units 31b, 32b is not reflected thereto. That is, a part outline following the direction (when running at right angle, y direction) intersecting with the x direction is represented, as the phase contrast image based on the refracted component of the x direction, through the grating surface that is the xy plane, and a part outline following the x direction without intersecting with the x direction is not represented as the phase contrast image of the x direction. That is, there is a part that cannot be represented depending on the shape and direction of the part to be the photographic subject H. For example, when a direction of a load surface of the articular cartilage of a knee is made to match the y direction of the xy directions that are the in-plane directions, a part outline adjacent to the load surface (yz plane) following the y direction is sufficiently represented but the tissue (for example, tendon, ligament and the like) around the cartilage, which intersects with the load surface and substantially extends along the x direction, is not sufficiently represented. By moving the photographic subject H, it is possible to capture the insufficiently represented part again. However, the burdens of the photographic subject H and the operator are increased and it is difficult to secure the position reproducibility with the re-captured image.

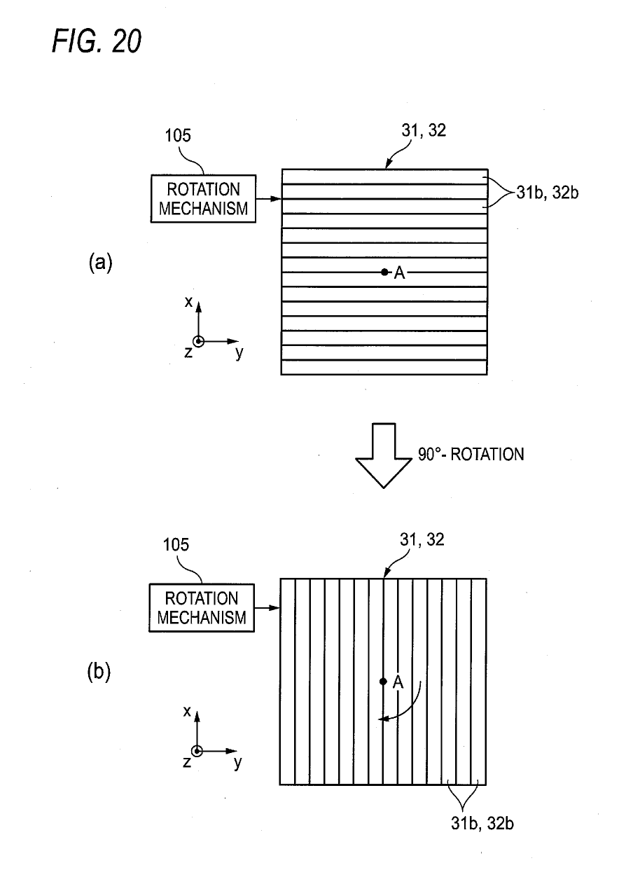

Accordingly, as another example, as shown in FIG. 20, a configuration is also very appropriate in which a rotation mechanism 105, which integrally rotates the first and second absorption type gratings 31, 32 by an arbitrary angle from a first direction (which is a direction along which the extending direction of the X-ray shield units 31b, 32b follow the y direction) shown in part (a) of FIG. 20 to a second direction (which is a direction along which the extending direction of the X-ray shield units 31b, 32b follow the x direction) shown in part (b) of FIG. 20 about an imaginary line (the optical axis A of the X-ray) orthogonal to centers of the grating surfaces of the first and second absorption type gratings 31, 32, is provided and the phase contrast images are respectively generated at each of the first and second directions. By doing so, it is possible to solve the above problem of the position reproducibility. Also, in part (a) of FIG. 20, the first direction of the first and second gratings 31, 32 is shown which is a direction along which the extending direction of the X-ray shield units 31b, 32b follows the y direction, and in part (b) of FIG. 20, the second direction of the first and second gratings 31, 32 is shown in which the state of part (a) of FIG. 20 is 90°-rotated and thus the extending direction of the X-ray shield units 31b, 32b follows the x direction. However, the rotating angles of the first and second gratings are arbitrary. In addition to the first and second directions, two or more rotation operations such as third and fourth directions may be performed and the phase contrast images may be generated at the respective directions.

Also, the rotation mechanism 105 may integrally rotate only the first and second absorption type gratings 31, 32 separately from the FPD 30 or integrally rotate the FPD 30 together with the first and second absorption type gratings 31, 32. Furthermore, the generation of the phase contrast images at the first and second directions by using the rotation mechanism 105 can be applied to any of the above illustrative embodiments.

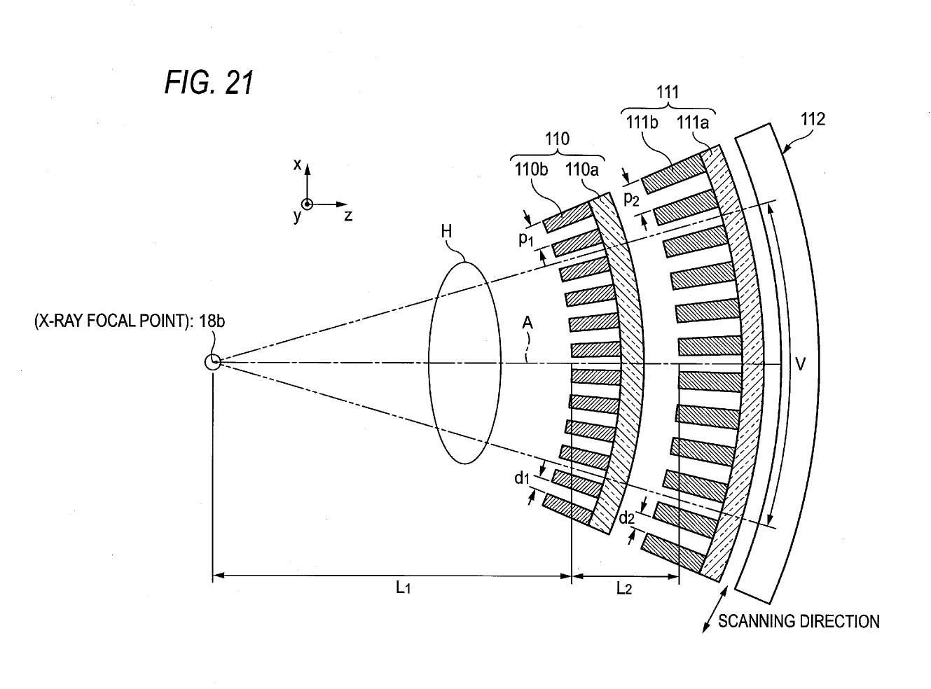

Also, the first and second absorption type gratings 31, 32 are configured so that the periodic arrangement direction of the X-ray shield units 31b, 32b is linear (i.e., the grating surfaces are planar). However, instead of this, it is very appropriate that first absorption type grating 110 and second absorption type grating 111 having grating surfaces that are concave on a curved surface are used, as shown in FIG. 21.

The first absorption type grating 110 has a plurality of X-ray shield units 110b, which are periodically arranged with a predetermined pitch p₁ on a surface of a radiolucent and curved substrate 110a. Each of the X-ray shield units 110b linearly extends in the y direction, like the above illustrative embodiments, and a grating surface of the first absorption type grating 110 has a cylindrical shape having a central axis that is a line passing to the X-ray focal point 18b and extending in the extending direction of the X-ray shield units 110b. Likewise, the second absorption type grating 111 has a plurality of X-ray shield units 111b, which are periodically arranged with a predetermined pitch p₂ on a surface of a radiolucent and curved substrate 111a. Each of the X-ray shield units 111b linearly extends in the y direction, and a grating surface of the second absorption type grating 111 has a cylindrical shape having a central axis that is a line passing to the X-ray focal point 18b and extending in the extending direction of the X-ray shield units 111b.

When a distance from the X-ray focal point 18b to the first absorption type grating 110 is L₁ and a distance from the first absorption type grating 110 to the second absorption type grating 111 is L₂, the grating pitch p₂ and the interval d₂ are determined to satisfy the equation (1). The opening width d₁ of the slit of the first absorption type grating 110 and the opening width d₂ of the slit of the second absorption type grating 111 are determined to satisfy the equation (2).

Like this, the grating surfaces of the first and second absorption type gratings 110, 111 are made to be the cylindrical surfaces, so that the X-ray irradiated from the X-ray focal point 18b is perpendicularly incident onto the grating surfaces when there is no photographic subject H. Therefore, in this illustrative embodiment, the restraint on the upper limits of the thickness h₁ of the X-ray shield unit 110b and the thickness h₂ of the X-ray shield unit 111b is relaxed, so that it is not necessary to consider the equations (7) and (8).

Also, in this illustrative embodiment, one of the first and second absorption type gratings 110, 111 is moved in a direction following the grating surface (cylindrical surface) about the X-ray focal point 18b, so that the above fringe scanning is performed. Furthermore, in this illustrative embodiment, it is preferable to use an FPD 112 having a detection surface that is a cylindrical surface. Likewise, the detection surface of the FPD 112 is a cylindrical surface having a central axis that is a line passing to the X-ray focal point 18b and extending in the y direction.

The first and second absorption type gratings 110, 111 and the FPD 112 of this illustrative embodiment can be applied to any of the above illustrative embodiments. Also, it is very appropriate that the multi-slit 140 has the same shape as the first and second absorption type gratings 110, 111.

In the below, an example of a configuration of another X-ray imaging system for illustrating an illustrative embodiment of the invention is described.

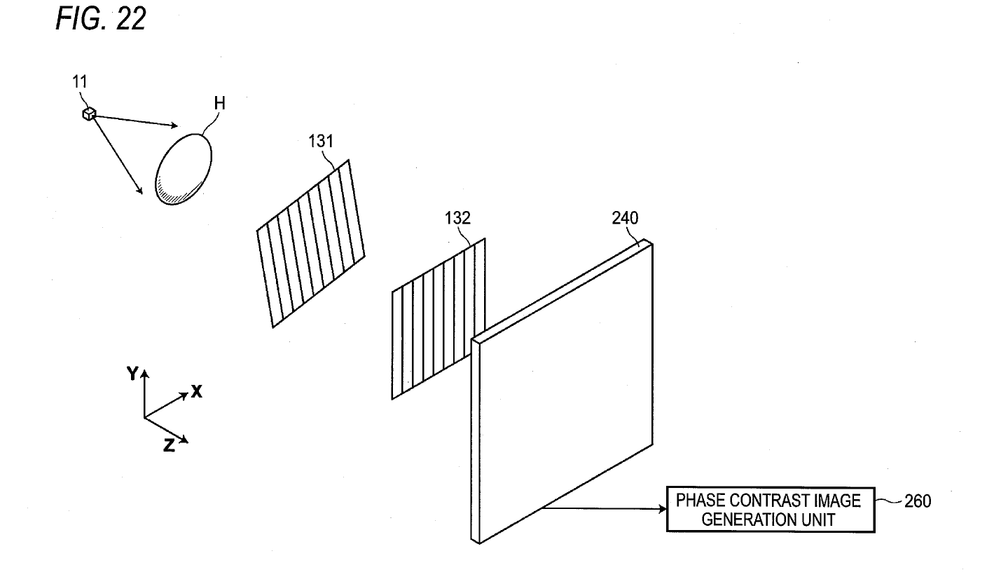

FIG. 22 shows a schematic configuration of the radiological phase image capturing apparatus of this illustrative embodiment.

An X-ray phase image capturing system of this illustrative embodiment has a first grating 131 that enables the X-ray emitted from the X-ray source 11 to pass therethrough and thus forms a first period pattern image, a second grating 132 that modulates an intensity of the first period pattern image formed by the first grating 131 and thus forms a second period pattern image, an X-ray image detector (radiological image detector) 240 that detects the second period pattern image formed by the second grating 132 and a phase contrast image generation unit 260 that acquires a fringe image, based on the second period pattern image detected by the X-ray image detector 240, and generates a phase contrast image, based on the acquired fringe image. In the meantime, the phase contrast image generation unit 260 configures a part of the processing of the control device 20 in the console 13 (refer to FIG. 2).

The X-ray source 11 irradiates the X-ray toward the photographic subject H and has a spatial coherence that can generate a Talbot interference effect when irradiating the X-ray to the first grating 131. For example, a micro focusing X-ray tube or plasma X-ray source in which a size of an emitting point of the X-ray is small may be used. Also, when an X-ray source having a relatively large emitting point (so-called, focus size) of the X-ray is used, which is used in the typical medical field, a multi-slit having a predetermined pitch (for example, the above multi-slit 140) may be provided between the X-ray source 11 and the first grating 131.

Preferably, the first grating 131 is a phase modulation type grating that provides the irradiated X-ray with phase modulation of about 90 degrees or about 180 degrees. For example, when the X-ray shield unit is made of gold, the thickness h₁ that is necessary in an X-ray energy area for typical medical diagnosis is 1 μm to several μm. Also, an amplitude modulation type grating may be used as the first grating 131.

In the meantime, the second grating 132 is preferably an amplitude modulation type grating.

Here, when the X-ray irradiated from the X-ray source 11 is a conical beam, rather than a parallel beam, a self-image of the first grating 131, which is formed after passing through the first grating 131, is enlarged in proportion to the distance from the X-ray source 11. In this illustrative embodiment, a grating pitch P₂ and an interval d₂ of the second grating 132 are determined so that the slits of the second grating substantially coincide with a period pattern of the bright parts of the self-image of the first grating 131 at the position of the second grating 132. That is, when a distance from the focal point of the X-ray source 11 to the first grating 131 is L₁ and a distance from the first grating 131 to the second grating 132 is L₂, the second grating pitch P₂ and the interval d₂ are determined so as to satisfy the equations (1) and (2).

In the meantime, when the X-ray irradiated from the X-ray source 11 is a parallel beam, the second grating pitch P₂ and the interval d₂ are determined so that P₂=P₁ and d₂=d₁.

The X-ray image detector 240 detects, as an image signal, an image that is obtained as the self-image of the first grating 131, which is formed by the X-ray incident onto the first grating 131, is intensity-modulated by the second grating 132. In this illustrative embodiment, as the X-ray image detector 240, a so-called optical reading type X-ray image detector is used which is a direct conversion type X-ray image detector and reads out an image signal as the linear reading light is scanned thereto.

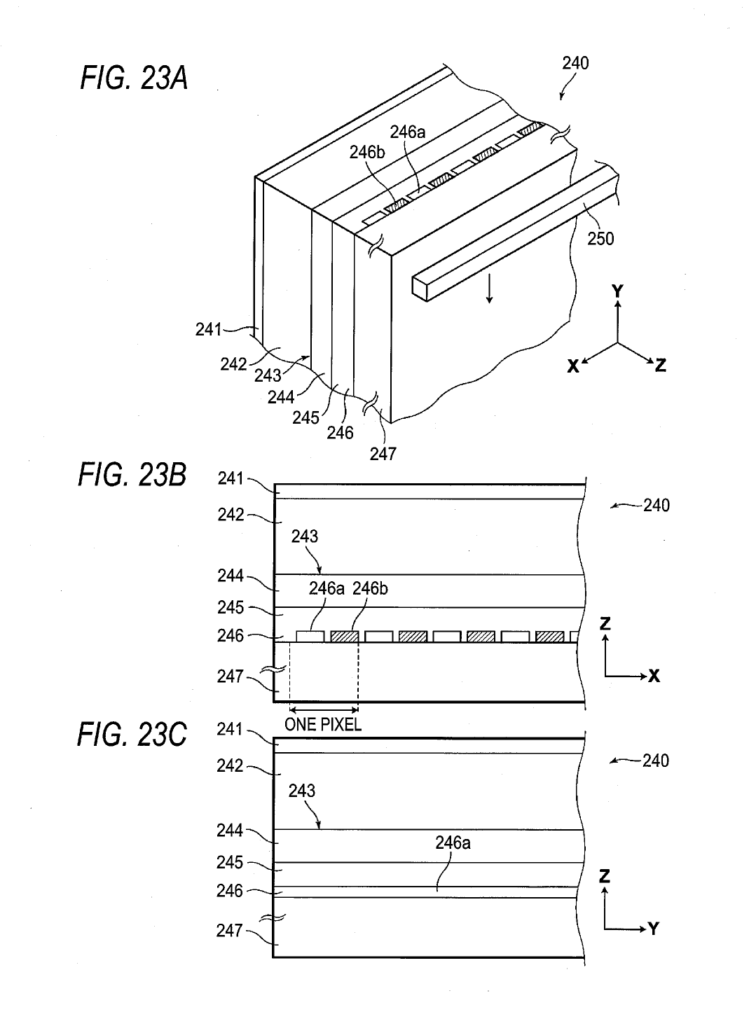

FIG. 23A is a perspective view of an X-ray image detector 240 of this illustrative embodiment, FIG. 23B is a sectional view taken along an XZ plane of the X-ray image detector shown in FIG. 23A, and FIG. 23C is a sectional view taken along a YZ plane of the X-ray image detector shown in FIG. 23A.

As shown in FIGS. 23A to 23C, the X-ray image detector 240 of this illustrative embodiment is configured by sequentially stacking a first electrode layer 241 that enables the X-ray to pass therethrough, a photoconductive layer 242 for record that generates charges as the X-ray having passed through the first electrode layer 241 is irradiated thereto, a charge transport layer 244 that functions as an insulator for a charge having one polarity of the charges generated in the photoconductive layer 242 for record and functions as a conductor for a charge having the other polarity, a photoconductive layer 245 for reading that generates charges as the reading light is illuminated thereto and a second electrode layer 246. An electric accumulation part 243 that accumulates the charges generated in the photoconductive layer 242 for record is formed near an interface between the photoconductive layer 242 for record and the charge transport layer 244. In the meantime, the respective layers are sequentially formed from the second electrode layer 246 on a glass substrate 247.

As the first electrode layer 241, any material may be used inasmuch as the X-ray can pass therethrough. For example, a Nesa film (SnO₂), ITO (Indium Tin Oxide), IZO (Indium Zinc Oxide), an IDIXO (Idemitsu Indium X-metal Oxide; Idemitsu Kosan Co., Ltd.) that is an amorphous type light transmissive oxide film, and the like may be used with a thickness of 50 to 200 nm Also, Al or Au having a thickness of 100 nm may be used.

As the photoconductive layer 242 for record, any material may be used inasmuch as it generates the charges as the X-ray is irradiated thereto. For example, a material having a-Se as a main component may be used which has relatively high quantum efficiency regarding the X-ray and high dark resistance. It is appropriate that a thickness thereof is 10 μm to 1500 μm. Also, for the mammography application, the thickness is preferably 150 μm to 250 μm, and for the general imaging application, the thickness is preferably 500 μm to 1200 μm.

As the charge transport layer 244, the larger a difference between the mobility of the charges that are charged in the first electrode layer 241 in recording an X-ray image and the mobility of the charges having a reverse polarity thereto, the better (for example, the difference is 10² or larger, preferably 10³ or larger). For example, an organic-based compound such as poly N-vinylcarbazole (PVK), N,N′-diphenyl-N,N′-bis(3-methylphenyl)-[1,1′-biphenyl]-4,4′-diamine (TPD), discotic liquid crystal and the like, a disperse material of TPD polymer (polycarbonate, polystyrene, PVK) or a semiconductor material such as a-Se having Cl of 10 to 200 ppm doped therein and As₂Se₃ is appropriate. A thickness of about 0.2 to 2 μm is appropriate.

As the photoconductive layer 245 for reading, any material may be used inasmuch as it exhibits the conductivity as the reading light is irradiated thereto. For example, a photoconductive material having, as a main component, at least one of a-Se, Se—Te, Se—As—Te, metal-free phthalocyanine, metal phthalocyanine, MgPc (Magnesium phthalocyanine), VoPc (phase II of Vanadyl phthalocyanine) and CuPc (Cupper phthalocyanine) is appropriate. A thickness of about 5 to 20 μm is appropriate.

The second electrode layer 246 has a plurality of transparent linear electrodes 246a that enables the reading light to pass therethrough and a plurality of light-shielding linear electrodes 246b that shields the reading light. The transparent linear electrode 246a and the light-shielding linear electrode 246b continuously extend linearly from one end portion of an image forming area of the X-ray image detector 240 to the other end portion. As shown in FIGS. 23A and 23B, the transparent linear electrodes 246a and the light-shielding linear electrodes 246b are alternately arranged in parallel with each other at a predetermined interval.

The transparent linear electrode 246a is made of a material that enables the reading light to pass therethrough and has conductivity. For example, like the first electrode layer 241, ITO, IZO or IDIXO may be used. A thickness thereof is about 100 to 200 nm.

The light-shielding linear electrode 246b is made of a material that shields the reading light and has conductivity. For example, a combination of the transparent conductive material and a color filter may be used. A thickness of the transparent conductive material is about 100 to 200 nm.

In the X-ray image detector 240 of this illustrative embodiment, as specifically described later, one set of the transparent linear electrode 246a and the light-shielding linear electrode 246b, which are adjacent to each other, is used to read out an image signal. That is, as shown in FIG. 23B, an image signal of one pixel is read out by one set of the transparent linear electrode 246a and the light-shielding linear electrode 246b. In this illustrative embodiment, the transparent linear electrode 246a and the light-shielding linear electrode 246b are arranged so that one pixel becomes about 50 μm.

The X-ray phase image capturing apparatus of this illustrative embodiment has, as shown in FIG. 23A, a linear reading light source 250 that extends in a direction (X direction) orthogonal to the extending direction of the transparent linear electrode 246a and the light-shielding linear electrode 246b. In this illustrative embodiment, the linear reading light source 250 includes a light source such as LED (Light Emitting Diode), LD (Laser Diode) and the like and a predetermined optical system and is configured to illuminate the linear reading light having a width of about 10 μm toward the X-ray image detector 240. The linear reading light source 250 is moved in the extending direction (Y direction) of the transparent linear electrode 246a and the light-shielding linear electrode 246b by a predetermined moving mechanism (not shown). By the moving, the X-ray image detector 240 is scanned by the linear reading light emitted from the linear reading light source 250, so that an image signal is read out. The readout operation of the image signal will be specifically described in the below.

In order to enable the configuration having the X-ray source 11, the first grating 131, the second grating 132 and the X-ray image detector 240 to function as a Talbot interferometer, some conditions should be further satisfied. The conditions are described in the below.

First, grid surfaces of the first grating 131 and the second grating 132 should be parallel with the X-Y plane shown in FIG. 22.

Also, a distance Z₂ (Talbot interference distance Z) between the first grating 131 and the second grating 132 should substantially satisfy a following equation (24) when the first grating 131 is a phase modulation type grating that provides a phase modulation of 90 degrees.

$$\begin{matrix}[ equation 24 ] & \\ {Z}_{2} = ( m + \frac{1}{2} ) \frac{{p}_{1} {p}_{2}}{λ} & ( 24 )\end{matrix}$$

Here, λ is a wavelength of the X-ray (typically, a peak wavelength), m is a zero (0) or positive integer, P₁ is a grating pitch of the first grating 131 and P₂ is a grating pitch of the second grating 132.

Also, when the first grating 131 is a phase modulation type grating that provides a phase modulation of 180 degrees, the Talbot interference distance Z should substantially satisfy a following equation (25). m is a zero (0) or positive integer, P₁ is a grating pitch of the first grating 131 and P₂ is a grating pitch of the second grating 132. Also, when the first grating 131 is an amplitude modulation type grating, the above equation (3) should be substantially satisfied.

$$\begin{matrix}[ equation 25 ] & \\ {Z}_{2} = ( m + \frac{1}{2} ) \frac{{p}_{1} {p}_{2}}{2 λ} & ( 25 )\end{matrix}$$

Also, it is necessary that the thickness h₁, h₂ of the first and second gratings 131, 132 should be set to satisfy the equations (7) and (8) described with respect to the first and second gratings 31, 32.

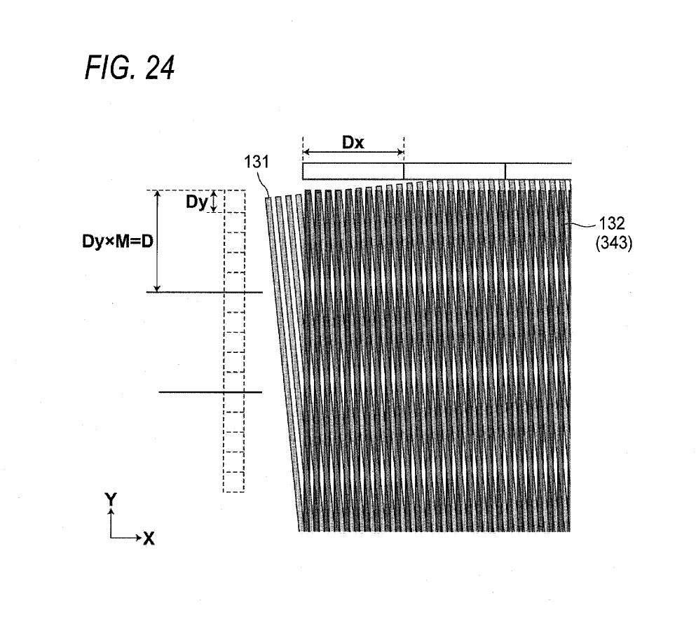

In the X-ray phase image capturing apparatus of this illustrative embodiment, as shown in FIG. 24, the first grating 131 and the second grating 132 are arranged so that the extending direction of the first grating 131 and the extending direction of the second grating 132 are relatively inclined. Regarding the first grating 131 and the second grating 132 arranged as described above, a main pixel size Dx of a main scanning direction (X direction in FIGS. 23A and 23B) and a sub-pixel size Dy of a sub-scanning direction of each pixel of the image signals detected by the X-ray image detector 240 have a relation as shown in FIG. 24.

The main pixel size Dx is determined by an arrangement pitch of the transparent linear electrodes 246a and the light-shielding linear electrodes 246b of the X-ray image detector 240, as described above, and is set to be 50 μm in this illustrative embodiment. Also, the sub-pixel size Dy is determined by the width of the linear reading light that is illuminated toward the X-ray image detector 240 by the linear reading light source 250, and is set to be 10 μm in this illustrative embodiment.

In this illustrative embodiment, a plurality of fringe images is obtained and a phase contrast image is generated based on the fringe images. When the number of the obtained fringe images is M, the first grating 131 is inclined relative to the second grating 132 so that the M sub-pixel sizes Dy become one image resolution D of the phase contrast image in the sub-scanning direction.

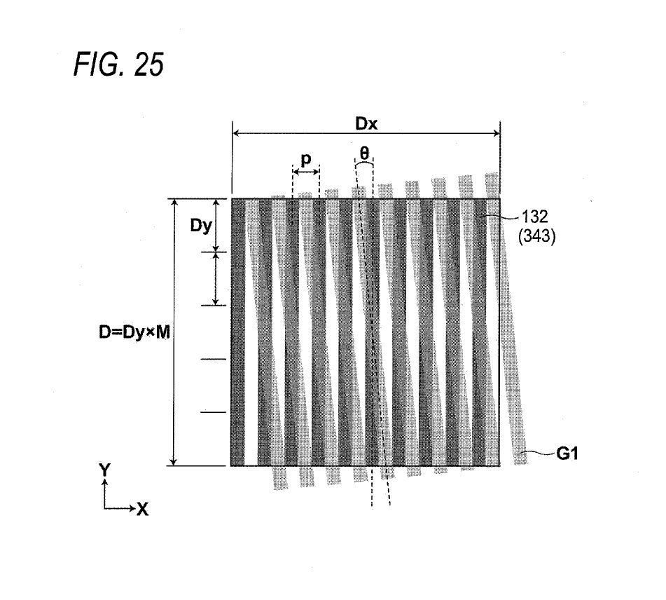

Specifically, as shown in FIG. 25, when the pitch of the second grating 132 and the pitch of a period pattern image (hereinafter, referred to as a self-image G1 of the first grating 131) formed at the position of the second grating 132 by the first grating 131 are indicated with p, a relative rotating angle of the self-image of the first grating 131 relative to the second grating 132 in the X-Y plane is indicated with 0 and an image resolution of the phase contrast image in the sub-scanning direction is indicated with D (=Dy×M), the rotating angle θ is set to satisfy a following equation (26), so that the phases of the self-image G1 of the first grating 131 and the second grating 132 are offset by an n period with respect to a length of the image resolution D in the sub-scanning direction. Meanwhile, in FIG. 25, a case where M=5 and n=1 is shown.

$$\begin{matrix}[ equation 26 ] & \\ θ = arctan \{ n \times \frac{p}{D} \} & ( 26 )\end{matrix}$$

here, n is an integer except for zero (0) and a multiple of M.

Accordingly, by each pixel of Dx×Dy that is obtained by M-dividing the image resolution D of the phase contrast image in the sub-scanning direction, it is possible to detect image signals that are obtained by M-dividing the intensity modulation of the n period of the self image of the first grating 131. In the example shown in FIG. 25, n=1. Thus, regarding the length of the image resolution D in the sub-scanning direction, the phases of the self-image G1 of the first grating 131 and the second grating 132 are offset by one period. More easily speaking, a range within which the self-image G1 of the first grating 131 passes through the second grating 132 of one period is changed over the length of the image resolution D in the sub-scanning direction.

Also, M=5. Thus, by each pixel of Dx×Dy, it is possible to detect the image signals that are obtained by five-dividing the intensity modulation of one period of the self-image of the first grating 131. That is, it is possible to respectively detect the image signals of the five different fringe images by each pixel of Dx×Dy. In the meantime, a method of acquiring the image signals of the five fringe images will be specifically described in the below.

Meanwhile, in this illustrative embodiment, as described above, Dx=50 μm, Dy=10 μm and M=5. Thus, the image resolution Dx of the phase contrast image in the main scanning direction and the image resolution D (=Dy×M) thereof in the sub-scanning direction are the same. However, it is not necessarily to make the image resolution Dx in the main scanning direction and the image resolution D in the sub-scanning direction same and an arbitrary main to sub ratio is possible.

Also, in this illustrative embodiment, M=5. However, M may be 3 or larger and may be any integer except for 5. Also, in this illustrative embodiment, n=1. However, n may be any integer except for 1 inasmuch as it is an integer except for zero (0). That is, when n is a negative integer, the rotation is made in the opposite direction to that of the above-described example, and n may be an integer except for ±1, so that the intensity modulation of n period may be made. However, when n is a multiple of M, the phases of the self image of the first grating 131 and the second grating 132 are the same between the M pixels Dy of one set in the sub-scanning direction. As a result, since the M different fringe images are not made, a case where n is a multiple of M is excluded.

Also, regarding the rotating angle θ of the self image of the first grating 131 relative to the second grating 132, the first grating 131 may be rotated after the relative rotating angle of the X-ray image detector 240 and the second grating 132 is fixed.

For example, when p=5 μm, D=50 μm and n=1 in the equation (26), a theoretical rotating angle θ is about 5.7 degrees. Then, an actual rotating angle θ′ of the self-image of the first grating 131 relative to the second grating 132 can be detected by a pitch of the moiré by the self-image of the first grating 131 and the second grating 132, for example.

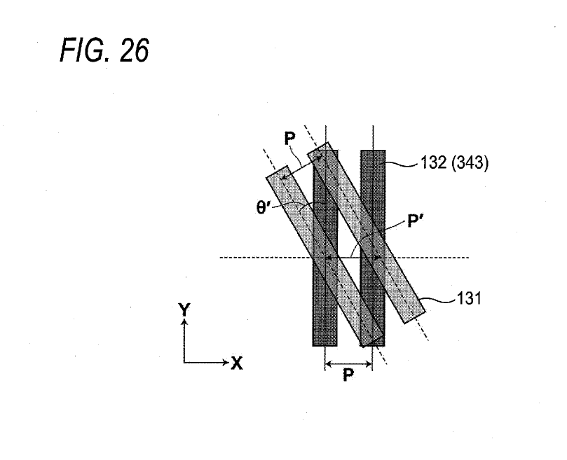

Specifically, as shown in FIG. 26, when the actual rotating angle is indicated with θh′ and a pitch of the apparent self-image in the x direction generated by the rotation is indicated with P′, the pitch Pm of the observed moiré is 1/Pm=|1/P′−1/P|. Thus, by substituting P′=P/cos θ′ in the above equation, the actual rotating angle θ′ can be calculated. In the meantime, the pitch Pm of the moiré may be calculated based on the image signals detected by the X-ray image detector 240.

Then, by comparing the theoretical rotating angle θ with the actual rotating angle θ′, the rotating angle of the first grating 131 may be manually or automatically adjusted as a difference of the rotating angles.

The phase contrast image generation unit 260 generates an X-ray phase contrast image, based on the image signals of the different fringe images of M types detected by the X-ray image detector 240.

In the below, the operations of the X-ray phase image capturing apparatus of this illustrative embodiment are described.

First, as shown in FIG. 22, the photographic subject H is arranged between the X-ray source 11 and the first grating 131 and the X-ray is then emitted from the X-ray source 11. The X-ray penetrates the photographic subject H and is then irradiated to the first grating 131. The X-ray irradiated to the first grating 131 is diffracted in the first grating 131, so that a Talbot interference image is formed at a predetermined distance from the first grating 131 in the optical axis direction of the X-ray.

The above is referred to as the Talbot effect. When the light wave passes through the first grating 131, a self-image of the first grating 131 is formed at a predetermined distance from the first grating 131. For example, when the first grating 131 is a phase modulation type grating that provides a phase modulation of 90 degrees, the self-image of the first grating 131 is formed at a distance that is determined by the equation (24) (by the equation (25) when the first grating is a phase modulation type grating of 180 degrees or by the equation (3) when the first grating is an intensity modulation type grating). In the meantime, since a wave surface of the X-ray incident onto the first grating 131 is distorted by the photographic subject H, the self-image of the first grating 131 is correspondingly deformed.

Subsequently, the X-ray passes through the second grating 132. As a result, the deformed self-image of the first grating 131 is intensity-modulated by the superimposition with the second grating 132, so that it is detected, as an image signal reflecting the distortion of the wave surface, by the X-ray image detector 240.

Here, the image detection and readout operations of the X-ray image detector 240 are described.

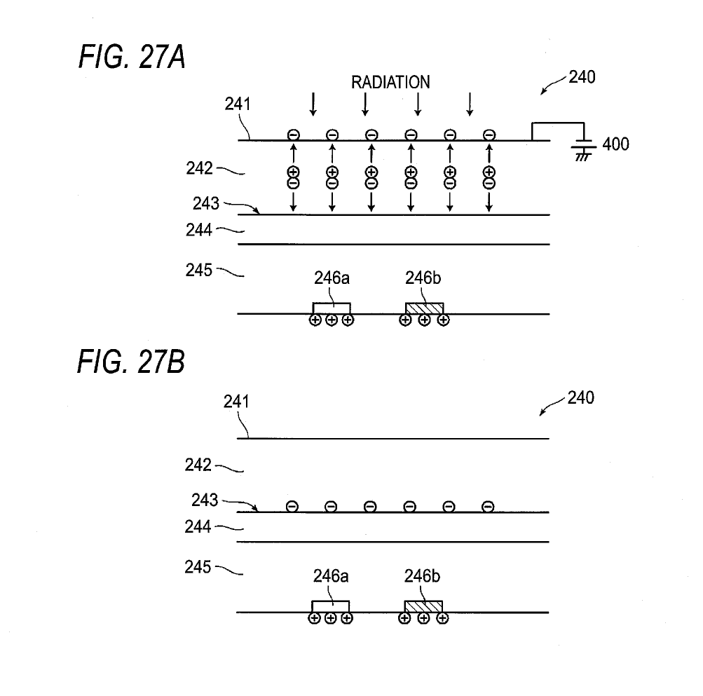

First, as shown in FIG. 27A, at a state in which the negative voltage is applied to the first electrode layer 241 of the X-ray image detector 240 by a high voltage power supply 400, the X-ray that has been intensity-modulated by the superimposition of the self-image of the first grating 131 and the second grating 132 is irradiated from the first electrode layer 241 of the X-ray image detector 240.

The X-ray irradiated to the X-ray image detector 240 penetrates the first electrode layer 241 and is then irradiated to the photoconductive layer 242 for record. By the irradiation of the X-ray, charge pairs are generated in the photoconductive layer 242 for record, and the positive charges thereof are combined with the negative charges charged in the first electrode layer 241 and thus annihilated and the negative charges thereof are accumulated, as latent image charges, in the electric accumulation part 243 that is formed at the interface between the photoconductive layer 242 for record and the charge transport layer 244 (refer to FIG. 27B).

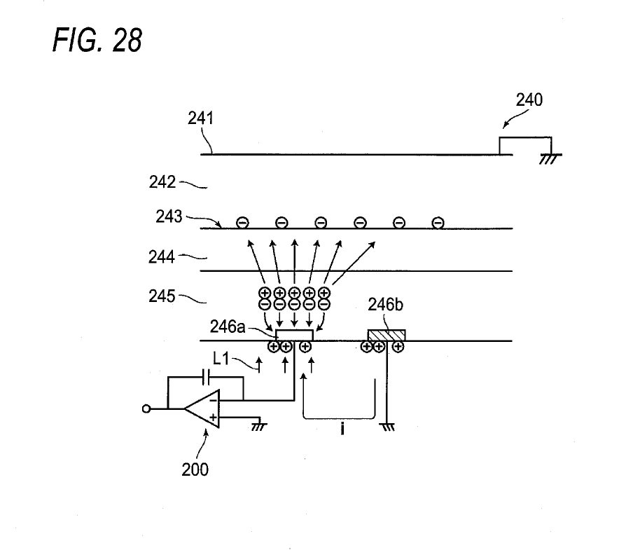

Then, as shown in FIG. 28, at a state in which the first electrode layer 241 is grounded, the linear reading light L1 emitted from the linear reading light source 250 is illuminated from the second electrode layer 246. The reading light L1 penetrates the transparent linear electrode 246a and is then illuminated to the photoconductive layer 245 for reading. The positive charges generated in the photoconductive layer 245 for reading by the illumination of the reading light L1 pass through the charge transport layer 244 and are combined with the latent image charges in the electric accumulation part 243 and the negative charges are combined with the positive charges that are charged in the light-shielding linear electrode 246b through a charge amplifier 200 connected to the transparent linear electrode 246a.

As the negative charges generated in the photoconductive layer 245 for reading and the positive charges charged in the light-shielding linear electrode 246b are combined, the current flows in the charge amplifier 200 and is integrated and thus detected as an image signal.

The linear reading light source 250 is moved in the sub-scanning direction, so that the X-ray image detector 240 is scanned by the linear reading light L1. Thereby, the image signals are sequentially detected for each of the scan lines, which are illuminated by the linear reading light L1, in accordance with the above operations, and the detected image signals for each of the reading lines are sequentially input and stored in the phase contrast image generation unit 260.

The whole surface of the X-ray image detector 240 is scanned by the reading light L1, so that the image signals of a whole one frame are stored in the phase contrast image generation unit 260. Then, the phase contrast image generation unit 260 acquires the image signals of the five different fringe images, based on the stored image signals.

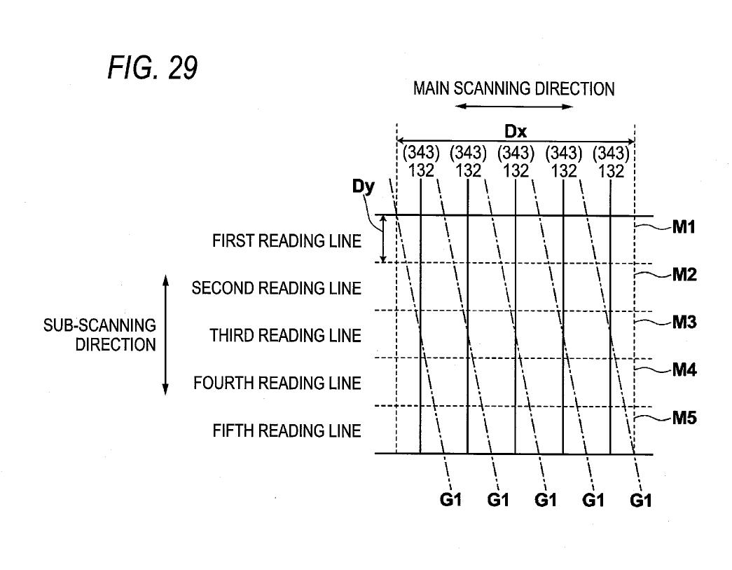

Specifically, in this illustrative embodiment, as shown in FIG. 25, the first grating 131 is inclined relatively to the second grating 132 so as to detect the image signals obtained by five-dividing the image resolution D of the phase contrast image in the sub-scanning direction and five-dividing the intensity-modulation of one period of the self-image of the first grating 131. Accordingly, as shown in FIG. 29, the image signal read out from a first reading line is acquired as a first fringe image signal M1, the image signal read out from a second reading line is acquired as a second fringe image signal M2, the image signal read out from a third reading line is acquired as a third fringe image signal M3, the image signal read out from a fourth reading line is acquired as a fourth fringe image signal M4 and the image signal read out from a fifth reading line is acquired as a fifth fringe image signal M5. In the meantime, the first to fifth reading lines shown in FIG. 29 correspond to the sub-pixel sizes Dy shown in FIG. 25, respectively.

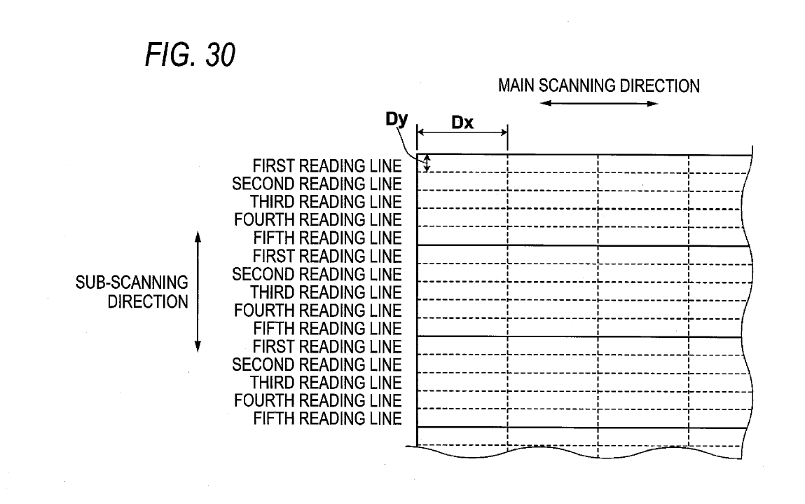

Also, in FIG. 29, the reading range of only Dx×(Dy×5) is shown. However, also for the other reading ranges, the first to fifth fringe image signals are acquired in the same manner. That is, as shown in FIG. 30, an image signal is acquired for each pixel line group consisting of a pixel line (reading line) every four pixel-interval in the sub-scanning direction, so that one fringe image signal of one frame is acquired. More specifically, an image signal of a pixel line group of a first reading line is acquired, so that a first fringe image signal of one frame is acquired, an image signal of a pixel line group of a second reading line is acquired, so that a second fringe image signal of one frame is acquired, an image signal of a pixel line group of a third reading line is acquired, so that a third fringe image signal of one frame is acquired, an image signal of a pixel line group of a fourth reading line is acquired, so that a fourth fringe image signal of one frame is acquired, and an image signal of a pixel line group of a fifth reading line is acquired, so that a fifth fringe image signal of one frame is acquired.

The first to fifth different fringe image signals are acquired as described above, and a phase contrast image is generated in the phase contrast image generation unit 260, based on the first to fifth fringe image signals.

Since the method of generating the phase contrast image in this illustrative embodiment is the same as that described with reference to the equations (17) to (23), the description thereof is omitted.

In the meantime, regarding the configuration in which the first grating 131 and the second grating 132 are inclined, it may be possible that both the first grating 131 and the second grating 132 are configured with the absorption type (amplitude modulation type) gratings and the radiation having passed through the slits are geometrically projected without reference to the Talbot interference effect. In this case, the interval d₁ of the first grating 131 and the interval d₂ of the second grating 132 are set to be sufficiently larger than the peak wavelength of the X-ray irradiated from the X-ray source 11 so that most of the irradiated X-ray is enabled to linearly pass through the slits without being diffracted therein. For example, when tungsten is used as a target of the X-ray source and the tube voltage is 50 kV, the peak wavelength of the X-ray is about 0.4 Å. In this case, when the interval d₁ of the first grating 131 and the interval d₂ of the second grating 132 are set to be about 1 μm to 10 μm, most of the radiation is geometrically projected without being diffracted in the slits. The relation between the grating pitch P₁ of the first grating 131 and the grating pitch P₂ of the second grating 132 and the relation between the interval d₁ of the first grating 131 and the interval d₂ of the second grating 132 are the same as the above case where the first grating 131 is a phase modulation type grating. Also, the inclination of the first grating 131 to the second grating 132 is the same as the above illustrative embodiment and the generation of the phase contrast image is also the same as the above illustrative embodiment.

Meanwhile, in the above illustrative embodiment, regarding the X-ray image detector 240, a so-called optical reading type X-ray image detector in which an image signal is read out by the scanning of the reading light emitted from the linear reading light source 250 is used. However, the invention is not limited thereto. For example, as disclosed in JP 2002-26300A, an X-ray image detector using TFT switches in which a plurality of TFT switches is two-dimensionally arranged and image signals are read out as the TFT switches become on and off, an X-ray image detector using CMOSs, and the like may be used.

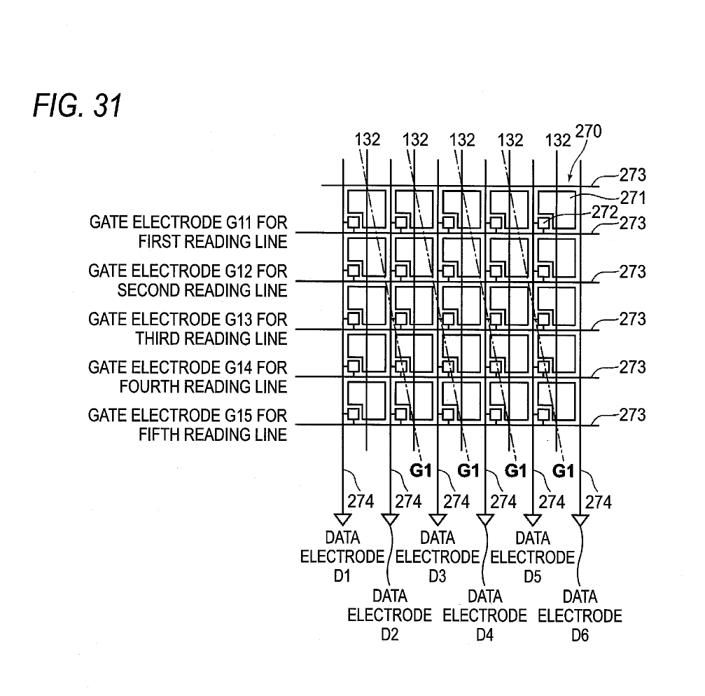

Specifically, in the X-ray image detector using TFT switches, as shown in FIG. 31, a plurality of pixel circuits 270, each of which has a pixel electrode 271 that collects charges photoelectrically converted in a semiconductor film by the irradiation of the X-ray and a TFT switch 272 that reads out, as an image signal, the charges collected by the pixel electrode 271, is two-dimensionally arranged. Also, the X-ray image detector using TFT switches has a plurality of gate electrodes 273 that is provided for each of pixel circuit lines and outputs a gate scanning signal for turning on and off the TFT switches 272 and a plurality of data electrodes 274 that is provided for each of pixel circuit column and outputs the charge signals read out from the respective pixel circuits 270. In the meantime, the detailed layer configuration of each pixel circuit 270 is the same as that disclosed in JP 2002-26300A.

Meanwhile, when the second grating 132 and the pixel circuit column (data electrode) are provided in parallel with each other, for example, one pixel circuit column corresponds to the main pixel size Dx described in the above illustrative embodiment and one pixel circuit line corresponds to the sub-pixel size Dy described in the above illustrative embodiment. The main pixel size Dx and the sub-pixel size Dy may be set to be about 50 μm.

Like the above illustrative embodiment, when M fringe images are used so as to generate a phase contrast image, the first grating 131 is inclined relatively to the second grating 132 so that the pixel circuit lines of M lines become one image resolution D of the phase contrast image in the sub-scanning direction. The specific rotating angle of the first grating 131 is calculated by the equation (26), like the above illustrative embodiment.

In the equation (26), when the rotating angle θ of the first grating 131 is set with M=5 and n=1, it is possible to detect an image signal, which is obtained by five-dividing the intensity modulation of one period of the self-image of the first grating 131, by one pixel circuit 270 shown in FIG. 31. That is, it is possible to respectively detect the image signals of the five different fringe images by the pixel circuit lines of five lines connected to the five gate electrodes 273 shown in FIG. 31. Meanwhile, in FIG. 31, one second grating 132 and self-image G1 are shown to correspond to one pixel circuit column. However, actually, a plurality of second gratings 132 and self-images may be provided for one pixel circuit column, which is not shown in FIG. 31.

Accordingly, an image signal, which is read out from the pixel circuit line connected to the gate electrode G11 for first reading line, is acquired as a first fringe image signal M1, an image signal, which is read out from the pixel circuit line connected to the gate electrode G12 for second reading line, is acquired as a second fringe image signal M2, an image signal, which is read out from the pixel circuit line connected to the gate electrode G13 for third reading line, is acquired as a third fringe image signal M3, an image signal, which is read out from the pixel circuit line connected to the gate electrode G14 for fourth reading line, is acquired as a fourth fringe image signal M4, and an image signal, which is read out from the pixel circuit line connected to the gate electrode G15 for fifth reading line, is acquired as a fifth fringe image signal M5.

The method of generating a phase contrast image based on the first to fifth fringe image signals is the same as the above illustrative embodiment. Meanwhile, as described above, when the sizes of one pixel circuit 270 in the main scanning direction and sub-scanning direction are 50 μm, the image resolution of the phase contrast image in the main scanning direction is 50 μm and the image resolution thereof in the sub-scanning direction is 50 μm×5=250 μm.

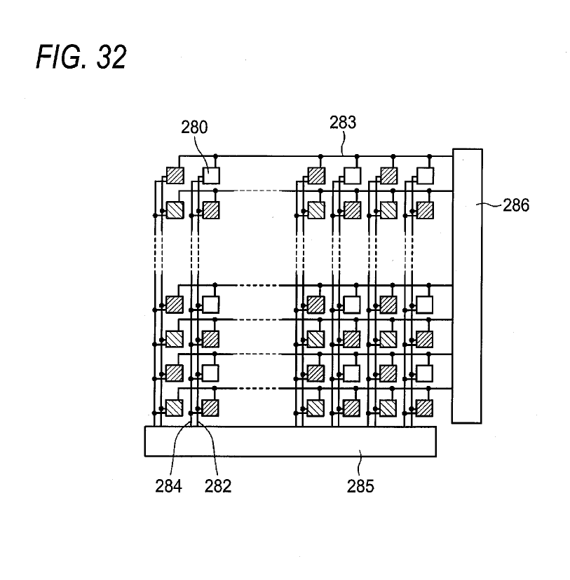

Also, in the X-ray image detector using CMOSs, a plurality of pixel circuits 280, each of which generates visible light as the X-ray is irradiated thereto and photoelectrically converts the visible light and thus detects a charge signal, is two-dimensionally arranged, as shown in FIG. 32, for example. The X-ray image detector using CMOSs has a plurality of gate electrodes 282 and reset electrodes 284 that are provided for each of pixel circuit lines and output a driving signal for driving a signal readout circuit included in the pixel circuit 280 and a plurality of data electrodes 283 that is provided for each of pixel circuit columns and outputs a charge signal read out from the signal readout circuit of each pixel circuit 280. In the meantime, a line selection scanning unit 285 that outputs a driving signal to the signal readout circuit is connected to the gate electrodes 282 and the reset electrodes 284 and a signal processing unit 286 that performs a predetermined process for the charge signals output from the respective pixel circuits is connected to the data electrodes 283.

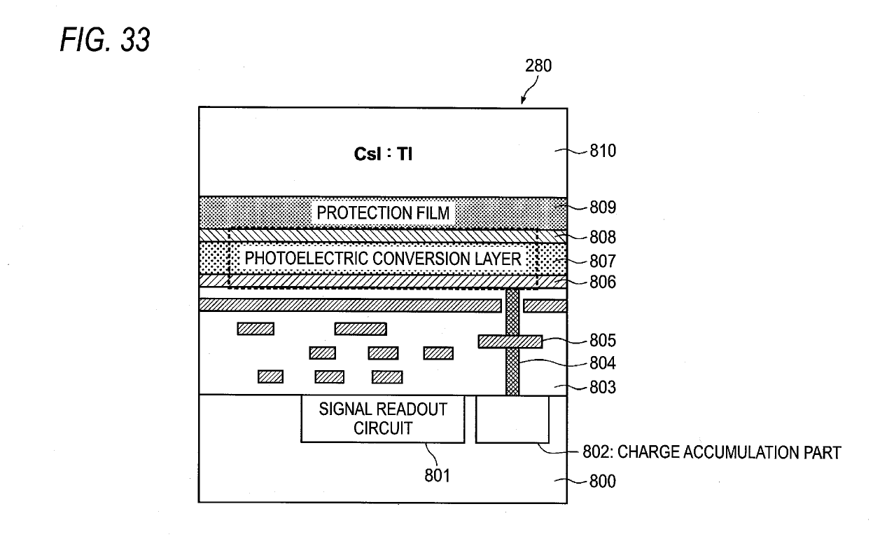

As shown in FIG. 33, each pixel circuit 280 has a lower electrode 806 that is formed above a substrate 800 via an insulation film 803, a photoelectric conversion film 807 that is formed on the lower electrode 806, an upper electrode 808 that is formed on the photoelectric conversion film 807, a protection film 809 that is formed on the upper electrode 808 and an X-ray conversion film 810 that is formed on the protection film 908.

The X-ray conversion film 810 is made of CsI:Tl that generates light having a wavelength of 550 nm as the X-ray is irradiated thereto, for example. A thickness thereof is preferably about 500 μm.

Since the upper electrode 808 should enable the light having a wavelength of 550 nm to be incident onto the photoelectric conversion film 807, it is made of a transparent conductive material regarding the incident light. Also, the lower electrode 806 is a thin film that is divided for each pixel circuit 280 and is formed of a transparent or opaque conductive material.

The photoelectric conversion film 807 is made of a photoelectric conversion material that absorbs light having a wavelength of 550 nm, for example and generates charges corresponding to the light. As the photoelectric conversion film, an organic semiconductor, an organic material including organic dye, an inorganic semiconductor crystal of a high absorption coefficient having a direct transition type band gap, and the like may be used in a single body or combination thereof.

By applying a predetermined bias voltage between the upper electrode 808 and the lower electrode 806, the one type charges of the charges generated in the photoelectric conversion film 807 are moved to the upper electrode 808 and the other type charges are moved to the lower electrode 806.

In the substrate 800 below the lower electrode 806, a charge accumulation part 802 that accumulates the charges moved to the lower electrode 806 is formed in correspondence to the lower electrode 806 and a signal readout circuit 801 that converts and outputs the charges accumulated in the charge accumulation part 802 into a voltage signal is formed.

The charge accumulation part 802 is electrically connected to the lower electrode 806 by a plug 804 that is formed to penetrate the insulation film 803 and is made of a conductive material. The signal readout circuit 801 is configured by a well-known CMOS circuit.

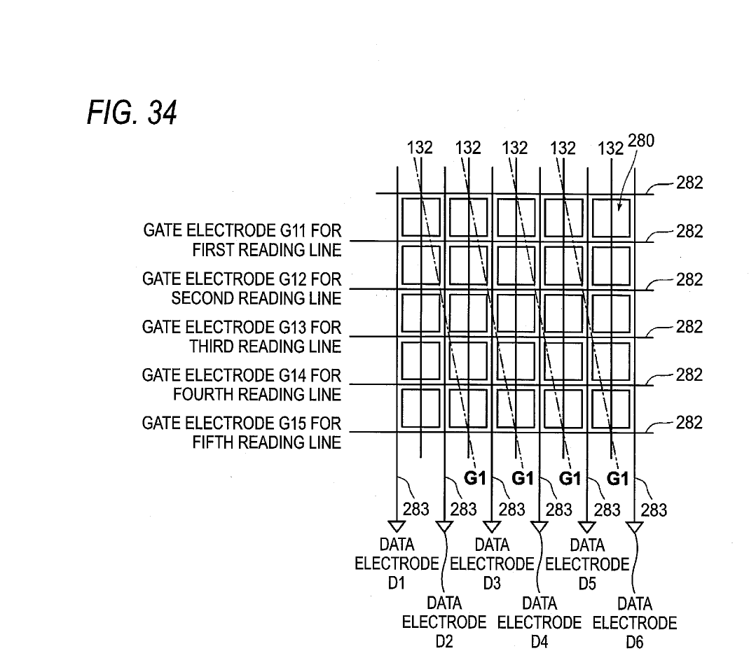

When the X-ray image detector using CMOSs as described above is mounted so that the second gratings 132 and the pixel circuit columns (data electrodes) are provided in parallel with each other, as shown in FIG. 34, one pixel circuit column corresponds to the main pixel size Dx described in the above illustrative embodiment and one pixel circuit line corresponds to the sub-pixel size Dy described in the above illustrative embodiment. In the X-ray image detector using CMOSs, the main pixel size Dx and the sub-pixel size Dy may be set to be about 10 μm, for example.

Like the above illustrative embodiment, when M fringe images are used so as to generate a phase contrast image, the first grating 131 is inclined relatively to the second grating 132 so that the pixel circuit lines of M lines become one image resolution D of the phase contrast image in the sub-scanning direction. The specific rotating angle of the first grating 131 is calculated by the equation (26), like the above illustrative embodiment.

In the equation (26), when the rotating angle θ of the first grating 131 is set with M=5 and n=1, it is possible to detect an image signal, which is obtained by five-dividing the intensity modulation of one period of the self-image of the first grating 131, by one pixel circuit 280 shown in FIG. 34. That is, it is possible to respectively detect the image signals of the five different fringe images by the pixel circuit lines of five lines connected to the five gate electrodes 282 shown in FIG. 34. Meanwhile, in FIG. 34, one second grating 132 and self-image G1 are shown to correspond to one pixel circuit column. However, actually, a plurality of second gratings 132 and self-images G1 may be provided for one pixel circuit column, which is not shown in FIG. 34.

Accordingly, like the X-ray image detector using TFT switches, an image signal, which is read out from the pixel circuit line connected to the gate electrode G11 for first reading line, is acquired as a first fringe image signal M1, an image signal, which is read out from the pixel circuit line connected to the gate electrode G12 for second reading line, is acquired as a second fringe image signal M2, an image signal, which is read out from the pixel circuit line connected to the gate electrode G13 for third reading line, is acquired as a third fringe image signal M3, an image signal, which is read out from the pixel circuit line connected to the gate electrode G14 for fourth reading line, is acquired as a fourth fringe image signal M4, and an image signal, which is read out from the pixel circuit line connected to the gate electrode G15 for fifth reading line, is acquired as a fifth fringe image signal M5.

The method of generating a phase contrast image based on the first to fifth fringe image signals is the same as the above illustrative embodiment. Meanwhile, as described above, when the sizes of one pixel circuit 280 in the main scanning direction and sub-scanning direction are 10 μm, the image resolution of the phase contrast image in the main scanning direction is 10 μm and the image resolution thereof in the sub-scanning direction is 10 μm×5=50 μm.

In the meantime, as described above, the X-ray image detector using TFT switches or X-ray image detector using CMOSs can be used. However, such X-ray image detectors have the square-shaped pixels. Thus, when the invention is applied thereto, the resolution in the sub-scanning direction is deteriorated, compared to the resolution in the main scanning direction. To the contrary, in the optical reading type X-ray image detector described in the above illustrative embodiment, the resolution Dx in the main scanning direction is limited by the width (direction perpendicular to the extending direction) of the linear electrode. However, in the sub-scanning direction, the resolution Dy is determined by the width of the reading light of the linear reading light source 250 in the sub-scanning direction and a product of the accumulation time of the charge amplifier 200 for each line and the moving speed of the linear reading light source 250. Although both the resolutions in the main and sub-scanning directions are typically several 10 μm, a design may be possible in which the resolution in the sub-scanning direction is increased with the resolution in the main scanning direction being kept. For example, such a design can be realized by decreasing the width of the linear reading light source 250 or lowering the moving speed thereof. Hence, the optical reading type X-ray image detector is more favorable.

Also, since it is possible to acquire the plurality of fringe image signals by one imaging, it is possible to use an accumulative fluorescent sheet or silver salt film as well as the semiconductor detector that can be immediately repeatedly used. In this case, the reading pixels in reading the accumulative fluorescent sheet or developed silver salt film may correspond to pixels in the claims.

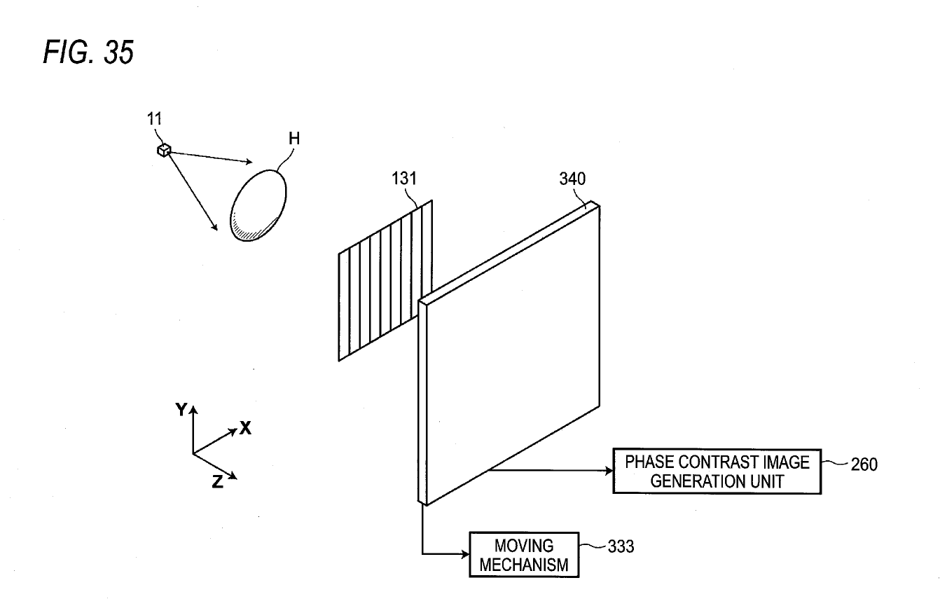

In the below, an example of a configuration of another X-ray imaging system for illustrating an illustrative embodiment of the invention is described. FIG. 35 shows a schematic configuration of the X-ray phase image capturing apparatus of this illustrative embodiment.

As shown in FIG. 35, the X-ray phase image capturing apparatus has a grating 131 that enables the X-ray emitted from the X-ray source 11 to pass therethrough and thus forms a period pattern image, an X-ray image detector (radiological image detector) 340 that detects the period pattern image formed by the grating 131 and performs an intensity modulation for the period pattern image, a moving mechanism 333 that moves the X-ray image detector 340 in a direction orthogonal to the extending direction of a linear electrode thereof, and a phase contrast image generation unit 260 that generates a phase contrast image, based on a fringe image that is obtained by performing the intensity modulation for the period pattern image in the X-ray image detector 340.

Also in this illustrative embodiment, a multi-slit (for example, the multi-slit 140 as described above) having a predetermined pitch may be provided between the X-ray source 11 and the first grating 131.

The X-ray image detector 340 detects a self-image of the grating 131 that is formed by the grating 131 as the X-ray passes through the grating 131, accumulates a charge signal corresponding to the self-image in a charge accumulation layer that is divided into a grating shape (which will be described later) to perform the intensity modulation for the self-image and to form a fringe image and outputs the generated fringe image as an image signal. As the X-ray image detector 340, in this illustrative embodiment, a so-called optical reading type X-ray image detector is used which is a direct conversion type X-ray image detector and reads out an image signal as the linear reading light is scanned thereto.

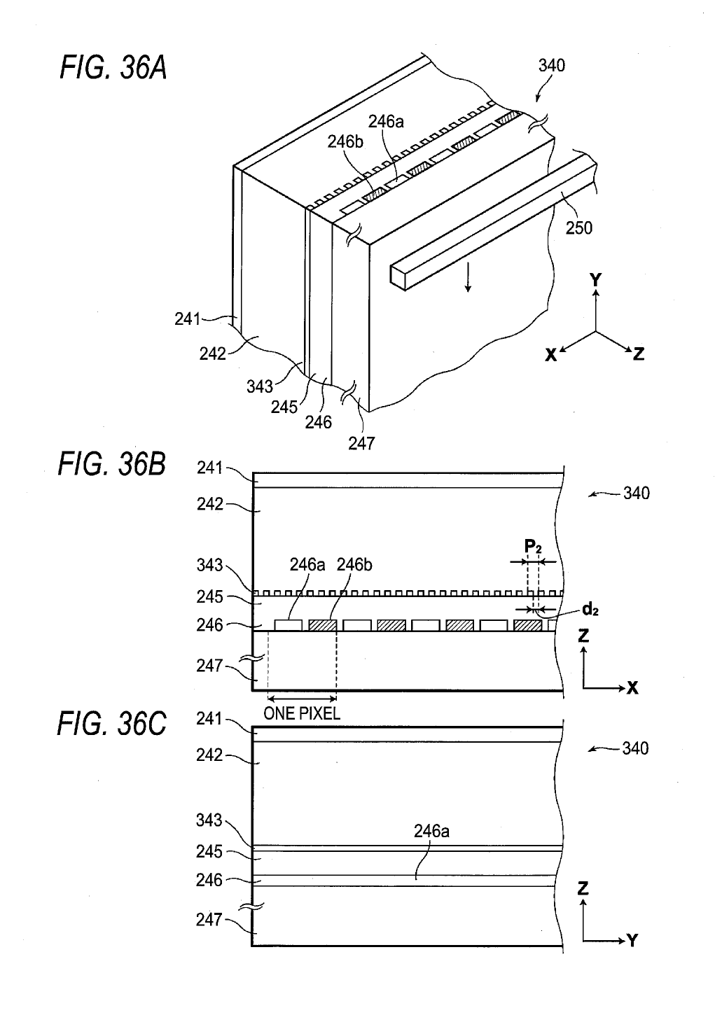

FIG. 36A is a perspective view of the X-ray image detector 340 of this illustrative embodiment, FIG. 36B is a sectional view taken along an XZ plane of the X-ray image detector shown in FIG. 36A, and FIG. 36C is a sectional view taken along a YZ plane of the X-ray image detector shown in FIG. 36A.

As shown in FIGS. 36A to 36C, the X-ray image detector 340 of this illustrative embodiment is configured by sequentially stacking a first electrode layer 241 that enables the X-ray to pass therethrough, a photoconductive layer 242 for record that generates charges as the X-ray having passed through the first electrode layer 241 is irradiated thereto, a charge accumulation layer 343 that functions as an insulator for a charge having one polarity of the charges generated in the photoconductive layer 242 for record and functions as a conductor for a charge having the other polarity, a photoconductive layer 245 for reading that generates charges as the reading light is irradiated thereto and a second electrode layer 246 in corresponding order. In the meantime, the respective layers are sequentially formed from the second electrode layer 246 on a glass substrate 247.

As the charge accumulation layer 343, any film that has an insulating property for a charge having a polarity to be accumulated can be used. For example, it is made of polymer such as acryl-based organic resin, polyimide, BCB, PVA, acryl, polyethylene, polycarbonate, polyetherimide and the like, sulfide such as As₂S₃, Sb₂S₃, ZnS and the like, oxide and fluoride. Also, a material that has an insulting property for a charge having one polarity to be accumulated and a conductive property for a charge having the opposite polarity is more preferable. In addition, a material having a product of mobility x life that is different by three digits or larger due to a polarity of a charge is preferable.

As the favorable compounds, As₂Se₃, a compound in which Cl, Br and I of 500 ppm to 20,000 ppm are doped in As₂Se₃, As₂(SeₓTe₁₋ₓ)₃ (0.5<x<1) in which Se of As₂Se₃ is replaced with Te by 50%, a compound in which Se of As₂Se₃ is replaced with S by 50%, AsₓSe_{y} (x+y=100, 34≦x≦46) in which As concentration of As₂Se₃ is changed by ±15%, an amorphous Se—Te based compound in which Te is 5 to 30 wt %, and the like may be exemplified.

In the meantime, regarding the charge accumulation layer 343, it is preferable to use a material having a dielectric constant that is 0.5 times to two times of dielectric constants of the photoconductive layer 242 for record and the photoconductive layer 245 for reading so that lines of electric force formed between the first electrode layer 241 and the second electrode layer 246 are not bent.

In this illustrative embodiment, the charge accumulation layer 343 is linearly divided to be parallel in the extending direction of the transparent linear electrodes 246a and light-shielding linear electrodes 246b of the second electrode layer 246, as shown in FIGS. 36A to 36C.

Also, the charge accumulation layer 343 is divided with a pitch smaller than the arrangement pitch of the transparent linear electrodes 246a or light-shielding linear electrodes 246b. However, the arrangement pitch P₂ and distance d₂ thereof are determined so that the phase imaging can be performed by a combination with the grating 131.

In the meantime, since the arrangement pitch P₂ and distance d₂ of the transparent linear electrodes 246a or light-shielding linear electrodes 246b are determined to be the same as the arrangement pitch P₂ and distance d₂ of the second grating 132, the same reference numerals are used.

Specifically, when the X-ray irradiated from the X-ray source 11 is a conical beam, rather than a parallel beam, the self-image G1 that is formed as the X-ray passes through the grating 131 is enlarged in proportion to a distance from the X-ray source 11. In this illustrative embodiment, the arrangement pitch P₂ and the interval d₂ of the charge accumulation layer 343 are determined so that the parts of the linear charge accumulation layer 343 substantially coincide with a periodic pattern of bright parts of the self-image of the grating 131 at the position of the charge accumulation layer 343. That is, when the grating pitch of the grating 131 is P₁, the interval of the X-ray shield units of the grating 131 is d₁, a distance from the focal point of the X-ray source 11 to the grating 131 is L₁ and a distance from the grating 131 to the detection surface of the X-ray image detector 340 is L₂, the arrangement pitch P₂ and the interval d₂ of the charge accumulation layer 343 are determined to satisfy the equations (1) and (2).

Also, the charge accumulation layer 343 is formed to have a thickness of 2 μm or smaller in the stacking direction (Z direction).

Also, the charge accumulation layer 343 may be formed by a resistance heating deposition using the material as described above and a metal mask of a metal plate having perforated holes or a mask made of fiber and the like. Alternatively, the charge accumulation layer may be formed by a photolithography.

In the X-ray image detector 340 of this illustrative embodiment, as specifically described later, one set of the transparent linear electrode 246a and the light-shielding linear electrode 246b, which are adjacent to each other, is used to read out an image signal. That is, as shown in FIG. 36B, an image signal of one pixel is read out by one set of the transparent linear electrode 246a and the light-shielding linear electrode 246b. In this illustrative embodiment, the transparent linear electrode 246a and the light-shielding linear electrode 246b are arranged so that one pixel becomes about 50 μm.

The X-ray phase image capturing apparatus of this illustrative embodiment has, as shown in FIG. 36A, the linear reading light source 250 that extends in the direction (X direction) orthogonal to the extending direction of the transparent linear electrode 246a and the light-shielding linear electrode 246b.

In order to enable the configuration, which includes the X-ray source 11, the grating 131 and the X-ray image detector 340 having the divided charge accumulation layer 343, to function as a Talbot interferometer, some conditions should be further satisfied. The conditions are described in the below.

First, the grating 131 and the detection surface of the X-ray image detector 340 should be parallel with the X-Y plane shown in FIG. 35. When the grating 131 is a phase modulation type grating that provides a phase modulation of 90 degrees, the distance Z₂ (Talbot interference distance Z) between the grating 131 and the detection surface of the X-ray image detector 340 should substantially satisfy the equation (24).

Also, when the grating 131 is a phase modulation type grating that provides a phase modulation of 180 degrees, the Talbot interference distance Z should substantially satisfy the equation (25). Further, when the grating 131 is an amplitude modulation type grating, the Talbot interference distance Z should substantially satisfy the equation (3).

The moving mechanism 333 translation-moves the X-ray image detector 340 in the direction orthogonal to the extending direction of the linear electrode thereof, thereby changing the relative position of the grating 131 and the X-ray image detector 340, as described above. The moving mechanism 333 is configured by an actuator such as piezoelectric device, for example.

In the below, the operations of the X-ray phase image capturing apparatus of this illustrative embodiment are described.

The X-ray penetrates the photographic subject H and is then irradiated to the grating 131. The X-ray irradiated to the grating 131 is diffracted in the grating 131, so that a Talbot interference image is formed at a predetermined distance from the grating 131 in the optical axis direction.

Then, the self-image of the grating 131 is incident from the first electrode layer 241 of the X-ray image detector 340, so that it is subject to the intensity modulation by the charge accumulation layer 343 of the X-ray image detector 340. As a result, the self-image is detected, as an image signal of the fringe image reflecting the wave surface only, by the X-ray image detector 340.

Here, the fringe image detection and readout operations of the X-ray image detector 340 are described more specifically.

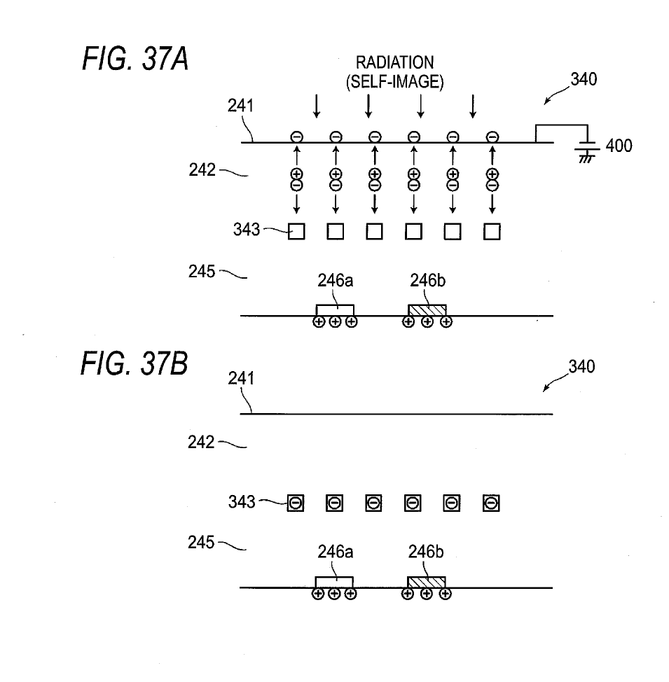

First, as shown in FIG. 37A, at a state in which the negative voltage is applied to the first electrode layer 241 of the X-ray image detector 340 by the high voltage power supply 400, the X-ray carrying the self-image of the grating 131 is irradiated from the first electrode layer 241 of the X-ray image detector 340.

The X-ray irradiated to the X-ray image detector 340 penetrates the first electrode layer 241 and is then irradiated to the photoconductive layer 242 for record. By the irradiation of the X-ray, charge pairs are generated in the photoconductive layer 242 for record, and the positive charges thereof are combined with the negative charges charged in the first electrode layer 241 and thus annihilated and the negative charges are accumulated, as latent image charges, in the charge accumulation layer 343 (refer to FIG. 37B).

In this illustrative embodiment, the charge accumulation layer 343 is linearly divided with the arrangement pitch as described above. Thus, among the charges in the photoconductive layer 242 for record, which are generated in correspondence to the self-image of the grating 131, only the charges below which the charge accumulation layer 343 exists are trapped and accumulated by the charge accumulation layer 343 and the other charges pass through areas of the linear charge accumulation layer 343 (hereinafter, referred to as non-charge accumulation areas), pass through the photoconductive layer 245 for reading and then flow to the transparent linear electrodes 246a and the light-shielding linear electrodes 246b.

Like this, among the charges generated in the photoconductive layer 242 for record, only the charges below which the linear charge accumulation layer 343 exists are accumulated, so that the self-image of the grating 131 is subject to the intensity modulation by the superimposition with the linear pattern of the charge accumulation layer 343. As a result, the image signal of the fringe image reflecting the distortion of the wave surface of the self-image by the photographic subject H is accumulated in the charge accumulation layer 343. That is, the charge accumulation layer 343 of this illustrative embodiment has the equivalent function to the second grating of the related phase imaging using two gratings.

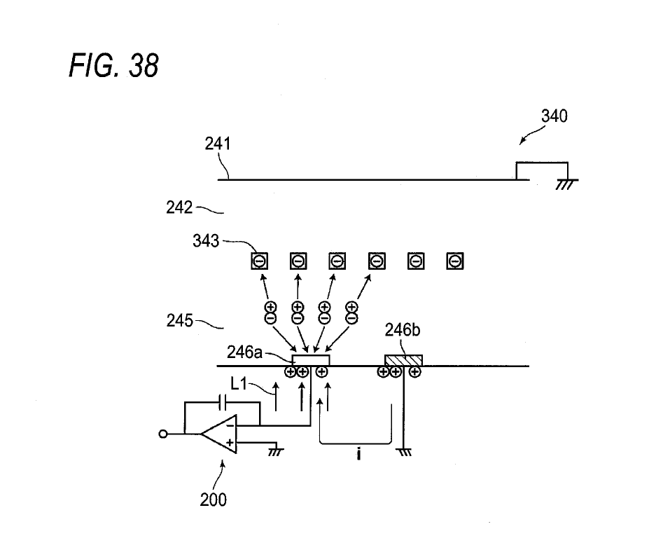

Then, as shown in FIG. 38, at a state in which the first electrode layer 241 is grounded, the linear reading light L1 emitted from the linear reading light source 250 is illuminated from the second electrode layer 246. The reading light L1 penetrates the transparent linear electrode 246a and is then illuminated to the photoconductive layer 245 for reading. The positive charges generated in the photoconductive layer 245 for reading by the illumination of the reading light L1 are combined with the latent image charges in the electric accumulation layer 343 and the negative charges are combined with the positive charges that are charged in the light-shielding linear electrode 246b through the charge amplifier 200 connected to the transparent linear electrode 246a.

As the negative charges generated in the photoconductive layer 245 for reading and the positive charges charged in the light-shielding linear electrode 246b are combined, the current flows in the charge amplifier 200 and is integrated and thus detected as an image signal.

The linear reading light source 250 is moved in the sub-scanning direction (Y direction), so that the X-ray image detector 240 is scanned by the linear reading light L1. Thereby, the image signals are sequentially detected for each of the reading lines, which are illuminated by the linear reading light L1, in accordance with the above operations, and the detected image signals for each of the reading lines are sequentially input and stored in the phase contrast image generation unit 260.

The whole surface of the X-ray image detector 340 is scanned by the reading light L1, so that the image signals of a whole one frame are stored in the phase contrast image generation unit 260.

Since the principle of generating the phase contrast image in this illustrative embodiment is the same as the above described with reference to the equations (17) to (23), the description thereof is omitted. The phase contrast image is generated based on the fringe images by the phase contrast image generation unit 260.

In the meantime, the above-described X-ray phase image capturing apparatus satisfies the equation (24), (25) or (3) so that the distance Z₂ from the grating 131 to the X-ray image detector 340 becomes a Talbot interference distance. However, it may be possible to configure the grating 131 so that it projects the incident X-ray without diffracting the same. According to this configuration, since the projection image that is projected through the grating 131 is similarly obtained at all positions of the rear of the grating 131, it is possible to set the distance Z₂ from the grating 131 to the X-ray image detector 340, irrespective of the Talbot interference distance.

In the below, a modified embodiment of the X-ray phase image capturing apparatus is described. According to the above X-ray phase image capturing apparatus, the X-ray image detector 340 is translation-moved by the moving mechanism 333, so that the X-ray image is captured at the respective positions and thus the M fringe image signals are acquired. However, the X-ray phase image capturing apparatus of this embodiment does not require the moving mechanism 333 as described above and is configured to acquire the M fringe image signals by one X-ray image capturing.

That is, as described above with reference to FIGS. 24 to 30, also in this embodiment, the grating 131 and the X-ray image detector 340 are arranged so that the extending direction of the grating 131 and the extending direction of the charge accumulation layer 343 of the X-ray image detector 340 are relatively inclined, as shown in FIGS. 24 to 26. Regarding the grating 131 and the charge accumulation layer 343 arranged as such, the main pixel size Dx of the main scanning direction (X direction in FIGS. 36A and 36B) and the sub-pixel size Dy of the sub-scanning direction of each pixel of the image signals detected by the X-ray image detector 340 have a relation as shown in FIG. 25. After one radiological image capturing is performed by the same configurations and operations described with reference to FIGS. 24 to 30, the whole surface of the X-ray image detector 340 is scanned by the reading light L1, so that the image signals of the whole one frame are stored in the phase contrast image generation unit 260. Then, the phase contrast image generation unit 260 acquires the image signals of the five different fringe images, based on the stored image signals. Based on the first to fifth fringe image signals, the phase contrast image generation unit 260 generates a phase contrast image by the same manner as the above-described embodiment.

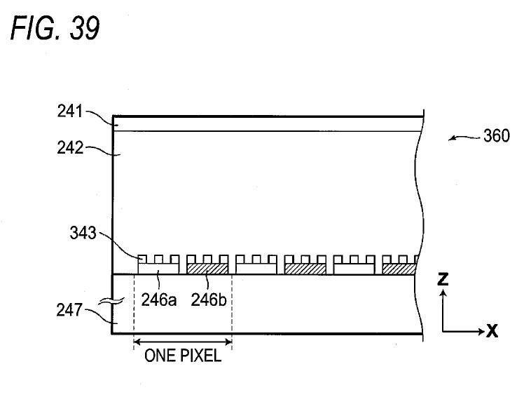

Also, in the above embodiment, the X-ray image detector 340 has the three layers, i.e., the photoconductive layer 242 for record, the charge accumulation layer 343 and the photoconductive layer 245 for reading. However, such layer configuration is not necessarily required. For example, as shown in FIG. 39, a configuration may be possible in which the linear charge accumulation layer 343 is provided to directly contact the transparent linear electrodes 246a and light-shielding linear electrodes 246b without the photoconductive layer 245 for reading and the photoconductive layer 242 for record is provided on the charge accumulation layer 343. Meanwhile, the photoconductive layer 242 for record also functions as the photoconductive layer for reading.

The above structure is a structure in which the charge accumulation layer 343 is directly provided on the second electrode layer 246 without the photoconductive layer 245 for reading, and enables the linear charge accumulation layer 343 to be easily formed. That is, the linear charge accumulation layer 343 can be formed by the vapor deposition. In the vapor deposition, a metal mask and the like is used so as to selectively form a linear pattern. However, in the configuration in which the linear charge accumulation layer 343 is provided on the photoconductive layer 245 for reading, the metal mask is set after the photoconductive layer 245 for reading is vapor-deposited. Accordingly, operations under atmosphere environments are performed between a process of vapor-depositing the photoconductive layer 245 for reading and a process of vapor-depositing the photoconductive layer 242 for record. Thereby, the photoconductive layer 245 for reading may be deteriorated or the foreign substances may be introduced between the photoconductive layers, so that the quality may be deteriorated. However, by omitting the photoconductive layer 245 for reading, it is possible to reduce the operations under atmosphere environments after the vapor deposition of the photoconductive layer, so that it is possible to decrease the concern about the quality deterioration.

In the below, the recording and readout operations of the X-ray image by the X-ray image detector 340 are described.

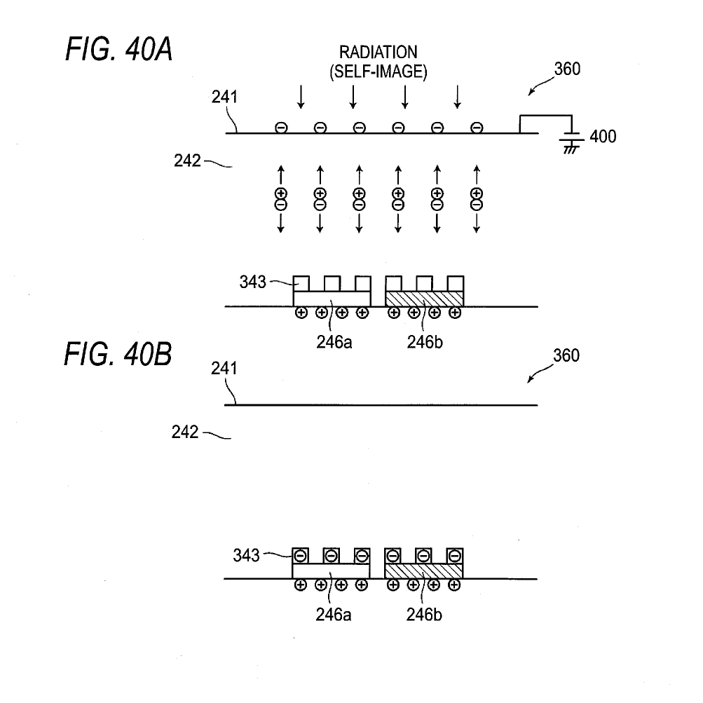

First, as shown in FIG. 40A, at a state in which the negative voltage is applied to the first electrode layer 241 of the X-ray image detector 360 by the high voltage power supply 400, the X-ray carrying the self-image of the grating 131 is irradiated from the first electrode layer 241 of the X-ray image detector 360.

The X-ray irradiated to the X-ray image detector 360 penetrates the first electrode layer 241 and is then irradiated to the photoconductive layer 242 for record. By the irradiation of the X-ray, charge pairs are generated in the photoconductive layer 242 for record, and the positive charges thereof are combined with the negative charges charged in the first electrode layer 241 and thus annihilated and the negative charges are accumulated, as latent image charges, in the charge accumulation layer 343 (refer to FIG. 40B). In the meantime, since the linear charge accumulation layer 343 contacting the second electrode layer 246 is an insulation film, the charges reaching the charge accumulation layer 343 are trapped and thus accumulated therein because the charges cannot reach the second electrode layer 246.

Like the X-ray image detector 340, among the charges generated in the photoconductive layer 242 for record, only the charges below which the charge accumulation layer 343 exists are accumulated, so that the self-image of the grating 131 is subject to the intensity modulation by the superimposition with the linear pattern of the charge accumulation layer 343. As a result, the image signal of the fringe image reflecting the distortion of the wave surface of the self-image by the photographic subject H is accumulated in the charge accumulation layer 343.

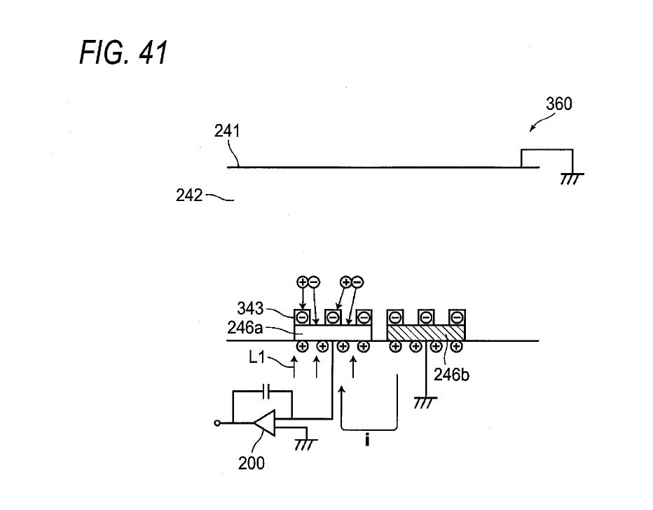

Then, as shown in FIG. 41, at a state in which the first electrode layer 241 is grounded, the linear reading light L1 emitted from the linear reading light source 250 is illuminated from the second electrode layer 246. The reading light L1 penetrates the transparent linear electrode 246a and is then illuminated to the photoconductive layer 242 for record near the charge accumulation layer 343. The positive charges generated by the illumination of the reading light L1 are attracted toward the linear charge accumulation layer 343 and thus recombined. The negative charges are attracted toward the transparent linear electrode 246a and combined with the positive charges charged in the transparent linear electrode 246a and the positive charges that are charged in the light-shielding linear electrode 246b through the charge amplifier 200 connected to the transparent linear electrode 246a. Thereby, the current flows in the charge amplifier 200 and is integrated and thus detected as an image signal.

Also in the above configuration in which the X-ray image detector 360 is used, the methods of acquiring the plurality of fringe images and generating the phase contrast image are the same as the above embodiments.

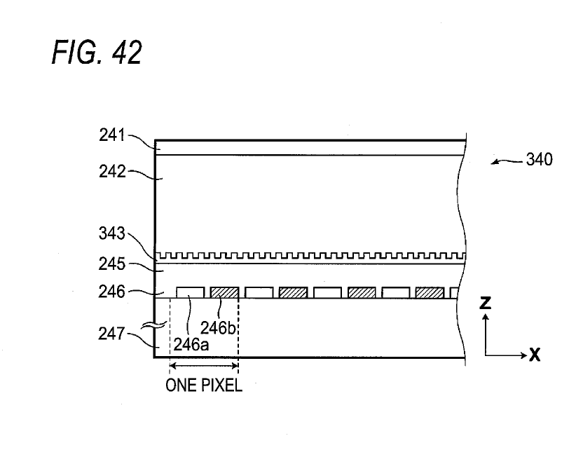

Also, in the respective embodiments, the charge accumulation layer 343 of the X-ray image detector 340 is perfectly linearly divided and separated. However, the invention is not limited thereto. For example, as shown in FIG. 42, the charge accumulation layer may be formed into a grating shape by forming a linear pattern on a flat plate shape.

In the below, another example of the radiographic system for illustrating an illustrative embodiment of the invention is described.

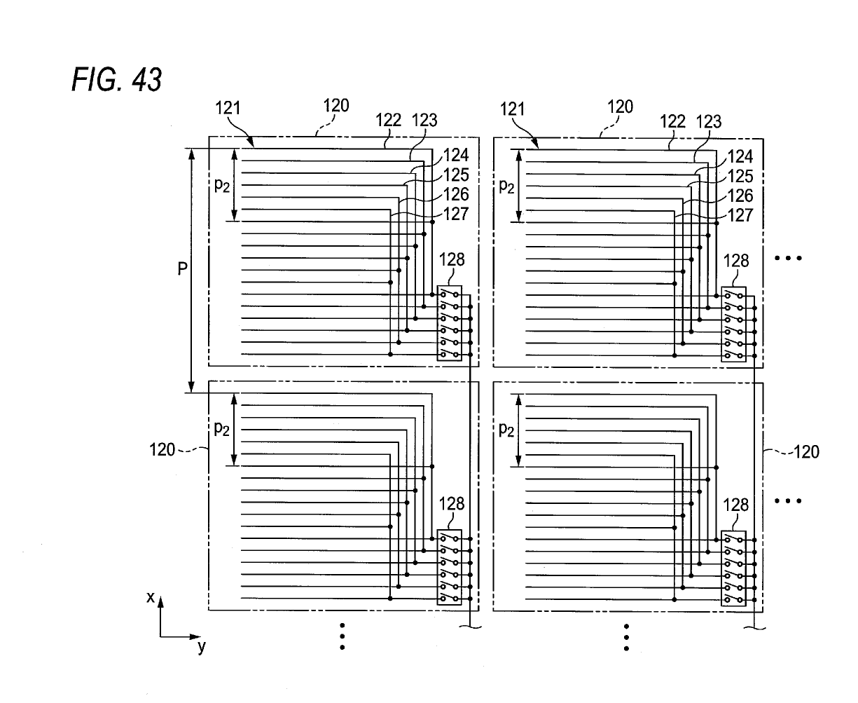

FIG. 43 pictorially shows an example of a configuration of the radiological image detector that is provided to this illustrative embodiment.

In each of the above illustrative embodiments, the second absorption type grating is provided separately from the FPD. However, the FPD of each illustrative embodiment may have a grating pattern by using the X-ray image detector that is disclosed in JP 2009-133823A, without using the second absorption type grating as the grating pattern.

The X-ray image detector is a direct conversion type that includes a conversion layer, which converts the X-ray into charges, and a charge collection electrode, which collects the charges converted by the conversion layer, for each pixel. The charge collection electrode has a plurality of linear electrode groups each of which consists of a plurality of linear electrodes, which extend in a first direction, are arranged with a pitch substantially coinciding with the fringe pattern period of the radiological image formed by the first grating 31 and are electrically connected to each other. The linear electrode groups are arranged with the positions thereof being deviated with a pitch shorter than a pitch of the linear electrodes so that the phases thereof are different from each other. Here, the grating pattern is configured by each of the linear electrode groups.

The X-ray image detector is configured as described above, so that the second absorption type grating is not required. As a result, it is possible to reduce the costs and to make the imaging unit further smaller. Also, since it is possible to acquire the fringe images having a plurality of phase components by one imaging, the physical scanning for the fringe scanning is not required.

As shown in FIG. 43, pixels 120 are two-dimensionally arranged with a constant pitch in the x and y directions. Each pixel 120 is formed with a charge collection electrode 121 for collecting charges converted by a conversion layer that converts the X-ray into charges. The charge collection electrode 121 has first to sixth linear electrode groups 122 to 127. The respective linear electrode groups are offset by π/3 with respect to a phase of an arrangement period of the linear electrodes. Specifically, when a phase of the first linear electrode group 122 is 0, a phase of the second linear electrode group 123 is π/3, a phase of the third linear electrode group 124 is 2π/3, a phase of the fourth linear electrode group 125 is π, a phase of the fifth linear electrode group 126 is 4π/3 and a phase of the sixth linear electrode group 127 is 5π/3.

In each of the first to sixth linear electrode groups 122 to 127, the linear electrodes extending in the y direction are periodically arranged with a predetermined pitch p₂ in the x direction. A relation of a substantial pitch p₂′ (a substantial pitch after the manufacturing) of the arrangement pitch p₂ of the linear electrodes, a pattern period p₁′ of the G1 image at a position (a position of the X-ray image detector) of the charge collection electrode 121 and an arrangement pitch P of the pixels 120 in the x direction is required to satisfy the equation (10), based on the period T of the moiré fringe expressed by the equation (9) and to satisfy the equation (11), like the above illustrative embodiments.

Also, each of the pixels 120 is provided with a switch group 128 for reading out the charges collected by the charge collection electrode 121. The switch group 128 consists of TFT switches each of which is provided to the first to sixth linear electrode groups 122 to 127, respectively. The charges collected by the first to sixth linear electrode groups 122 to 127 are individually read out under control of the switch groups 128, so that it is possible to acquire six fringe images having different phases by one imaging and to generate the phase contrast image based on the six fringe images.

By using the X-ray image detector having the above configuration, the second absorption type grating is not necessary for the imaging unit. As a result, it is possible to reduce the costs and to make the imaging unit further smaller. Also, in this illustrative embodiment, since it is possible to acquire the fringe images having a plurality of phase components by one imaging, the physical scanning for the fringe scanning is not required, so that the scanning mechanism can be excluded. In addition, regarding the configuration of the charge collection electrodes, the other configuration as disclosed in JP 2009-133823A may be used instead of the above configuration.

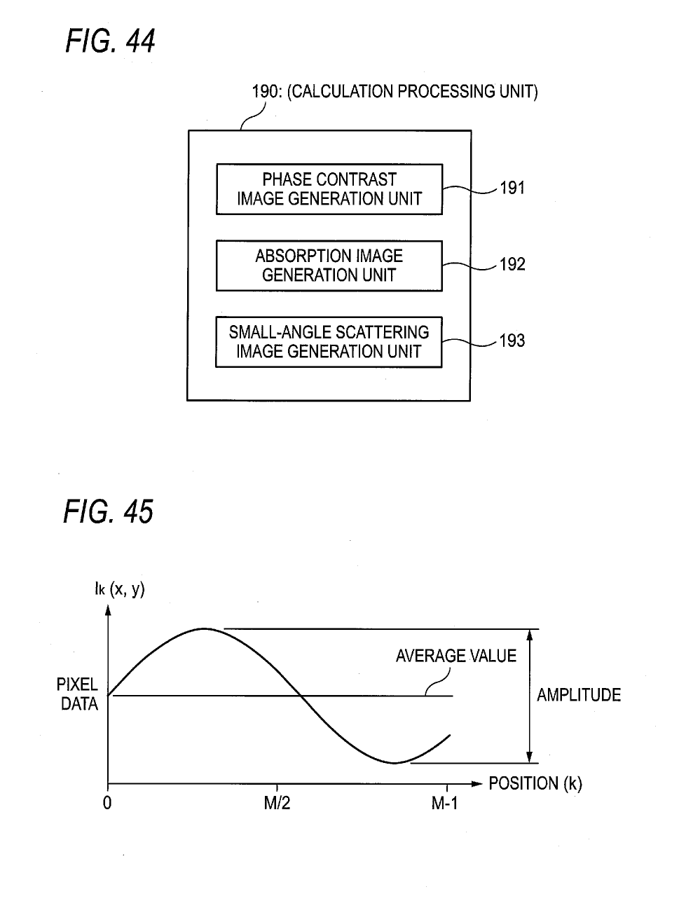

FIG. 44 shows another example of the radiological image detector for illustrating an illustrative embodiment of the invention.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the object to be diagnosed is increased as the number of the imaging is increased. In addition, in recent years, a small-angle scattering image attracts attention in addition to the phase contrast image and the absorption image. The small-angle scattering image can represent tissue characterization and state caused due to the fine structure in the photographic subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the absorption image and the small-angle scattering image to be generated from a plurality of images acquired for the phase contrast image. Since the other configurations are the same as the above X-ray imaging system 10, the descriptions thereof are omitted. The calculation processing unit 190 has a phase contrast image generation unit 191, an absorption image generation unit 192 and a small-angle scattering image generation unit 193. The units perform the calculation processes, based on the image data acquired at the M scanning positions of k=0, 1, 2, . . . , M−1. Among them, the phase contrast image generation unit 191 generates a phase contrast image in accordance with the above-described process.

The absorption image generation unit 192 averages the image data Iₖ(x, y), which is obtained for each pixel, with respect to k, as shown in FIG. 45, and thus calculates an average value and images the image data, thereby generating an absorption image. Also, the calculation of the average value may be performed simply by averaging the image data Iₖ(x, y) with respect to k. However, when M is small, an error is increased. Accordingly, after fitting the image data Iₖ(x, y) with a sinusoidal wave, an average value of the fitted sinusoidal wave may be calculated. In addition, when generating the absorption image, the invention is not limited to the using of the average value. For example, an addition value that is obtained by adding the image data Iₖ(x, y) with respect to k may be used inasmuch as it corresponds to the average value.

In the meantime, it may be possible to prepare an absorption image from an image group that is acquired by performing the imaging (pre-imaging) at a state in which there is no photographic subject. The absorption image reflects a transmittance non-uniformity of a detection system (that is, the absorption image includes information such as a transmittance non-uniformity of grids, an absorption influence of a radiation dose detector, and the like). Therefore, from the image, it is possible to prepare a correction coefficient map for correcting the transmittance non-uniformity of the detection system. Also, by preparing an absorption image from an image group that is acquired by performing the imaging (main imaging) at a state in which there is a photographic subject and multiplying the respective pixels with the correction coefficient, it is possible to acquire an absorption image of the photographic subject in which the transmittance non-uniformity of the detection system is corrected.

The small-angle scattering image generation unit 193 calculates an amplitude value of the image data Iₖ(x, y), which is obtained for each pixel, and thus images the image data, thereby generating a small-angle scattering image. Meanwhile, the amplitude value may be calculated by calculating a difference between the maximum and minimum values of the image data Iₖ(x, y). However, when M is small, an error is increased. Accordingly, after fitting the image data Iₖ(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

In the meantime, it may be possible to prepare a small-angle scattering image from the image group that is acquired by performing the imaging (pre-imaging) at a state in which there is no photographic subject. The small-angle scattering image reflects amplitude value non-uniformity of a detection system (that is, the small-angle scattering image includes information such as pitch non-uniformity of grids, opening ratio non-uniformity, non-uniformity due to the relative position deviation between the grids, and the like). Therefore, from the image, it is possible to prepare a correction coefficient map for correcting the amplitude value non-uniformity of the detection system. Also, by preparing a small-angle scattering image from an image group that is acquired by performing the imaging (main imaging) at a state in which there is a photographic subject and multiplying the respective pixels with the correction coefficient, it is possible to acquire a small-angle scattering image of the photographic subject in which the amplitude value non-uniformity of the detection system is corrected.

According to the X-ray imaging system of this illustrative embodiment, the absorption image or small-angle scattering image is generated from the plurality of images acquired for the phase contrast image of the photographic subject. Accordingly, the capturing positions between the capturing of the phase contrast image and the capturing of the absorption image are not deviated, so that it is possible to favorably superimpose the phase contrast image and the absorption image or small-angle scattering image. Also, it is possible to reduce the burden of the photographic subject, compared to a configuration in which the imaging is separately performed so as to acquire the absorption image and the small-angle scattering image.

The above illustrative embodiments relate to the application in which the invention is applied to the medical diagnosis apparatus. However, the invention is not limited to the medical diagnosis apparatus and can be applied to the other radiation detection apparatus for industrial use.

As describe above, the specification discloses a radiographic apparatus including:

a first grating;

a grating pattern having a period that substantially coincides with a pattern period of a radiological image formed by radiation having passed through the first grating;

a radiological image detector that detects the radiological image masked by the grating pattern, and

a third grating that is arranged at a more forward location than the first grating in a traveling direction of the radiation incident onto the first grating and selectively shields an area to which the radiation is irradiated, thereby forming disperse radiation sources,

wherein a heat insulation member is arranged at a more forward location than the third grating in the traveling direction of the radiation.

Also, according to the radiographic apparatus disclosed in the specification, the grating pattern may be a second grating.

Also, according to the radiographic apparatus disclosed in the specification, the heat insulation member may be provided at a position intersecting with an axis of the radiation incident onto the third grating.

Also, according to the radiographic apparatus disclosed in the specification, the heat insulation member may include at least one of a member having pores therein and a member that shields infrared.

Also, according to the radiographic apparatus disclosed in the specification, the heat insulation member may also serve as a vibration-proof member that prevents vibration from being transferred from an outside to the third grating.

Also, according to the radiographic apparatus disclosed in the specification, the third grating may be integrally mounted to a radiation source.

Also, the radiographic apparatus disclosed in the specification may further include a collimator that limits an irradiation field of the radiation, and the heat insulation member is held in the same housing as the collimator.

Also, the radiographic apparatus disclosed in the specification may further include a cooling unit that cools the third grating.

Also, according to the radiographic apparatus disclosed in the specification, the cooling unit may be an air cooling unit.

Also, according to the radiographic apparatus disclosed in the specification, a direction of air current cooling the third grating in the air cooling unit may be parallel with an extending direction of a plurality of radiation shield units of the third grating.

Also, according to the radiographic apparatus disclosed in the specification, the air cooling the third grating in the air cooling unit may flow along the third grating at least at the heat insulation member-side of the third grating.

Also, according to the radiographic apparatus disclosed in the specification, the air cooling unit may have an air introduction port that introduces external air therein at a position that is a lower temperature side in convection of heat generated from the radiation source.

Also, according to the radiographic apparatus disclosed in the specification, the air cooling unit may have a plurality of air introduction ports, and the air introduction port, which is provided at a position that is a lower temperature side in convection of heat generated from the radiation source, is opened and the air introduction port, which is provided at a higher temperature side, is closed.

Also, according to the radiographic apparatus disclosed in the specification, the air cooling unit may have a plurality of air introduction ports, which are arranged at a lower temperature side in convection of heat generated from the radiation source, the air introduction port that is located at a closer position to the third grating is opened and the air introduction port that is located at a more distant position from the third grating is closed.

Also, the radiographic apparatus disclosed in the specification may further include a radiation source that irradiates the radiation toward the third grating via the heat insulation member.

Also, according to the radiographic apparatus disclosed in the specification, the radiation source may include a cathode that emits electrons, an anode with which the electrons emitted from the cathode collide and a rotation driving unit that rotates the anode to change an electron collision area of the anode.

Also, the specification discloses a radiographic system including the radiographic apparatus and a calculation processing unit that calculates, from an image detected by the radiological image detector of the radiographic apparatus, a refraction angle distribution of the radiation incident onto the radiological image detector and generates a phase contrast image of a photographic subject based on the refraction angle distribution.

Also, the specification discloses a radiographic system including an introduction port opening and closing control unit that performs a control of opening and closing the plurality of air introduction ports of the radiographic apparatus depending on an irradiation direction of the radiation.

What is claimed is:

1. A radiographic apparatus comprising:
a first grating;
a grating pattern having a period that substantially coincides with a pattern period of a radiological image formed by radiation having passed through the first grating;
a radiological image detector that detects the radiological image masked by the grating pattern; and
a third grating that is arranged at a more forward location than the first grating in a traveling direction of the radiation incident onto the first grating and selectively shields an area to which the radiation is irradiated, thereby forming disperse radiation sources,
wherein a heat insulation member is arranged at a more forward location than the third grating in the traveling direction of the radiation.

2. The radiographic apparatus according to claim 1, wherein the grating pattern is a second grating.

3. The radiographic apparatus according to claim 1, wherein the heat insulation member is provided at a position intersecting with an axis of the radiation incident onto the third grating.

4. The radiographic apparatus according to claim 1, wherein the heat insulation member includes at least one of a member having pores therein and a member that shields infrared.

5. The radiographic apparatus according to claim 1, wherein the heat insulation member also serves as a vibration-proof member that prevents vibration from being transferred from an outside to the third grating.

6. The radiographic apparatus according to claim 5, wherein the third grating is integrally mounted to a radiation source.

7. The radiographic apparatus according to claim 1, further comprising a collimator that limits an irradiation field of the radiation,
wherein the heat insulation member is held in the same housing as the collimator.

8. The radiographic apparatus according to claim 1, further comprising a cooling unit that cools the third grating.

9. The radiographic apparatus according to claim 8, wherein the cooling unit is an air cooling unit.

10. The radiographic apparatus according to claim 9, wherein a direction of air current cooling the third grating in the air cooling unit is parallel with an extending direction of a plurality of radiation shield units of the third grating.

11. The radiographic apparatus according to claim 9, wherein the air cooling the third grating in the air cooling unit flows along the third grating at least at the heat insulation member-side of the third grating.

12. The radiographic apparatus according to claim 9, wherein the air cooling unit has an air introduction port that introduces external air therein at a position that is a lower temperature side in convection of heat generated from a radiation source.

13. The radiographic apparatus according to claim 12, wherein the air cooling unit has a plurality of air introduction ports, and
wherein the air introduction port, which is provided at a position that is a lower temperature side in convection of heat generated from the radiation source, is opened and the air introduction port, which is provided at a higher temperature side, is closed.

14. The radiographic apparatus according to claim 12, wherein the air cooling unit has a plurality of air introduction ports, which are arranged at a lower temperature side in convection of heat generated from the radiation source, and
wherein the air introduction port that is located at a closer position to the third grating is opened and the air introduction port that is located at a more distant position from the third grating is closed.

15. The radiographic apparatus according to claim 1, further comprising a radiation source that irradiates the radiation toward the third grating via the heat insulation member.

16. The radiographic apparatus according to claim 15, wherein the radiation source includes a cathode that emits electrons, an anode with which the electrons emitted from the cathode collide and a rotation driving unit that rotates the anode to change an electron collision area of the anode.

17. A radiographic system comprising:
the radiographic apparatus according to claim 1; and
a calculation processing unit that calculates, from an image detected by the radiological image detector of the radiographic apparatus, a refraction angle distribution of the radiation incident onto the radiological image detector and generates a phase contrast image of a photographic subject based on the refraction angle distribution.

18. A radiographic system comprising:
the radiographic apparatus according to claim 13; and
an introduction port opening and closing control unit that performs a control of opening and closing the plurality of air introduction ports of the radiographic apparatus depending on an irradiation direction of the radiation.
